(19) United States
(12) Patent Application Publication
(10) Pub. No.: US 2026/0147285 A1
(43) Pub. Date: May 28, 2026

(54) ELECTROPHOTOGRAPHIC PHOTORECEPTOR

(71) Applicant: MITSUBISHI CHEMICAL CORPORATION, Tokyo (JP)

(72) Inventors: Tsukasa HASEGAWA, Tokyo (JP); Manuel Emilio OTERO RAMIREZ, Tokyo (JP); Hideki GOROUMARU, Tokyo (JP); Akira ANDO, Tokyo (JP)

(73) Assignee: MITSUBISHI CHEMICAL CORPORATION, Tokyo (JP)

(21) Appl. No.: 19/345,018

(22) Filed: Sep. 30, 2025

Related U.S. Application Data
(63) Continuation of application No. PCT/JP2024/012663, filed on Mar. 28, 2024.

(30) Foreign Application Priority Data
Mar. 31, 2023 (JP) 2023-059157
Mar. 31, 2023 (JP) 2023-059158

(51) Int. Cl. G03G 5/147

(52) U.S. Cl. CPC G03G 5/14713

(57) ABSTRACT

The present disclosure relates to an electrophotographic photoreceptor having at least a photosensitive layer and a protective layer sequentially on an electroconductive support, wherein the protective layer contains a compound represented by Formula (1) satisfying Formula (I) and Formula (II-1): M_{ETM}≥700 (I) 0.32≤M_{X}/M_{ETM}≤0.60 (II-1), wherein M_{ETM} represents a molecular weight of the compound represented by Formula (1), and M_{X} represents a molecular weight of a compound in which all bonding sites of X in Formula (1) are replaced with hydrogen atoms.

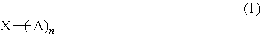

### TECHNICAL FIELD

The present disclosure relates to an electrophotographic photoreceptor having at least a photosensitive layer and a protective layer sequentially on an electroconductive support, the electrophotographic photoreceptor being used in a copying machine, a printer, or the like, and having improved electrical characteristics such as residual potential properties and improved mechanical characteristics such as hardness and elastic deformation rate.

### BACKGROUND ART

In a printer, a copying machine, or the like, when a charged organic photoconductor (OPC) drum is irradiated with light, the irradiated portion undergoes electrostatic elimination to generate an electrostatic latent image, and a toner is attached to the electrostatic latent image, whereby an image can be obtained. In an instrument using the electrophotographic technology, the photoreceptor is a key member.

Since this type of organic photoconductor affords much room for material selection and the properties of the photoconductor are easily controlled, a “function-separated photoreceptor” in which the functions of charge generation and charge transfer are shared by different compounds has become the mainstream. For example, a single-layer type electrophotographic photoreceptor having a charge generation material (CGM) and a charge transport material (CTM) in the same layer (hereinafter referred to as “single-layer type photoreceptor”) and a laminated type electrophotographic photoreceptor obtained by laminating a charge generation layer containing a charge generation material (CGM) and a charge transport layer containing a charge transport material (CTM) (hereinafter referred to as “laminated type photoreceptor”) are known. Examples of a charging method for the photoreceptor include a negative charging method of charging the surface of the photoreceptor with a negative charge and a positive charging method of charging the surface of the photoreceptor with a positive charge.

Examples of currently practically used combinations of the layer structure and the charging method for the photoreceptor include a “negatively-charged laminated type photoreceptor” and a “positively-charged single-layer type photoreceptor.”

The “negatively-charged laminated type photoreceptor” generally has a configuration in which an undercoat layer (UCL) made of a resin or the like is provided on an electroconductive substrate such as an aluminum tube, a charge generation layer (CGL) made of a charge generation material (CGM), a resin, and the like is provided thereon, and a charge transport layer (CTL) made of a hole transport material (HTM), a resin, and the like is further provided thereon.

Meanwhile, the “positively-charged single-layer type photoreceptor” generally has a configuration in which an undercoat layer (UCL) made of a resin or the like is provided on an electroconductive substrate such as an aluminum tube, and a single-layer type photosensitive layer made of a charge generation material (CGM), a hole transport material (HTM), an electron transport material (ETM), a resin, and the like is provided thereon (e.g., see Patent Literature 1).

In any of the photoreceptors, the surface of the photoreceptor is charged by a corona discharge method or a contact method, and then the photoreceptor is exposed to light to neutralize the surface charge, thereby forming an electrostatic latent image by a potential difference from the surrounding surface. Thereafter, a toner is brought into contact with the surface of the photoreceptor to form a toner image corresponding to the electrostatic latent image, and the toner image is transferred onto paper or the like and then heated, molten, and fixed to complete printing.

As described above, the electrophotographic photoreceptor has a basic configuration in which a photosensitive layer is formed on an electroconductive support, but a protective layer is also provided on the photosensitive layer for the purpose of improving abrasion resistance and the like.

As a technique for improving the mechanical strength or abrasion resistance of the surface of a photoreceptor, there is disclosed a photoreceptor in which a layer containing a compound having a chain-polymerizable functional group as a binder resin is formed on an outermost layer of the photoreceptor, and energy such as heat, light, or radiation is applied to the layer to polymerize the compound, thereby forming a cured resin layer (e.g., see Patent Literatures 1 and 2).

Such a protective layer is generally formed by dissolving a curable composition containing a compound having a chain-polymerizable functional group in an organic solvent to prepare a coating liquid for forming a protective layer and applying the coating liquid for forming a protective layer to the surface of the photoreceptor.

### CITATION LIST

### Patent Literature

Patent Literature 1: U.S. Pat. No. 9,417,538
Patent Literature 2: WO 2010/035683

### SUMMARY

### Technical Problem

It is known that a protective layer is provided in order to improve the abrasion resistance of a photoreceptor. Especially, a protective layer made of a curable compound (a compound having a chain-polymerizable functional group) is particularly excellent in mechanical strength.

In addition, from the viewpoint of improving the electrical characteristics of the photoreceptor, the protective layer is required to have a good electron transporting property at the same time.

Furthermore, the protective layer is required to have high hardness and elastic deformation rate from the viewpoint of improving abrasion resistance.

That is, it is considered that, in order to improve the abrasion resistance and electrical characteristics of the photoreceptor, it is effective to use a compound having an electron transport structure as the curable compound forming the protective layer.

However, it has been found that some compounds having an electron transport structure have insufficient solubility in the production of a coating liquid for forming a protective layer. It has also been found that the residual potential, hardness, and elastic deformation rate of the photoreceptor having a protective layer formed thereon are insufficient.

An object of the present disclosure is to provide an electrophotographic photoreceptor having at least a photosensitive layer and a protective layer sequentially on an electroconductive support, wherein the electrophotographic photoreceptor is excellent in electrical characteristics such as residual potential properties and mechanical characteristics such as hardness and elastic deformation rate, and a compound used for forming the protective layer has excellent solubility in an organic solvent.

### Solution to Problem

The present inventors have found that when a compound represented by Formula (1) described below and satisfying Formula (I) and Formula (II-1) described below or a compound represented by Formula (1) described below and satisfying Formulae (I) to (III) described below is used as a compound for forming a protective layer, good solubility is achieved, and residual potential, hardness, and elastic deformation rate are also improved.

The present disclosure has been accomplished based on such findings, and the gist thereof is as follows.
[1] An electrophotographic photoreceptor having at least a photosensitive layer and a protective layer sequentially on an electroconductive support, wherein
the protective layer contains a compound represented by Formula (1) described below, and the compound represented by Formula (1) satisfies Formula (I) and Formula (II-1) described below.

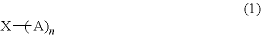

In Formula (1), X represents an n-valent electron transport skeleton.

A is a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, a group represented by Formula (2) described below, or a group represented by Formula (1B) described below.

n represents an integer of 1 or more.

When n is 1, A is a group represented by Formula (2) described below or a group represented by Formula (1B) described below.

When n is 2 or more, a plurality of As may be the same or different, and at least one A is a group represented by Formula (2) described below or a group represented by Formula (1B) described below.

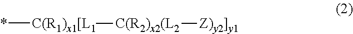

In Formula (2), * represents a bond with X.

R₁ and R₂ each independently represent a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, or a group represented by Formula (1B) described below.

L₁ and L₂ each independently represent a direct bond, a divalent group, a group represented by Formula (1A) described below, or a group represented by Formula (3A) described below.

Z represents a hydrogen atom, an alkyl group, an alkoxy group, an amide group, or a polymerizable functional group. Provided that x1+y1=3 wherein x1 is an integer from 0 to 2 and y1 is an integer from 1 to 3; x2+y2=3 wherein x2 is an integer from 0 to 2 and y2 is an integer from 1 to 3; when x1 is an integer of 2 or more, R₁s may be the same or different; when y1 is an integer of 2 or more, each of R₂s, x2s, y2s, L₁s, L₂s, and Zs may be the same or different; when x2 is an integer of 2 or more, R₂s may be the same or different; and when y2 is an integer of 2 or more, each of Les and Zs may be the same or different.

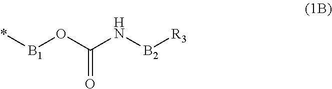

In Formula (1B), * represents a bond with any atom in Formula (1) or (2), and B₁ and B₂ each independently represent a direct bond or a divalent group. R₃ represents a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, or a polymerizable functional group.

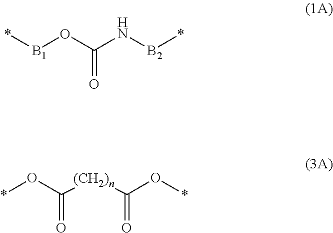

In Formula (1A) and Formula (3A), * represents a bond with any atom in Formula (1) and Formula (2). In Formula (1A), B₁ and B₂ each independently represent a direct bond or a divalent group. In Formula (3A), n is an integer of 1 or more.

$${M}_{E T M} \geq 700 \qquad ( I )$$

$$0.32 \leq {M}_{X} / {M}_{E T M} \leq 0.60 \qquad ( II - 1 )$$

(In Formula (I) and Formula (II-1), M_{ETM} represents a molecular weight of the compound represented by Formula (1); and in Formula (II-1), M_{X} represents a molecular weight of a compound in which all bonding sites of X in Formula (1) are replaced with hydrogen atoms.)
[2] An electrophotographic photoreceptor having at least a photosensitive layer and a protective layer sequentially on an electroconductive support, wherein
the protective layer contains a polymer of a compound represented by Formula (1) described below, and the compound represented by Formula (1) satisfies Formulae (I), (II-2), and (III) described below.

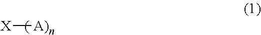

In Formula (1), X represents an n-valent electron transport skeleton.

A is a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, a group represented by Formula (2) described below, or a group represented by Formula (1B) described below.

n represents an integer of 1 or more.

When n is 1, A is a group represented by Formula (2) described below or a group represented by Formula (1B) described below. When the A is a group represented by Formula (2) described below, at least one of Zs is a polymerizable functional group. When the A is a group represented by Formula (1B) described below, R₃ is a polymerizable functional group.

When n is 2 or more, a plurality of As may be the same or different, and at least one A is a group represented by Formula (2) described below or a group represented by Formula (1B) described below and contains at least one polymerizable functional group in the structure.

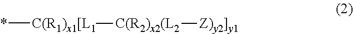

In Formula (2), * represents a bond with X.

R₁ and R₂ each independently represent a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, or an aromatic heterocyclic group optionally having a substituent, or a group represented by Formula (1B) described below.

L₁ and L₂ each independently represent a direct bond, a divalent group, a group represented by Formula (1A) described below, or a group represented by Formula (3A) described below.

Z represents a hydrogen atom, an alkyl group, an alkoxy group, an amide group, or a polymerizable functional group. Provided that x1+y1=3 wherein x1 is an integer from 0 to 2 and y1 is an integer from 1 to 3; x2+y2=3 wherein x2 is an integer from 0 to 2 and y2 is an integer from 1 to 3; when x1 is an integer of 2 or more, R₁s may be the same or different; when y1 is an integer of 2 or more, each of R₂s, x2s, y2s, L₁s, L₂s, and Zs may be the same or different; when x2 is an integer of 2 or more, R₂s may be the same or different; and when y2 is an integer of 2 or more, each of L₂s and Zs may be the same or different.

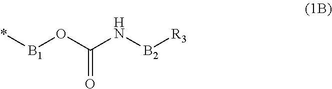

In Formula (1B), * represents a bond with any atom in Formula (1) or (2), and B₁ and B₂ each independently represent a direct bond or a divalent group. R₃ represents a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, or a polymerizable functional group.

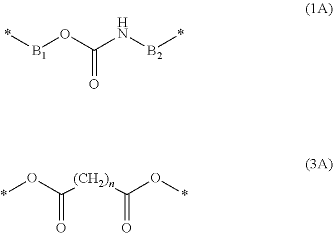

In Formula (1A) and Formula (3A), * represents a bond with any atom in Formula (1) and Formula (2). In Formula (1A), B₁ and B₂ each independently represent a direct bond or a divalent group. In Formula (3A), n is an integer of 1 or more.

$${M}_{E T M} \geq 700 \qquad ( I )$$

$${M}_{X} / {M}_{E T M} > 0.31 \qquad ( II - 2 )$$

$${A}_{E T M} \geq 1.8 \qquad ( III )$$

In Formula (I) and Formula (II-2), M_{ETM} represents a molecular weight of the compound represented by Formula (1). In Formula (II-2), M_{X} represents a molecular weight of a compound in which all bonding sites of X in Formula (1) are replaced with hydrogen atoms. In Formula (III), A_{ETM} represents the number of polymerizable functional groups contained per molecular weight of 1000 of the compound represented by Formula (1).
[3] The electrophotographic photoreceptor according to [1] or [2], wherein the compound represented by Formula (1) further satisfies Formula (IV) described below.

EA_{X}≥3.8 (IV)

(In Formula (IV), EA_{X} represents an electron affinity (eV) of a compound in which all bonding sites of X in Formula (1) are replaced with hydrogen atoms.)
[4] The electrophotographic photoreceptor according to any one of [1] to [3], wherein, in Formula (1), X is represented by Formulae (A-1) to (A-27) described below.
[5] The electrophotographic photoreceptor according to any one of [1] to [4], wherein, in Formula (1), at least one of As is represented by Formula (2).
[6] The electrophotographic photoreceptor according to any one of [1] to [5], wherein, in Formula (2), at least one of L₁ and L₂ is a group represented by Formula (1A) or a group represented by Formula (3A).
[7] The electrophotographic photoreceptor according to any one of [1] to [6], wherein the compound represented by Formula (1) has at least one polymerizable functional group in one molecule.
[8] The electrophotographic photoreceptor according to any one of [1] to [7], wherein the polymerizable functional group is selected from Formulae (M1) to (M7) described below.

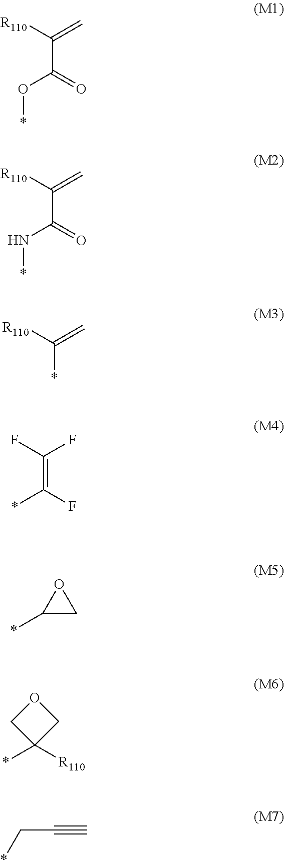

In Formulae (M1) to (M7), R₁₁₀ represents a hydrogen atom or an alkyl group optionally having a substituent, and * represents a bonding position.
[9] The electrophotographic photoreceptor according to any one of [1] to [8], wherein, in Formula (2), R₁ is an alkyl group optionally having a substituent.
[10] The electrophotographic photoreceptor according to any one of [1] to [9], wherein the protective layer further contains a polymer of a polymerizable compound having no electron transport skeleton.
[11] The electrophotographic photoreceptor according to any one of [1] to [10], wherein the protective layer further contains an electron donating compound.
[12] An electrophotographic photoreceptor cartridge including the electrophotographic photoreceptor described in any one of [1] to [11].
[13] An image forming apparatus including the electrophotographic photoreceptor described in any one of [1] to [11].

### Advantageous Effects

The present disclosure can provide an electrophotographic photoreceptor having at least a photosensitive layer and a protective layer sequentially on an electroconductive support, the electrophotographic photoreceptor being excellent in electrical characteristics such as residual potential properties and mechanical characteristics such as hardness and elastic deformation rate.

Moreover, in the present disclosure, the compound used for forming the protective layer has excellent solubility in an organic solvent such as an alcohol-based solvent, and thus the protective layer is formed under good solvent solubility. Therefore, an electrophotographic photoreceptor having excellent electrical characteristics and mechanical characteristics can be efficiently produced with good workability.

### BRIEF DESCRIPTION OF DRAWINGS

FIG. 1 is a schematic view of an example of a configuration of an image forming apparatus that can be constituted using an electrophotographic photoreceptor according to an embodiment of the present disclosure.

FIG. 2 is a graph showing a general relationship between an indentation depth of an indenter and a load curve when the Martens hardness and elastic deformation rate of a photoreceptor are measured.

### DESCRIPTION OF EMBODIMENTS

Next will be described an embodiment for carrying out the present disclosure (hereinafter referred to as “embodiment of the present disclosure”) in detail. The present disclosure is not limited to the following embodiments and can be carried out with various modifications within the scope of the gist thereof.

### Inventive Photoreceptor

An electrophotographic photoreceptor according to an exemplary embodiment of the present disclosure (hereinafter also referred to as “the inventive photoreceptor”) is an electrophotographic photoreceptor including at least a photosensitive layer and a protective layer sequentially on an electroconductive support, wherein the protective layer contains the inventive compound A or B described below. When the inventive compound A or B has a polymerizable functional group in one molecule, the compound may be present in the form of a polymer in the protective layer after curing. For example, the inventive compound A or B may be in the form of a polymer obtained by polymerizing the compounds with each other, or when the protective layer contains a curable compound, the inventive compound A or B may be in the form of a polymer obtained by polymerizing the compound with the curable compound.

The inventive photoreceptor may optionally have a layer other than the photosensitive layer and the protective layer.

A charging method for the inventive photoreceptor may be either a negative charging method of charging the surface of the photoreceptor with a negative charge or a positive charging method of charging the surface of the photoreceptor with a positive charge. Of these, from the viewpoint that the protective layer is required to have an electron-transporting property, the positive charging method is preferable because the method is considered to be able to further benefit from the effects of the present disclosure.

In the inventive photoreceptor, a side opposite to the electroconductive support is an upper side or a front surface side, and an electroconductive support side is a lower side or a back surface side.

### Present Protective Layer

The protective layer of the inventive photoreceptor (may be referred to as “the present protective layer”) contains a polymer of an electron transport compound A represented by Formula (1) described below and satisfying Formula (I) and Formula (II-1) described below (the compound A may be referred to as “the inventive compound A”) or an electron transport compound B represented by Formula (1) described below and satisfying Formulae (I), (II-2), and (III) described below (the compound B may be referred to as “the inventive compound B”).

In the present specification, the term “the inventive compound A, B” means the inventive compound A or B, and the meaning of the term “the inventive compound” encompasses the inventive compounds A and B.

In the present disclosure, the “electron transport compound” means a compound having an electron transporting property, in other words, a compound having an electron transport skeleton.

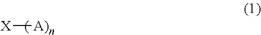

$${M}_{E T M} \geq 700 \qquad ( I )$$

$$0.32 \leq {M}_{X} / {M}_{E T M} \leq 0.60 \qquad ( II - 1 )$$

(In Formula (I) and Formula (II-1), M_{ETM} represents the molecular weight of the compound represented by Formula (1). In Formula (II-1), M_{X} represents the molecular weight of a compound in which all bonding sites of X in Formula (1) are replaced with hydrogen atoms.)

$${M}_{E T M} \geq 700 \qquad ( I )$$

$${M}_{X} / {M}_{E T M} > 0.31 \qquad ( II - 2 )$$

$${A}_{E T M} \geq 1.8 \qquad ( III )$$

(In Formula (I) and Formula (II-2), M_{ETM} represents the molecular weight of the compound represented by Formula (1). In Formula (II-2), M_{X} represents the molecular weight of a compound in which all bonding sites of X in Formula (1) are replaced with hydrogen atoms. In Formula (III), A_{ETM} represents the number of polymerizable functional groups contained per molecular weight of 1000 of the compound represented by Formula (1).)

The mechanism of providing the effect that the inventive photoreceptor including a protective layer containing the inventive compound A is excellent in electrical characteristics is considered as follows.

Since the inventive compound A has an electron transport structure, the use of the inventive compound A for formation of the present protective layer enhances charge injection from the photosensitive layer into the protective layer and charge mobility to the outermost surface through the electron transport skeleton, and an electrophotographic photoreceptor excellent in electrical characteristics such as residual potential properties can be obtained.

In a case where the inventive compound A has a polymerizable functional group, the inventive compound A is polymerized in a step of forming a protective layer described below and becomes a polymer, and thus a protective layer having further excellent mechanical strength can be formed. In this case, the polymer may be a polymer obtained by polymerization of the inventive compound A, or may be a copolymer obtained by polymerization of the inventive compound A and a polymerizable compound having no electron transport skeleton when the protective layer contains the polymerizable compound having no electron transport skeleton.

Further, when the inventive compound A has a value equal to or lower than the upper limit of Formula (II-1) described below, the proportion of a mother skeleton which is a hydrophobic x-conjugated skeleton is in a preferred range, the solubility in an alcohol-based solvent is high, applicability of a coating liquid at the time of forming the protective layer is good, and a uniform protective layer without unevenness can be formed. Conceivably, this improves the electron transporting property in the protective layer and improves the electrical characteristics of the photoreceptor. Further, when the inventive compound A has a value equal to or higher than the lower limit of Formula (II-1) described below, the proportion of the structure contributing to electron transport present in the protective layer is high, and the electron transporting property is high, and thus the electrical characteristics are further improved.

Further, when the inventive compound A satisfies Formula (I) and Formula (II-1), a side chain moiety contributing to the solubility in an alcohol-based solvent is increased, and the solubility in an alcohol-based solvent becomes more excellent.

When the inventive compound A further satisfies Formula (IV), the electron injection from an adjacent layer is good and the electron transporting property of the mother skeleton is excellent, and therefore, the electrical characteristics are further improved.

The mechanism of providing the effect that the inventive photoreceptor including a protective layer containing a polymer of the inventive compound B is excellent in electrical characteristics is considered as follows.

Since the inventive compound B has an electron transport structure, the use of the inventive compound B for formation of the present protective layer enhances charge injection from the photosensitive layer into the protective layer and charge mobility to the outermost surface through the electron transport skeleton, and an electrophotographic photoreceptor excellent in electrical characteristics such as residual potential properties can be obtained.

Since the inventive compound B has a polymerizable functional group, the inventive compound B is polymerized in a step of forming a protective layer described below and becomes a polymer, and thus a protective layer having excellent mechanical strength can be formed. In this case, the polymer may be a polymer obtained by polymerization of the inventive compound B, or may be a copolymer obtained by polymerization of the inventive compound B and a polymerizable compound having no electron transport skeleton when the protective layer contains the polymerizable compound having no electron transport skeleton.

Further, when the inventive compound B satisfies Formula (I) and Formula (II-2), the proportion of a structure that is present in the protective layer and is considered to contribute to the electron transport increases, which is advantageous for the electron transport. Further, when the inventive compound B satisfies Formula (III), the number of polymerizable functional groups present in the protective layer is large, and a dense network structure is easily formed. As a result, the hardness and the elastic deformation rate become good.

When the inventive compound B further satisfies Formula (IV), the electron injection from an adjacent layer is good and the electron transporting property of the mother skeleton is excellent, and therefore, the electrical characteristics are further improved.

The present protective layer is preferably an outermost layer, i.e., an outermost layer located on a side opposite to the electroconductive support, from the viewpoint of more effectively achieving the effects by the inventive compound A, B. However, even when the present protective layer is not necessarily the outermost layer, the effects of the present disclosure can be received. For example, in a case where some segregation layer is present on the outermost layer of the photoreceptor, the effects can be received even when the present protective layer is not the outermost layer.

Hereinafter, first, the inventive compound A, B used for forming the protective layer according to the present disclosure will be described, and then a composition containing the inventive compound A, B (hereinafter the composition may also be referred to as “the composition of the present disclosure” or “the present composition”) and the electrophotographic photoreceptor of the present disclosure will be described in order.

### Inventive Compound A

The inventive compound A is preferably a compound represented by Formula (1) described below and satisfying Formula (I) and Formula (II-1) described below.

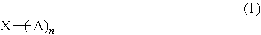

### X

In Formula (1), X represents an n-valent electron transport skeleton.

X is preferably a skeleton represented by any of Formulae (A-1) to (A-27) described below.

In a case where the electron transport skeleton is a skeleton represented by Formula (A-10), (A-11), or (A-26) described below, the electron transporting property is excellent and the electrical characteristics (VL) are further improved, which is more preferable.

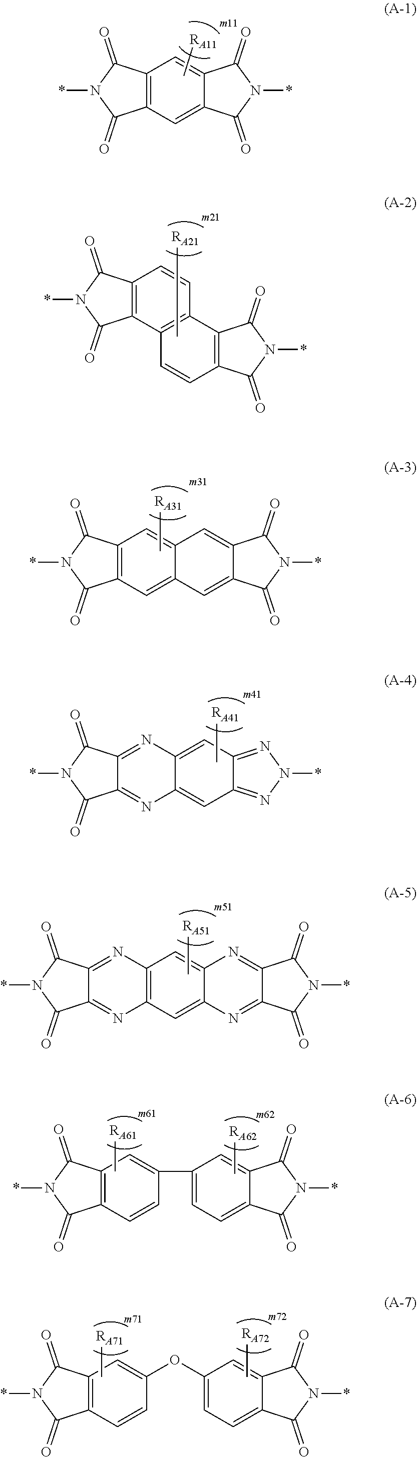

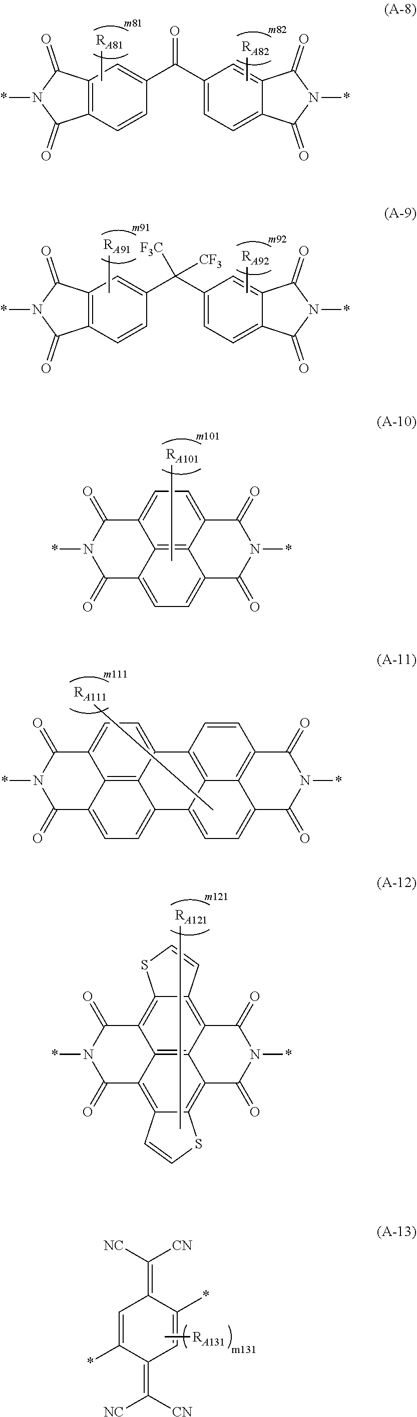

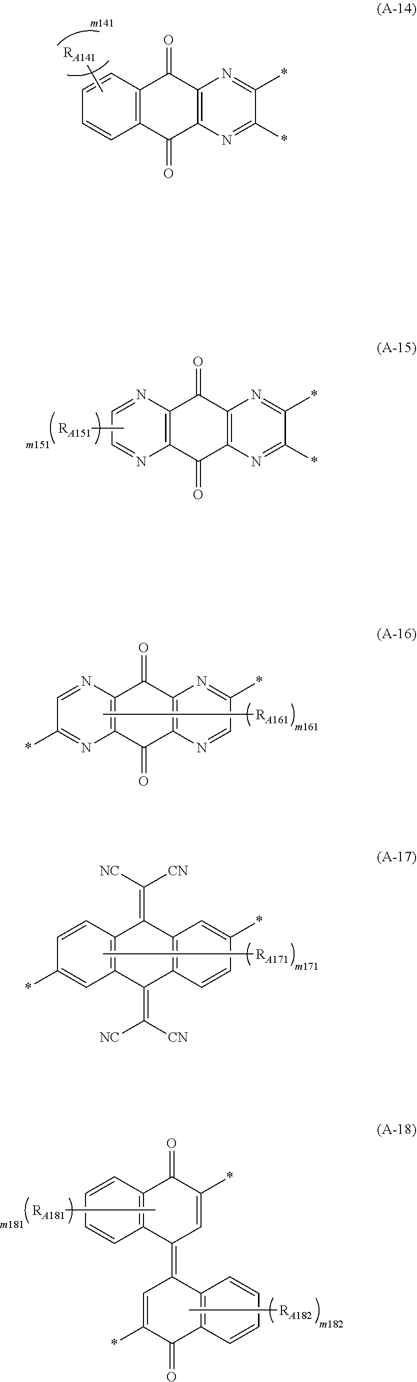

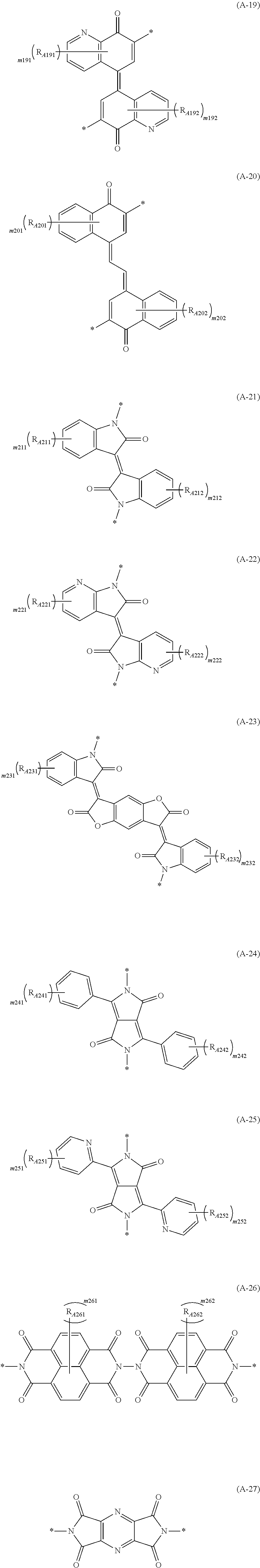

In Formulae (A-1) to (A-27), * represents a bond with A.

R_{A11}, R_{A21}, R_{A31}, R_{A41}, R_{A51}, R_{A61}, R_{A62}, R_{A71}, R_{A72}, R_{A81}, R_{A82}, R_{A91}, R_{A92}, R_{A101}, R_{A111}, R_{A121}, R_{A131}, R_{A141}, R_{A151}, R_{A161}, R_{A171}, R_{A181}, R_{A182}, R_{A191}, R_{A192}, R_{A201}, R_{A202}, R_{A211}, R_{A212}, R_{A221}, R_{A222}, R_{A231}, R_{A232}, R_{A241}, R_{A242}, R_{A251}, R_{A252}, R_{A261}, and R_{A262} each independently represent a hydrogen atom, an alkyl group optionally having a substituent, an aralkyl group optionally having a substituent, an aromatic group optionally having a substituent, an alkoxy group optionally having a substituent, an aryloxy group optionally having a substituent, an acyl group optionally having a substituent, an ester group optionally having a substituent, a cyano group, a nitro group, a sulfone group optionally having a substituent, a hydroxy group, an aldehyde group optionally having a substituent, or a halogen atom.

In Formulae (A-1) to (A-27), m11, m21, m31, m41, m51, m61, m62, m71, m72, m81, m82, m91, m92, m101, m111, m121, m131, m141, m151, m161, m171, m181, m182, m191, m192, m201, m202, m211, m212, m221, m222, m231, m232, m241, m242, m251, m252, m261, and m262 each independently represent an integer of 0 or more.

When m11, m21, m31, m41, m51, m61, m62, m71, m72, m81, m82, m91, m92, m101, m111, m121, m131, m141, m151, m161, m171, m181, m182, m191, m192, m201, m202, m211, m212, m221, m222, m231, m232, m241, m242, m251, m252, m261, and m262 are each 2 or more, each of R_{A11}s to R_{A262}s may be different.

n

In Formula (1), n represents an integer of 1 or more, and when n is 2 or more, a plurality of As may be the same or different.

### A

A in Formula (1) is a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, a group represented by Formula (2) described below, or a group represented by Formula (1B) described below.

In the present disclosure, the expression “a group optionally having a substituent” means that the group may have a substituent, and the meaning thereof encompasses both a case where the group has a substituent and a case where the group does not have a substituent.

When n is 1, A is a group represented by Formula (2) described below or a group represented by Formula (1B) described below. When the A is a group represented by Formula (2) described below, at least one of Zs is a polymerizable functional group. When the A is a group represented by Formula (1B) described below, R₃ is a polymerizable functional group.

When n is 2 or more, a plurality of As may be the same or different, and at least one A is a group represented by Formula (2) described below or a group represented by Formula (1B) described below and contains at least one polymerizable functional group in the structure.

Of these, from the viewpoint of further improving the solubility in an organic solvent, at least one of As is preferably a group represented by Formula (2) described below.

### Group Represented by Formula (2)

The group represented by Formula (2) is an example of A in Formula (1).

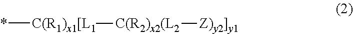

In Formula (2), * represents a bond with X.

R₁ and R₂ each independently represent a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, or a group represented by Formula (1B) described below.

From the viewpoint of further improving the solubility in an organic solvent, the group represented by Formula (2) more preferably has branches at two positions and has a polymerizable functional group in a side chain. From such a viewpoint, R₁ in Formula (2) is preferably an alkyl group optionally having a substituent, because Formula (2) is branched at the alkyl group and the solubility in an organic solvent is further improved.

In Formula (2), L₁ and L₂ each independently represent a direct bond, a divalent group, a group represented by Formula (1A) described below, or a group represented by Formula (3A) described below.

Among these, at least one of L₁ and L₂ is preferably a group represented by Formula (1A) described below or a group represented by Formula (3A) described below, because the solubility in an organic solvent is further improved when the side chain having a urethane bond is branched.

In Formula (2), Z represents a hydrogen atom, an alkyl group, an alkoxy group, an amide group, or a polymerizable functional group, Provided that x1+y1=3 wherein x1 is an integer from 0 to 2 and y1 is an integer from 1 to 3; x2+y2=3 wherein x2 is an integer from 0 to 2 and y2 is an integer from 1 to 3; when x1 is an integer of 2 or more, R₁s may be the same or different; when y1 is an integer of 2 or more, each of R₂s, x2s, y2s, L₁s, L₂s, and Zs may be the same or different; when x2 is an integer of 2 or more, R₂s may be the same or different; and when y2 is an integer of 2 or more, each of L₂s and Zs may be the same or different.

### Group Represented by Formula (1B)

The group represented by Formula (1B) is an example of A in Formula (1), and is also an example of L₁ and L₂ in Formula (2).

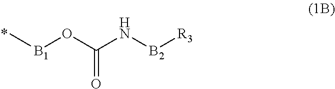

In Formula (1B), * represents a bond with any atom in Formula (1) or (2).

B₁ and B₂ each independently represent a direct bond or a divalent group.

R₃ represents a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, or a polymerizable functional group.

### Group Represented by Formula (1A)

The group represented by Formula (1A) is an example of L₁ and L₂ in Formula (2).

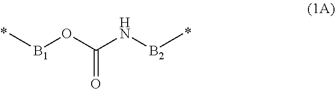

In Formula (1A), * represents a bond with any atom in Formula (1) and Formula (2).

B₁ and B₂ each independently represent a direct bond or a divalent group.

Here, examples of the divalent group include an alkylene group, a divalent group having a ketone group, a divalent group having an ether bond, a divalent group having an ester bond, or a group in which these groups are linked.

### Group Represented by Formula (3A)

The group represented by Formula (3A) is an example of L₁ and L₂ in Formula (2).

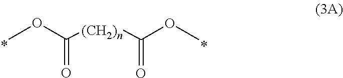

In Formula (3A), * represents a bond with any atom in Formula (1) and Formula (2).

n is an integer of 1 or more.

### Formula (I) and Formula (II-1)

The inventive compound A is preferably a compound satisfying Formula (I) and Formula (II-1) described below.

In Formula (I) and Formula (II-1) described below, “M_{ETM}” represents the molecular weight of the compound represented by Formula (1). “M_{X}” represents the molecular weight of a compound in which all bonding sites of X in Formula (1) are replaced with hydrogen atoms.

$${M}_{E T M} \geq 700 \qquad ( I )$$

$$0.32 \leq {M}_{X} / {M}_{E T M} \leq 0.60 \qquad ( II - 1 )$$

As described in Formula (I), the molecular weight (M_{ETM}) of the compound represented by Formula (1) is preferably 700 or more from the viewpoint of film formability and charge transporting property. From such a viewpoint, the molecular weight (M_{ETM}) of the compound represented by Formula (1) is more preferably 750 or more, still more preferably 800 or more, yet still more preferably 900 or more, and particularly preferably 1000 or more.

Meanwhile, the molecular weight is preferably 2000 or less from the viewpoint of solubility. Therefore, the molecular weight is preferably 1800 or less, more preferably 1600 or less, still more preferably 1500 or less, and particularly preferably 1400 or less.

“M_{X}/M_{ETM}” in Formula (II-1), i.e., the ratio of the molecular weight of the compound in which all bonding sites of X in Formula (1) are replaced with hydrogen atoms to the molecular weight of the compound represented by Formula (1) means the ratio of a structure capable of participating in the transfer of electrons in the compound.

The ratio is preferably 0.32 or more, because the proportion of the structure contributing to electron transport present in the protective layer is high, and the electron transporting property is high, and thus the electrical characteristics are further improved. From such a viewpoint, the ratio is more preferably 0.33 or more, still more preferably 0.34 or more, yet still more preferably 0.35 or more, and particularly preferably 0.36 or more.

Meanwhile, the ratio is preferably 0.60 or less, because the proportion of the mother skeleton which is a hydrophobic π-conjugated skeleton is in a preferred range, the solubility in an alcohol-based solvent is increased, and the applicability of the coating liquid at the time of forming the protective layer is improved. From such a viewpoint, the ratio is more preferably 0.58 or less, still more preferably 0.56 or less, yet still more preferably 0.54 or less, and particularly preferably 0.53 or less.

The molecular weight (M_{X}) of the compound in which all bonding sites of X in Formula (1) are replaced with hydrogen atoms may be any molecular weight that satisfies Formula (II-1).

Especially, the molecular weight (M_{X}) is more preferably 250 or more, still more preferably 300 or more, yet still more preferably 350 or more, and particularly preferably 400 or more. Meanwhile, the molecular weight is preferably 800 or less, more preferably 750 or less, still more preferably 700 or less, and particularly preferably 650 or less.

### Formula (IV)

The inventive compound A is particularly preferably a compound further satisfying Formula (IV) described below.

In Formula (IV) described below, EA_{X} represents an electron affinity (eV) of the compound in which all bonding sites of X in Formula (1) are replaced with hydrogen atoms. As described in Examples below, this parameter is determined by quantum scientific calculations.

$${EA}_{X} \geq 3.8 \qquad ( IV )$$

The electron affinity (eV) of the compound in which all bonding sites of X in Formula (1) are replaced with hydrogen atoms is preferably 3.8 or more as described in Formula (IV), because an electron injection property from an adjacent layer and the electron transporting property in the protective layer are improved. From such a viewpoint, the electron affinity (EA_{X}) of the compound in which all bonding sites of X in Formula (1) are replaced with hydrogen atoms is more preferably 3.83 or more, still more preferably 3.85 or more, yet still more preferably 3.89 or more, and particularly preferably 3.94 or more.

Meanwhile, the electron affinity (EA_{X}) is preferably 6.0 or less from the viewpoint of an electron trapping property. Therefore, the electron affinity is preferably 5.5 or less, more preferably 5.0 or less, still more preferably 4.7 or less, and particularly preferably 4.4 or less.

### Polymerizable Functional Group

The inventive compound A preferably has at least one polymerizable functional group in one molecule. When the inventive compound A has one or more polymerizable functional groups, crosslinkability is further enhanced, the hardness of the present protective layer is increased, and the mechanical strength can be further increased.

One or more polymerizable functional groups may be present in the inventive compound A, but, from the viewpoint of solubility in an organic solvent and curability, the number of polymerizable functional groups is preferably two or more, and more preferably four or more. Meanwhile, from the viewpoint of stability of the compound, the number of polymerizable functional groups contained in the inventive compound A is preferably 12 or less, more preferably 10 or less, and still more preferably 8 or less.

The polymerizable functional group is not particularly limited as long as it is a functional group having polymerizability, and examples thereof include polymerizable functional groups represented by Formulae (M1) to (M7) described below.

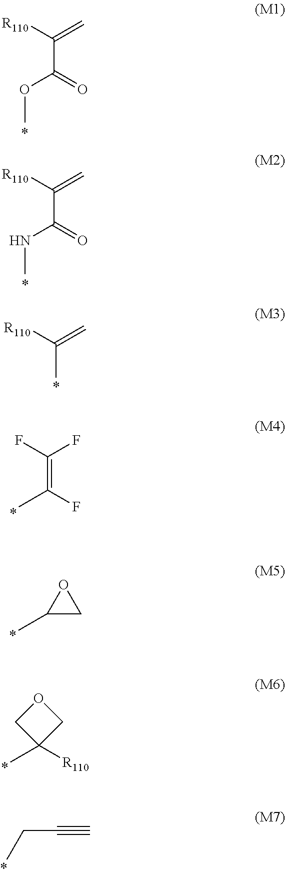

In Formulae (M1) to (M7), R₁₁₀ represents a hydrogen atom or an alkyl group optionally having a substituent, and * represents a bonding position.

In Formulae (M1) to (M7), R₁₁₀ is preferably a hydrogen atom or an alkyl group having no substituent, preferably a hydrogen atom or an alkyl group having from 1 to 10 carbon atoms, and particularly preferably a hydrogen atom or a methyl group.

In a case where the inventive compound A has two or more polymerizable functional groups, all the polymerizable functional groups are not necessarily the same and may be different, but are preferably the same from the viewpoint of curability.

### Inventive Compound B

The inventive compound B is preferably a compound represented by Formula (1) and satisfying Formula (I) and Formula (II-2) described below.

Since Formula (1) of the inventive compound B is the same as Formula (1) of the inventive compound A, the description of Formula (1) of the inventive compound A is used as the description of Formula (1) of the inventive compound B.

### Formula (I), Formula (II-2), and Formula (III)

The inventive compound B is preferably a compound satisfying Formulae (I) to (III) described below.

In Formula (I) and Formula (II-2), M_{ETM} represents the molecular weight of the compound represented by Formula (1). In Formula (II-2), M_{X} represents the molecular weight of a compound in which all bonding sites of X in Formula (1) are replaced with hydrogen atoms. In Formula (III), A_{ETM} represents the number of polymerizable functional groups contained per molecular weight of 1000 of the compound represented by Formula (1).

$${M}_{E T M} \geq 700 \qquad ( I )$$

$${M}_{X} / {M}_{E T M} > 0.31 \qquad ( II - 2 )$$

$${A}_{E T M} \geq 1.8 \qquad ( III )$$

As described in Formula (I), the molecular weight (M_{ETM}) of the compound represented by Formula (1) is preferably 700 or more, because an amorphous property is improved and crystallization is easily suppressed, and thus, the film formability is improved and the film becomes uniform, whereby the charge transporting property is improved. From such a viewpoint, the molecular weight (M_{ETM}) of the compound represented by Formula (1) is more preferably 750 or more, still more preferably 800 or more, yet still more preferably 900 or more, and particularly preferably 1000 or more.

Meanwhile, the molecular weight is preferably 2000 or less from the viewpoint of solubility. Therefore, the molecular weight is preferably 1800 or less, more preferably 1600 or less, still more preferably 1500 or less, and particularly preferably 1400 or less.

“M_{X}/M_{ETM}” in Formula (II-2), i.e., the ratio of the molecular weight of the compound in which all bonding sites of X in Formula (1) are replaced with hydrogen atoms to the molecular weight of the compound represented by Formula (1) means the ratio of a structure capable of participating in the transfer of electrons in the compound.

The ratio is preferably more than 0.31, because the proportion of the structure contributing to electron transport present in the protective layer is high, and the electron transporting property is high, and thus the electrical characteristics are further improved. From such a viewpoint, the ratio is more preferably 0.32 or more, still more preferably 0.33 or more, yet still more preferably 0.34 or more, yet still more preferably 0.35 or more, and particularly preferably 0.36 or more.

Meanwhile, the ratio is preferably 0.60 or less, because the proportion of the mother skeleton which is a hydrophobic π-conjugated skeleton is in a preferred range, the solubility in an alcohol-based solvent is increased, and the applicability of the coating liquid at the time of forming the protective layer is improved. From such a viewpoint, the ratio is more preferably 0.58 or less, still more preferably 0.56 or less, yet still more preferably 0.54 or less, and particularly preferably 0.53 or less.

The molecular weight (M_{X}) of the compound in which all bonding sites of X in Formula (1) are replaced with hydrogen atoms may be any molecular weight that satisfies Formula (II-2).

Especially, the molecular weight (M_{X}) is more preferably 250 or more, still more preferably 300 or more, yet still more preferably 350 or more, and particularly preferably 400 or more. Meanwhile, the molecular weight is preferably 800 or less, more preferably 750 or less, still more preferably 700 or less, and particularly preferably 650 or less.

As described in Formula (III), when the number of polymerizable functional groups (A_{ETM}) contained per molecular weight of 1000 of the compound represented by Formula (1) is 1.8 or more, the number of polymerizable functional groups present in the protective layer is large, and a dense network structure is easily formed, resulting in improved hardness and elastic deformation rate. From such a viewpoint, the number of polymerizable functional groups (A_{ETM}) is more preferably 1.9 or more, still more preferably 2.2 or more, yet still more preferably 2.5 or more, and particularly preferably 2.8 or more.

Meanwhile, when the number of polymerizable functional groups (A_{ETM}) contained per molecular weight of 1000 of the compound represented by Formula (1) is too large, the electron transporting property is lowered, and the residual potential may be deteriorated. From such a viewpoint, the number of polymerizable functional groups (A_{ETM}) is preferably 7.0 or less, more preferably 6.0 or less, still more preferably 5.0 or less, and particularly preferably 4.0 or less.

### Formula (IV)

The inventive compound B is particularly preferably a compound further satisfying Formula (IV), as in the case of the inventive compound A.

### Polymerizable Functional Group

The inventive compound B preferably has at least one polymerizable functional group in one molecule. When the inventive compound B has one or more polymerizable functional groups, crosslinkability is further enhanced, the hardness of the present protective layer is increased, and the mechanical strength can be further increased.

One or more polymerizable functional groups may be present in the inventive compound B, but, from the viewpoint of solubility in an organic solvent and curability, the number of polymerizable functional groups is preferably two or more, and more preferably four or more. Meanwhile, from the viewpoint of stability of the compound, the number of polymerizable functional groups contained in the inventive compound B is preferably 12 or less, more preferably 10 or less, and still more preferably 8 or less.

The polymerizable functional group that can be contained in the inventive compound B is the same as the polymerizable functional group that can be contained in the inventive compound A, and therefore, the description of the polymerizable functional group in the inventive compound A is used as the description of the polymerizable functional group in the inventive compound B.

### Specific Example

Specific examples of the inventive compound A, B include compounds as described below. However, the inventive compound A, B is not limited to the following compounds.

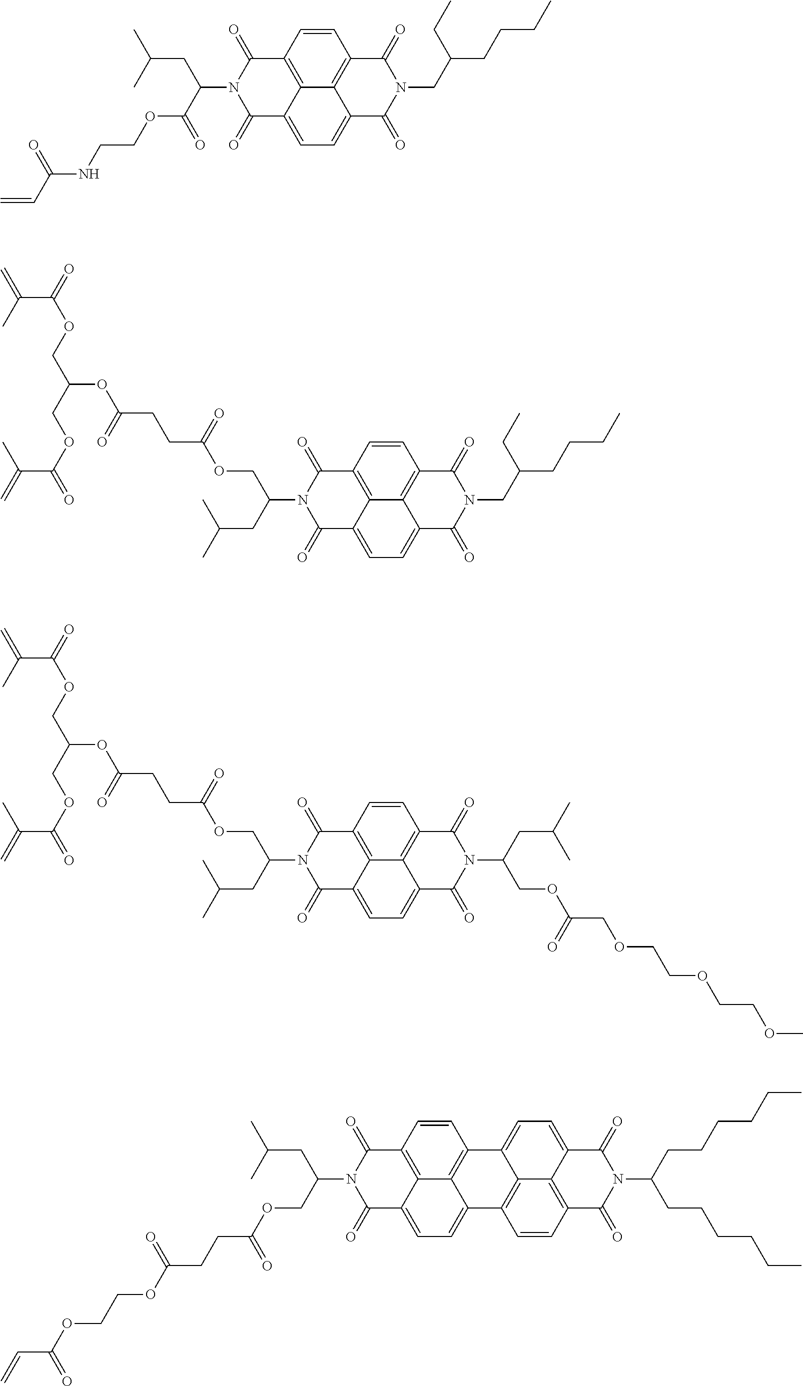

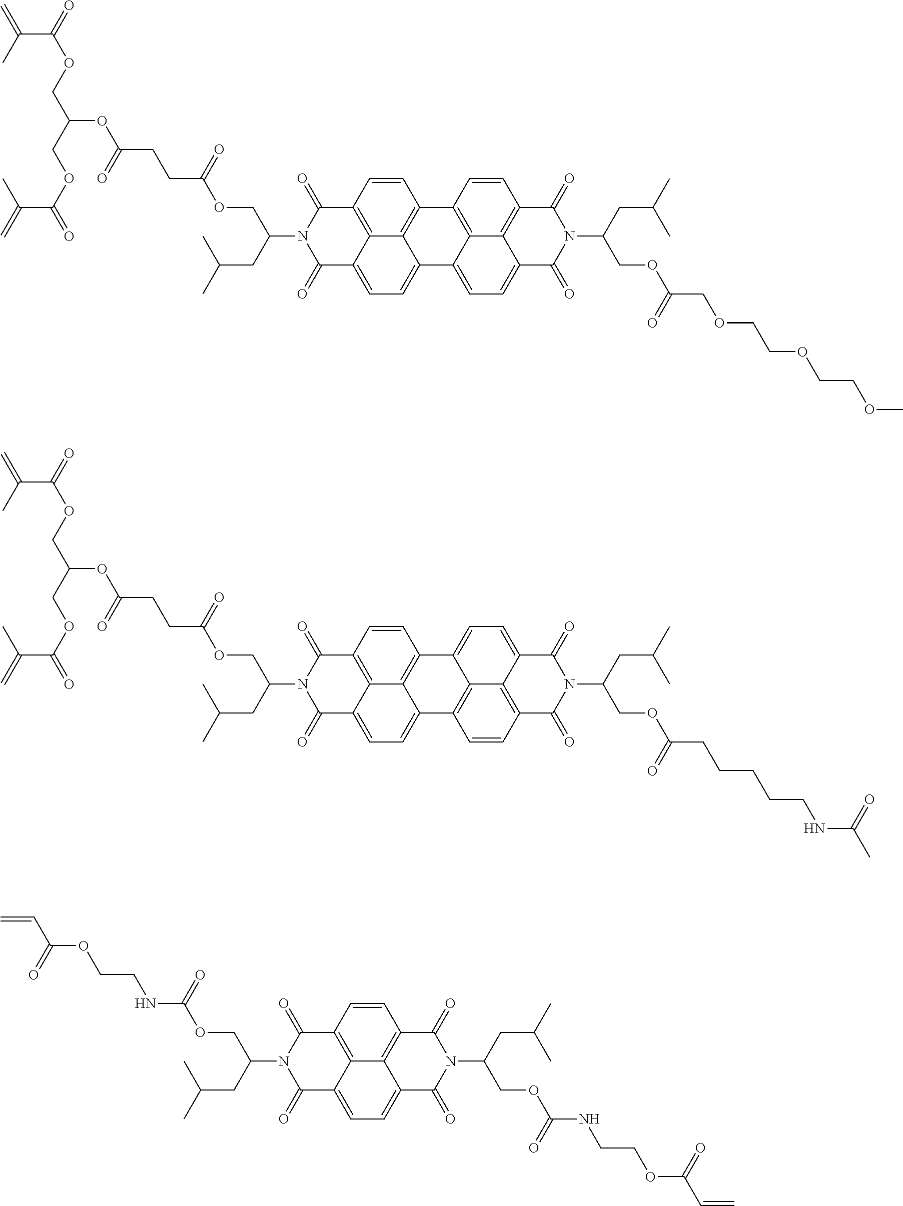

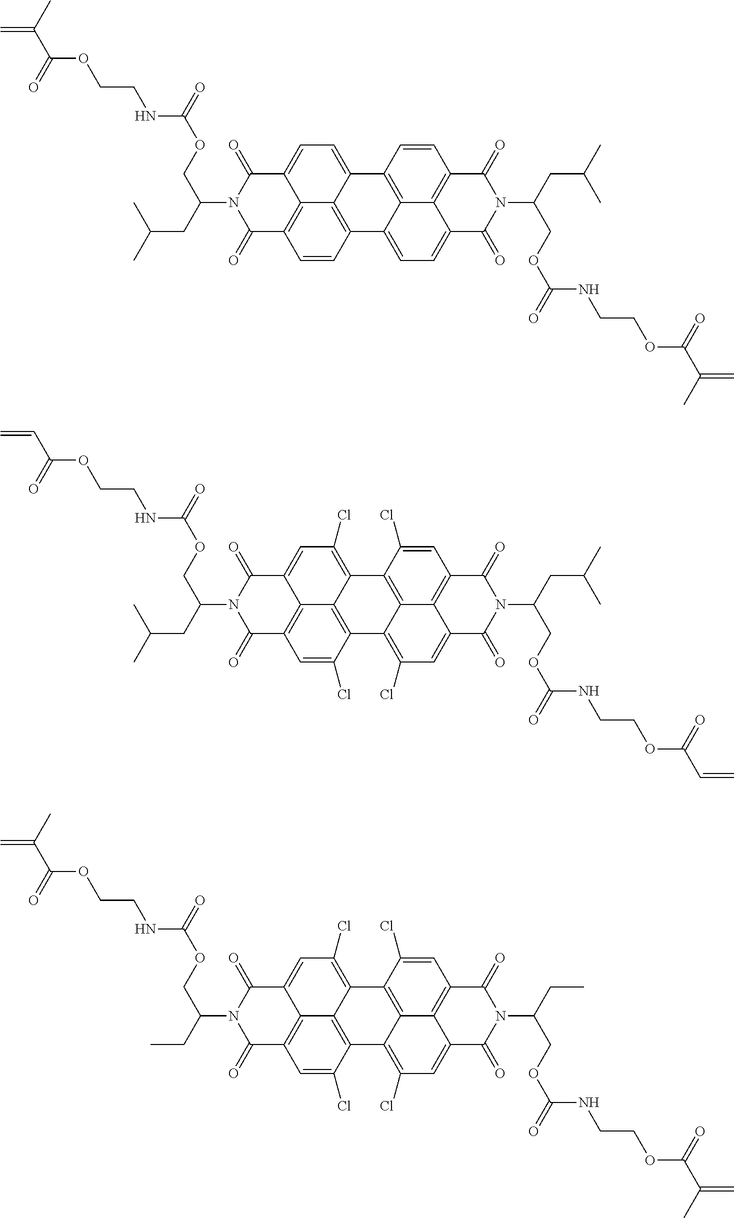

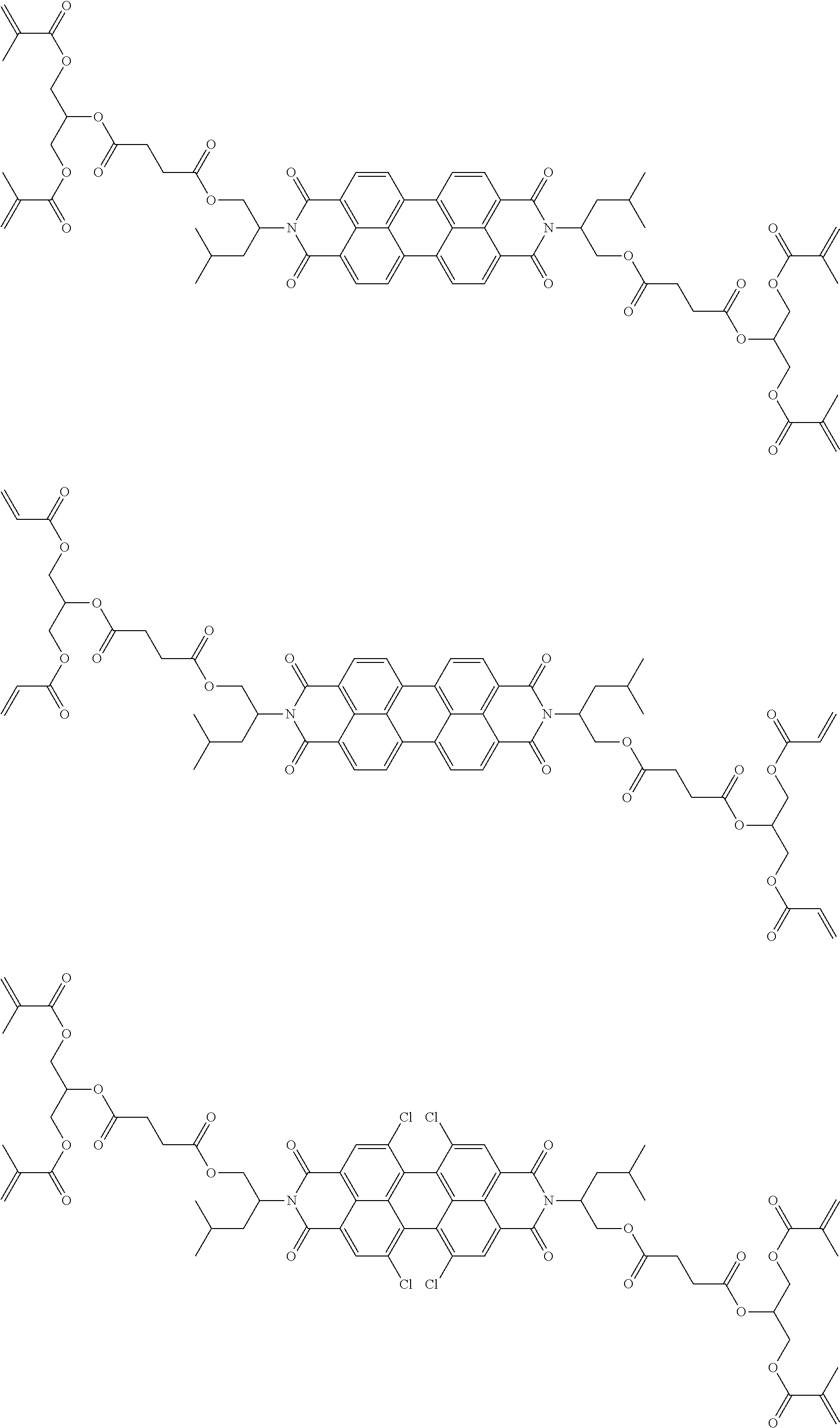

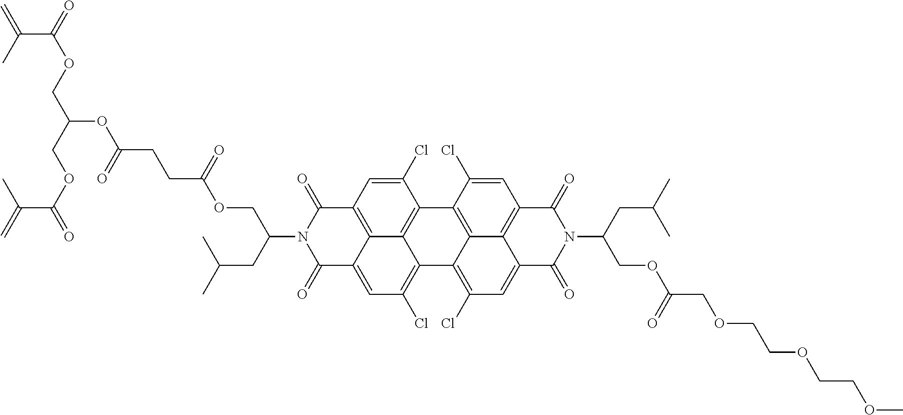 [SMILES: C=C(C)C(=O)OCC(COC(=O)C(=C)C)OC(=O)CCC(=O)OCC(CC(C)C)N1C(=O)c2cc(Cl)c3c4c(Cl)cc5c6c(cc(Cl)c(c7c(Cl)cc(c2c37)C1=O)c64)C(=O)N(C(COC(=O)COCCOCCOC)CC(C)C)C5=O]

### Method for Producing Inventive Compound A, B

The inventive compound A, B can be produced, for example, in accordance with a method described in Examples below.

### Solubility of Inventive Compound A, B

The inventive compound A, B has excellent solubility in an organic solvent, particularly an alcohol-based solvent or a mixed solvent containing an alcohol-based solvent, and is preferably dissolved in a mixed solvent of toluene and 2-propanol (30 mass % of toluene and 70 mass % of 2-propanol) in an amount of 3 mass % or more, particularly 6 mass % or more.

### Present Composition

The composition of the present disclosure (hereinafter also referred to as “the present composition”) contains the above-described inventive compound, and is used as a curable composition for preparing a coating liquid for forming a protective layer of the electrophotographic photoreceptor of the present disclosure as described below.

The present composition contains an electron transport compound containing at least the inventive compound and contains a polymerizable compound having no electron transport skeleton, an electron donating compound, a polymerization initiator, inorganic particles, and other materials, as necessary.

In the present disclosure, the term “composition” is composed of only a solid component containing no solvent.

Accordingly, the content of each component, such as the inventive compound in 100 parts by mass of the present composition described below, corresponds to the content of each component in 100 parts by mass of the total mass of the protective layer formed using the present composition.

The total mass of the protective layer means the total mass of the protective layer after curing, and this is the same as the total mass of a solid component in the coating liquid for forming a protective layer described below.

### Electron Transport Compound

The electron transport compound contained in the present composition contains at least the inventive compound, and may contain an electron transport compound other than the inventive compound, as necessary.

The present composition may contain only one type of the inventive compound or may contain two or more types thereof.

Examples of the electron transport compound other than the inventive compound include compounds as shown below.

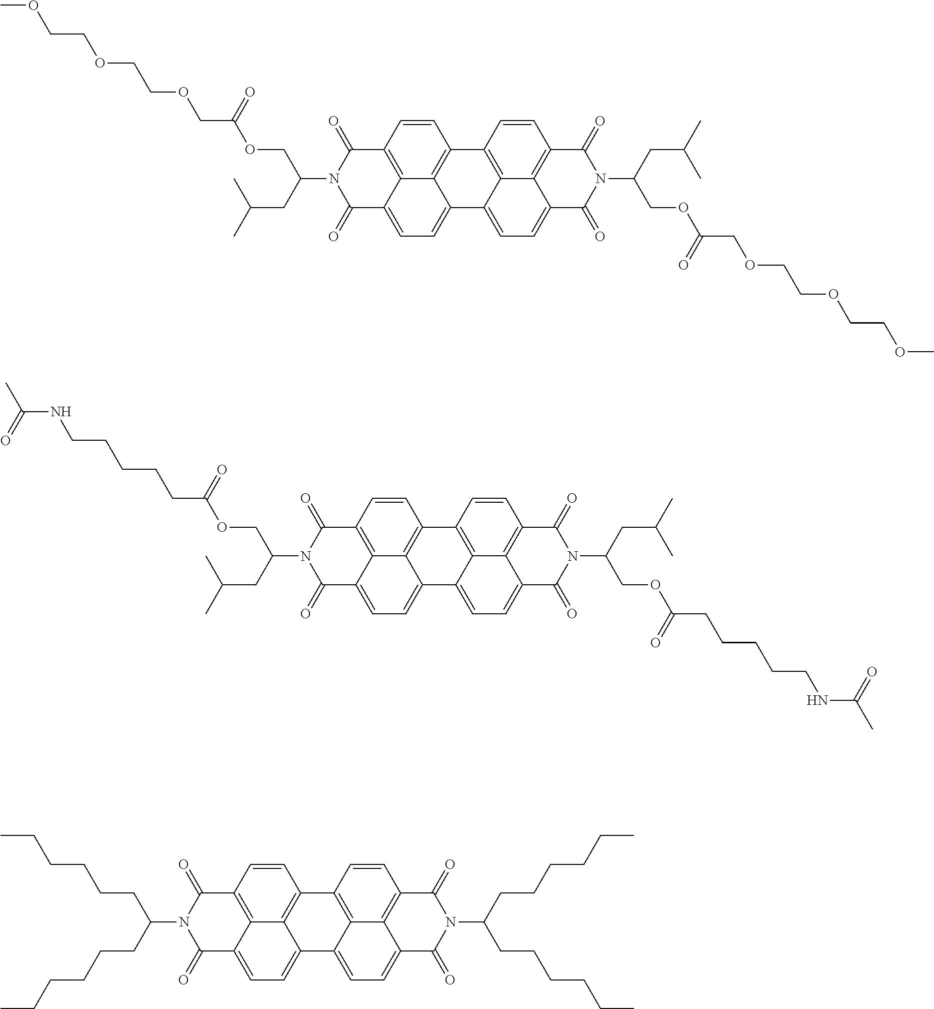

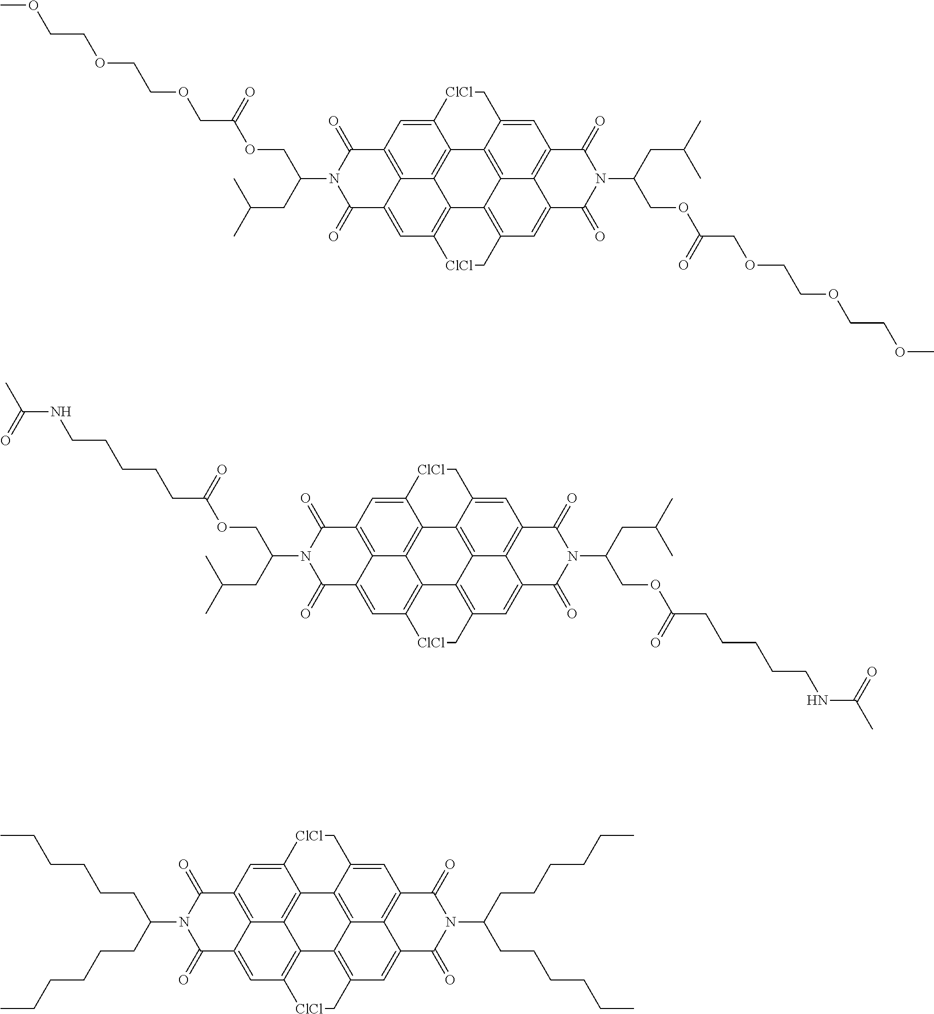

The composition may contain only one type of electron transport compound other than the inventive compound or may contain two or more types thereof.

The content of the electron transport compound in the present composition is preferably 40 parts by mass or more, more preferably 50 parts by mass or more, and still more preferably 60 parts by mass or more, per 100 parts by mass of the total mass of the present composition, from the viewpoint of electron transporting property. Meanwhile, the content is preferably 90 parts by mass or less, more preferably 80 parts by mass or less, and still more preferably 70 parts by mass or less, from the viewpoint of the hardness and elastic deformation rate of the protective layer.

In a case where the present composition contains an electron transport compound other than the inventive compound, the content of the inventive compound is preferably 40 parts by mass or more, more preferably 50 parts by mass or more, and still more preferably 60 parts by mass or more, and may be 100 parts by mass, per 100 parts by mass of the total mass of the electron transport compound in the present composition, from the viewpoint of effectively achieving excellent solvent solubility, electrical characteristics, and mechanical characteristics by the inventive compound.

### Polymerizable Compound Having No Electron Transport Skeleton

The present composition may contain a polymerizable compound having no electron transport skeleton. When the present composition contains a polymerizable compound having no electron transport skeleton, the present protective layer described below contains a polymer of the polymerizable compound having no electron transport skeleton.

The inventive compound has one or more polymerizable functional groups, and therefore can also serve as a curable compound. Therefore, the present composition can form a protective layer with good curability by the method described below even when the present composition does not contain a polymerizable compound having no electron transport skeleton. However, when the polymerizable compound having no electron transport skeleton is used in addition to the inventive compound, the mechanical strength of the formed protective layer can be more sufficiently achieved.

The polymerizable compound having no electron transport skeleton may be a compound having a chain-polymerizable functional group. Especially, a monomer, oligomer, or polymer having a radically polymerizable functional group is preferable. Among these, a curable compound having crosslinkability, particularly a photocurable compound, is preferable. Examples of the compound include a curable compound having two or more radically polymerizable functional groups. A compound having one radically polymerizable functional group may be used in combination.

The radically polymerizable functional group can be, for example, either of an acryloyl group (including an acryloyloxy group) and a methacryloyl group (including a methacryloyloxy group), or both of these groups.

Preferred compounds as the curable compound having a radically polymerizable functional group are exemplified below.

Examples of the monomer having an acryloyl group or a methacryloyl group include trimethylolpropane triacrylate (TMPTA), trimethylolpropane trimethacrylate, pentaerythritol triacrylate, pentaerythritol tetraacrylate, glycerol triacrylate, tris(acryloxyethyl) isocyanurate, dipentaerythritol hexaacrylate, dimethylolpropane tetraacrylate, pentaerythritol ethoxytetraacrylate, EO-modified phosphoric acid triacrylate, 2,2,5,5-tetrahydroxymethylcyclopentanone tetraacrylate, 2-hydroxy-3-acryloyloxypropyl methacrylate, polyethylene glycol diacrylate, polypropylene glycol diacrylate, polytetramethylene glycol diacrylate, EO-modified bisphenol A diacrylate, PO-modified bisphenol A diacrylate, 9,9-bis[4-(2-acryloyloxyethoxy)phenyl]fluorene, tricyclodecane dimethanol diacrylate, decanediol diacrylate, hexanediol diacrylate, ethylene glycol dimethacrylate, polyethylene glycol dimethacrylate, EO-modified bisphenol A dimethacrylate, PO-modified bisphenol A dimethacrylate, tricyclodecane dimethanol dimethacrylate, decanediol dimethacrylate, and hexanediol dimethacrylate.

Examples of the oligomer or polymer having an acryloyl group or a methacryloyl group include urethane acrylate, ester acrylate, acrylic acrylate, and epoxy acrylate. Among these, urethane acrylate and ester acrylate are preferable, and, of these, ester acrylate is more preferable.

The above-described compounds may be used alone, or two or more types thereof may be used in combination.

A preferable example of the polymerizable compound having no electron transport skeleton can be a polyfunctional acrylate compound not having an aromatic ring such as a benzene ring as shown in the following structure. When such a polyfunctional acrylate compound is incorporated, the crosslinkability is enhanced, the hardness of the protective layer is increased, the mechanical strength is increased, and, additionally, the inventive compound can be dispersed, whereby crystallization can be suppressed. Crystallization is not preferable for the photoreceptor because a leakage current is generated.

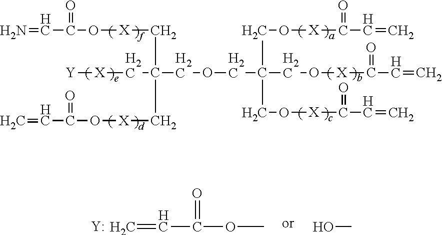

In a case where the present composition contains such a polymerizable compound having no electron transport skeleton, the content ratio (mass ratio) of the polymerizable compound to the electron transport compound in the present composition is preferably 1.5 or less, more preferably 1.0 or less, and still more preferably 0.75 or less, from the viewpoint of electron transporting property. Meanwhile, from the viewpoint of the hardness and elastic deformation rate of the protective layer, the content ratio (mass ratio) is preferably 0.2 or more, more preferably 0.3 or more, and still more preferably 0.4 or more.

The content of the polymerizable compound having no electron transport skeleton in the present composition described above corresponds to the content of the polymer of the present protective layer described below.

### Electron Donating Compound

The present composition may further contain an electron donating compound. When the present composition contains an electron donating compound, the present protective layer described below contains the electron donating compound.

In the present disclosure, the “electron donating compound” means a compound capable of donating electrons to the protective layer. In other words, the “electron donating compound” means a compound capable of decreasing an energy barrier at the time of electron transfer in a target compound (electron transport compound) in the protective layer by any mechanism and injecting electrons into the target compound. As the mechanism, for example, electrons may be directly transferred from the electron donating compound to the target compound, electrons may be transferred by forming a hydrogen bond between the electron donating compound and the target compound, or electrons transferred from the photosensitive layer may be injected into the target compound present in the protective layer by reducing an energy barrier during electron transfer by forming a hydrogen bond between the electron donating compound and the target compound.

Examples of currently known electron donating compounds include compounds having structures such as triphenylmethane, acridine, amine, amidine, aniline, pyridine, xanthene, benzimidazole, guanidine, and phosphazene. Compounds that will be found to have such an action in the future are also included.

As described above, examples of the electron donating compound include compounds having structures such as triphenylmethane, acridine, amine, amidine, aniline, pyridine, xanthene, benzimidazole, guanidine, and phosphazene. Among these, compounds having a benzimidazole structure or a guanidine structure are preferable from the viewpoint of stability. The guanidine structure may be either a chain guanidine structure or a cyclic guanidine structure, but is preferably a cyclic guanidine structure from the viewpoint of stability.

The electron donating compound is preferably a compound having one or more heteroatoms in the molecule, and, especially, a compound having one or more nitrogen atoms (N atoms) in the molecule is more preferable. From the viewpoint of stability, the number of heteroatoms in one molecule of the electron donating compound is preferably 1 or more, more preferably 2 or more, and still more preferably 3 or more. From the viewpoint of an electron donating ability, the number of nitrogen atoms (N atoms) in one molecule of the electron donating compound is preferably 1 or more, more preferably 2 or more, and still more preferably 3 or more.

The electron donating compound is preferably a compound having one or more cyclic structures from the viewpoint of stability.

The electron donating compound is preferably an electron donating compound represented by Formula (4) or Formula (5) described below.

Such an electron donating compound is activated when heated to, for example, room temperature or higher, and can donate electrons to the protective layer. Specifically, the electron donating compound represented by Formula (4) described below is activated when heated to about 80° C. or higher and can donate electrons to the protective layer. The electron donating compound represented by Formula (5) described below is activated when heated to room temperature or higher and can donate electrons to the protective layer. Therefore, for example, when the protective layer is formed, such a compound is activated by an increase in temperature associated with ultraviolet irradiation, and can donate electrons to the protective layer.

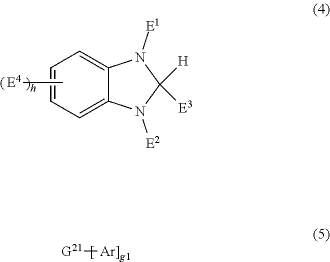

Preferably, in Formula (4), E¹ to E⁴ are each independently a hydrogen atom, a halogen atom, an alkyl group optionally having a substituent, a thioalkyl group optionally having a substituent, a thioaryl group optionally having a substituent, an arylsulfonyl group optionally having a substituent, an amino group optionally having a substituent, an alkylamino group optionally having a substituent, an arylamino group optionally having a substituent, a hydroxy group optionally having a substituent, an alkoxy group optionally having a substituent, an acylamino group optionally having a substituent, an acyloxy group optionally having a substituent, an aromatic hydrocarbon group optionally having a substituent, a carboxy group optionally having a substituent, a carboxamide group optionally having a substituent, a carboalkoxy group optionally having a substituent, an acyl group optionally having a substituent, a sulfonyl group optionally having a substituent, a cyano group optionally having a substituent, a nitro group optionally having a substituent, or a derivative of any of these groups.

E¹ to E⁴ may be bonded together to form a ring.

In Formula (4), h is an integer of 0 or more, and among them, h is preferably 2 or less, more preferably 1 or less, and still more preferably 0, from the viewpoint of stability.

In Formula (5), g1 is an integer of 1 or more, and among them, g1 is preferably 4 or less, more preferably 3 or less, and still more preferably 2 or less, from the viewpoint of electrical characteristics.

In Formula (5), Ar is preferably represented by Formula (6) described below.

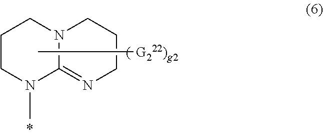

In Formula (6), * represents a bond with G²¹ in Formula (5).

G²² is preferably an alkyl group optionally having a substituent, an alkoxy group optionally having a substituent, or a halogen atom.

In Formula (6), g2 is an integer of 0 or more, and among them, g2 is preferably 2 or less, more preferably 1 or less, and most preferably 0, from the viewpoint of stability.

G²¹ in Formula (5) is preferably a hydrocarbon group optionally having a substituent. The number of carbons of the hydrocarbon group is preferably 1 or more, and more preferably 3 or more, and is preferably 12 or less, and more preferably 10 or less. When g1 is 1, the hydrocarbon group is preferably an alkyl group, and examples thereof include a methyl group, an ethyl group, a propyl group, an isopropyl group, a butyl group, a hexyl group, an octyl group, and a decyl group. When g1 is 2, the hydrocarbon group is preferably an alkylene group, and examples thereof include a methylene group and an ethylene group.

The content of the electron donating compound in the present composition is preferably 0.1 parts by mass or more, more preferably 0.5 parts by mass or more, and still more preferably 1.0 part by mass or more, per 100 parts by mass of the total mass of the present composition, from the viewpoint of electrical characteristics. Meanwhile, the content is preferably 25 parts by mass or less, more preferably 15 parts by mass or less, and still more preferably 5.0 parts by mass or less, per 100 parts by mass of the total mass of the present composition, from the viewpoint of electrical characteristics.

Specific examples of the electron donating compound are shown below. However, the electron donating compound is not limited to these.

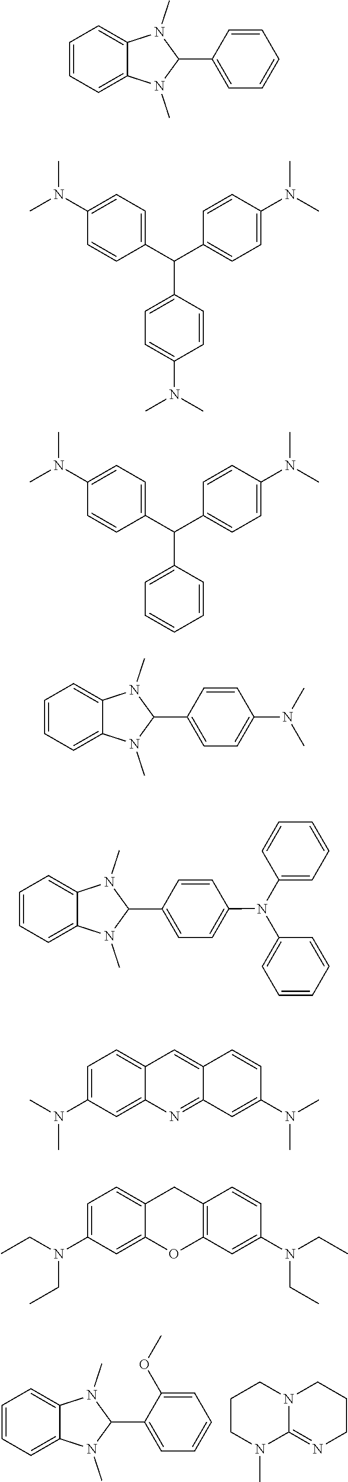

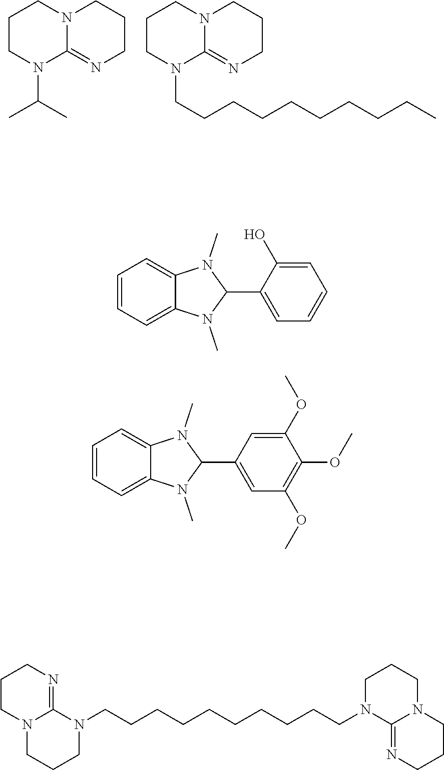

The present composition may contain only one type of these electron donating compounds, or may contain two or more types thereof.

### Polymerization Initiator

Examples of the polymerization initiator include a thermal polymerization initiator and a photopolymerization initiator.

Examples of the thermal polymerization initiator include peroxide-based compounds such as 2,5-dimethylhexane-2,5-dihydroperoxide, and azo-based compounds such as 2,2′-azobis(isobutyronitrile).

The photopolymerization initiator can be classified into a direct cleavage type and a hydrogen abstraction type depending on the difference in radical generation mechanism.

When a direct cleavage type photopolymerization initiator absorbs light energy, a part of the covalent bond in the molecule is cleaved to generate a radical. Meanwhile, in the case of a hydrogen abstraction type photopolymerization initiator, a molecule which is excited by absorbing light energy abstracts hydrogen from a hydrogen donor, thereby generating a radical.

Examples of the direct cleavage type photopolymerization initiator include acetophenone-based or ketal-based compounds such as acetophenone, 2-benzoyl-2-propanol, 1-benzoylcyclohexanol, 2,2-diethoxyacetophenone, benzyl dimethyl ketal, and 2-methyl-4′-(methylthio)-2-morpholinopropiophenone; benzoin ether-based compounds such as benzoin, benzoin methyl ether, benzoin ethyl ether, benzoin isobutyl ether, benzoin isopropyl ether, and O-tosylbenzoin; and acylphosphine oxide-based compounds such as diphenyl(2,4,6-trimethylbenzoyl) phosphine oxide, phenylbis(2,4,6-trimethylbenzoyl) phosphine oxide, and lithium phenyl(2,4,6-trimethylbenzoyl)phosphonate.

Examples of the hydrogen abstraction type photopolymerization initiator include benzophenone-based compounds such as benzophenone, 4-benzoylbenzoic acid, 2-benzoylbenzoic acid, methyl 2-benzoylbenzoate, methyl benzoylformate, benzyl, p-anisyl, 2-benzoylnaphthalene, 4,4′-bis(dimethylamino)benzophenone, 4,4′-dichlorobenzophenone, and 1,4-dibenzoylbenzene; and anthraquinone-based or thioxanthone-based compounds such as 2-ethylanthraquinone, 2-isopropylthioxanthone, 2-chlorothioxanthone, 2,4-dimethylthioxanthone, 2,4-diethylthioxanthone, and 2,4-dichlorothioxanthone.

Examples of other photopolymerization initiators include camphorquinone, 1-phenyl-1,2-propanedione-2-(o-ethoxycarbonyl) oxime, acridine-based compounds, triazine-based compounds, and imidazole-based compounds.

In order to efficiently absorb light energy and generate a radical, the photopolymerization initiator preferably has an absorption wavelength in a wavelength region of a light source used for light irradiation. Especially, an acylphosphine oxide-based compound having an absorption wavelength on a relatively long wavelength side is preferably contained.

From the viewpoint of supplementing curability, it is more preferable to use an acylphosphine oxide-based compound and a hydrogen abstraction type initiator in combination. In this case, the content of the hydrogen abstraction type initiator relative to the acylphosphine oxide-based compound is not particularly limited. The content is preferably 0.1 parts by mass or more per 1 part by mass of the acylphosphine oxide-based compound from the viewpoint of supplementing surface curability, and is preferably 5 parts by mass or less per 1 part by mass of the acylphosphine oxide-based compound from the viewpoint of maintaining internal curability.

A compound having a photopolymerization promoting effect may be used alone or in combination with the photopolymerization initiator. Examples of the compound having a photopolymerization promoting effect include triethanolamine, methyldiethanolamine, ethyl 4-dimethylaminobenzoate, isoamyl 4-dimethylaminobenzoate, (2-dimethylamino)ethyl benzoate, and 4,4′-dimethylaminobenzophenone.

One type of polymerization initiator may be used, or two or more types thereof may be used in combination. The content of the polymerization initiator is from 0.5 to 40 parts by mass, preferably from 1 to 20 parts by mass, per 100 parts by mass of a total contained product having radical polymerizability.

The total contained product having radical polymerizability includes the inventive compound and the polymerizable compound having no electron transport skeleton.

### Inorganic Particles

The present composition may contain inorganic particles from the viewpoint of improving strong exposure characteristics and the mechanical strength of the protective layer to be formed, or from the viewpoint of imparting charge transport ability thereto. However, the inorganic particles are not an essential component of the composition of the present disclosure.

In the present disclosure, by using the inventive compound, a protective layer having excellent mechanical strength can be formed without incorporating inorganic particles.

Examples of the inorganic particles include metal powder, metal oxide, metal fluoride, potassium titanate, and boron nitride, and any type of inorganic particles that can be used in an electrophotographic photoreceptor can be usually used.

Only one type of inorganic particles may be used, or a plurality of types of particles may be used in combination.

### Additional Material

The present composition may contain an additional material other than the above-described ones, as necessary. Examples of the additional material include stabilizers (heat stabilizers, ultraviolet absorbers, light stabilizers, antioxidants, and the like), dispersants, antistatic agents, colorants, and lubricants. One type of these materials may be appropriately used alone, or two or more types thereof may be used in any proportions and in any combination.

### Method for Forming Present Protective Layer

The present protective layer is preferably formed of the present composition described above. Hereinafter, a method for forming the present protective layer using the present composition will be described.

### Coating Liquid for Forming Protective Layer

The present protective layer can be formed by applying a coating liquid obtained by dissolving the above-described present composition, i.e., a curable composition containing an electron transport compound including the inventive compound and, as necessary, containing a polymerizable compound having no electron transport skeleton, an electron donating compound, a polymerization initiator, inorganic particles, and additional materials in a solvent or a coating liquid obtained by dispersing the curable composition in a dispersion medium (hereinafter the coating liquid may also be referred to as “coating liquid for forming the present protective layer”) onto the present photosensitive layer and curing the coating liquid.

The content of the electron transport compound including the inventive compound in the coating liquid for forming the present protective layer is preferably 30 parts by mass or less, more preferably 20 parts by mass or less, and still more preferably 10 parts by mass or less, per 100 parts by mass of the solvent, from the viewpoint of film uniformity and solubility of the protective layer.

The content of the curable compound, i.e., the total content of the inventive compound and the polymerizable compound having no electron transport skeleton in the coating liquid for forming the present protective layer is preferably 30 parts by mass or less, more preferably 20 parts by mass or less, and still more preferably 10 parts by mass or less, per 100 parts by mass of the solvent, from the viewpoint of residual potential. Meanwhile, from the viewpoint of the hardness and elastic deformation rate of the protective layer, the total content is preferably 0.5 parts by mass or more, more preferably 1.0 part by mass or more, and still more preferably 1.5 parts by mass or more.

The content of additional components in the coating liquid for forming the present protective layer, i.e., the content of components other than the electron transport compound and the curable compound contained in the present composition is in accordance with the content of each component in the present composition described above.

The solvent used in the coating liquid for forming the present protective layer can be, for example, an organic solvent.

Examples of the organic solvent include alcohols such as methanol, ethanol, propanol, and 2-methoxyethanol; ethers such as tetrahydrofuran, 1,4-dioxane, and dimethoxyethane; esters such as methyl formate and ethyl acetate; ketones such as acetone, methyl ethyl ketone, and cyclohexanone; aromatic hydrocarbons such as benzene, toluene, xylene, and anisole; chlorinated hydrocarbons such as dichloromethane, chloroform, 1,2-dichloroethane, 1,1,2-trichloroethane, 1,1,1-trichloroethane, tetrachloroethane, 1,2-dichloropropane, and trichloroethylene; nitrogen-containing compounds such as n-butylamine, isopropanolamine, diethylamine, triethanolamine, ethylenediamine, and triethylenediamine; and aprotic polar solvents such as acetonitrile, N-methylpyrrolidone, N,N-dimethylformamide, and dimethyl sulfoxide. A mixed solvent of these solvents in any combination and in any proportions can also be used. Especially, from the viewpoint of solubility and applicability, alcohols, ethers, aromatic hydrocarbons, and aprotic polar solvents are preferable, alcohols, ethers, and aromatic hydrocarbons are more preferable, alcohols and ethers are even more preferable, and alcohols are most preferable.

Even an organic solvent which does not dissolve the electron transport compound used in the protective layer of the inventive photoreceptor by itself can be used as long as the compound can be dissolved in a mixed solvent prepared by mixing the organic solvent with, for example, any of the above-described organic solvents. In general, the use of a mixed solvent can reduce coating unevenness. When a dip coating method is used in the coating method described below, it is preferable to select a solvent that does not dissolve a lower layer. From this viewpoint, it is particularly preferable to incorporate an alcohol.

The amount ratio of the solvent to the solid component used in the coating liquid for forming the present protective layer varies depending on the method for applying the coating liquid for forming the present protective layer, and may be appropriately changed so that a uniform coating film is formed in the coating method to be used.

### Method for Applying Coating Liquid for Forming Present Protective Layer

For forming the present protective layer, the method for applying the coating liquid for forming the present protective layer is not particularly limited, and examples thereof include a spray coating method, a spiral coating method, a ring coating method, and a dip coating method.

After a coating film is formed by the above coating method, the coating film is dried. In this case, the temperature and time of drying are not limited as long as necessary and sufficient drying is achieved. However, when the protective layer is applied only by air drying after application of the photosensitive layer, it is preferable to perform sufficient drying by the method described in a method for forming a photosensitive layer described below.

### Method for Curing Present Protective Layer

The present protective layer can be formed by applying the coating liquid for forming the present protective layer and then curing the coating liquid by applying energy from the outside. Examples of external energy used at this time include heat, light, and radiation. Examples of the method for applying heat energy include heating methods using gases such as air and nitrogen, steam, various heating media, infrared rays, and electromagnetic waves. The heating may be performed from the coated surface side or the support side. The heating temperature is preferably 100° C. or higher and 170° C. or lower.

For application of light energy, a UV irradiation light source such as a high-pressure mercury lamp having an emission wavelength mainly in the ultraviolet (UV) region, a metal halide lamp, an electrodeless lamp bulb, or a light-emitting diode can be used. A visible light source can be selected according to the absorption wavelength of the polymerizable compound or the photopolymerization initiator.

The light irradiation dose is preferably 10 J/cm² or more, more preferably 15 J/cm² or more, and still more preferably 20 J/cm² or more, from the viewpoint of curability. From the viewpoint of electrical characteristics, the light irradiation dose is preferably 400 J/cm² or less, more preferably 200 J/cm² or less, and still more preferably 150 J/cm² or less.

Meanwhile, examples of the energy of radiation include energy obtained using an electron beam (EB).

Among these energies, the energy of light is preferably used from the viewpoint of ease of reaction rate control, simplicity of the apparatus, and the length of pot life.

After curing of the protective layer, a heating step may be added from the viewpoint of relaxation of residual stress, relaxation of residual radicals, and improvement of electrical characteristics. The heating temperature is preferably 60° C. or higher, and more preferably 100° C. or higher, and is preferably 200° C. or lower, and more preferably 150° C. or lower.

### Layer Thickness

The thickness of the present protective layer is preferably 0.5 μm or more, and more preferably 1 μm or more, from the viewpoint of abrasion resistance. Meanwhile, from the viewpoint of electrical characteristics, the thickness is preferably 5 μm or less, and more preferably 4 μm or less.

From the same viewpoint, the thickness of the present protective layer is preferably 1/50 or more, more preferably 1/40 or more, and still more preferably 1/30 or more, with respect to the thickness of the present photosensitive layer. Meanwhile, the thickness is preferably ⅕ or less, more preferably 1/10 or less, and still more preferably 1/20 or less.

### Present Photosensitive Layer

The photosensitive layer in the inventive photoreceptor (hereinafter also referred to as “the present photosensitive layer”) only needs to be a layer containing at least a charge generation material (CGM) and a charge transport material.

The present photosensitive layer may be a single-layer type photosensitive layer containing both a charge generation material and a charge transport material in the same layer, or may be a laminated type photosensitive layer separated into a charge generation layer and a charge transport layer.

### Single-Layer Type Photosensitive Layer

In a case where the present photosensitive layer is a single-layer type photosensitive layer, at least a charge generation material (CGM), a hole transport material (HTM), an electron transport material (ETM), and a binder resin are preferably contained in the same layer.

### Charge Generation Material

As the charge generation material (CGM) used in the present photosensitive layer, various photoconductive materials such as inorganic photoconductive materials and organic pigments can be used. Among these, organic pigments are particularly preferable, and phthalocyanine pigments and azo pigments are more preferable.

In particular, when a phthalocyanine pigment is used as the charge generation material, specifically, metal-free phthalocyanine, phthalocyanine in which a metal such as copper, indium, gallium, tin, titanium, zinc, vanadium, silicon, or germanium, or an oxide or halide thereof is coordinated, or the like is used. Among these, X-type and τ-type metal-free phthalocyanine, A-type, B-type, and D-type titanyl phthalocyanine, vanadyl phthalocyanine, chloroindium phthalocyanine, chlorogallium phthalocyanine, hydroxygallium phthalocyanine, and the like, which have particularly high sensitivity, are suitable.

In the case of using an azo pigment, various known bisazo pigments and trisazo pigments are suitably used.

One type of charge generation material may be used alone, or two or more types thereof may be used in any combination and in any proportions. Further, in the case of using two or more types of charge generation materials in combination, as a method of mixing the charge generation materials to be used in combination, the respective charge generation materials may be mixed later, or may be mixed in production and treatment steps of the charge generation materials, such as synthesis, pigmentation, and crystallization.

From the viewpoint of electrical characteristics, the particle size of the charge generation material is desirably small. Specifically, the particle size of the charge generation material is preferably 1 μm or less, and more preferably 0.5 μm or less, and the lower limit thereof is 0.01 μm or more. The particle size of the charge generation material means the particle size of the charge generation material contained in the photosensitive layer.

Further, the amount of the charge generation material in the single-layer type photosensitive layer is preferably 0.1 mass % or more, and more preferably 0.5 mass % or more, from the viewpoint of sensitivity. The amount is preferably 50 mass % or less, and more preferably 20 mass % or less, from the viewpoint of sensitivity and chargeability.

### Charge Transport Material

The charge transport material is classified into a hole transport material mainly having a hole transport ability and an electron transport material mainly having an electron transport ability. However, in a case where the present photosensitive layer is a single-layer type photosensitive layer, at least a hole transport material and an electron transport material are preferably contained in the same layer.

### Hole Transport Material

The hole transport material (HTM) can be selected from known materials and used. Examples of the hole transport material include heterocyclic compounds such as carbazole derivatives, indole derivatives, imidazole derivatives, oxazole derivatives, pyrazole derivatives, thiadiazole derivatives, and benzofuran derivatives, aniline derivatives, hydrazone derivatives, arylamine derivatives, stilbene derivatives, butadiene derivatives, enamine derivatives, and electron donating materials such as compounds in which a plurality of these compounds are bonded, and polymers having a group made of these compounds in a main chain or a side chain.

Among these, carbazole derivatives, arylamine derivatives, stilbene derivatives, butadiene derivatives, enamine derivatives, and compounds in which a plurality of these compounds are bonded are preferable, and arylamine derivatives and enamine derivatives are more preferable.

Only one type of hole transport material may be used alone, or two or more types thereof may be used in any combination and in any proportions.

The amount of the hole transport material in the single-layer type photosensitive layer is preferably 20 mass % or more, and more preferably 30 mass % or more, per 100 mass % of the entire present photosensitive layer, from the viewpoint of hole transporting property. The amount is preferably 55 mass % or less, and more preferably 45 mass % or less, from the viewpoint of solubility.

### Electron Transport Material

The electron transport material (ETM) can be selected from known materials and used. Examples of the electron transport material include electron attracting materials including aromatic nitro compounds such as 2,4,7-trinitrofluorenone, cyano compounds such as tetracyanoquinodimethane, and quinone compounds such as diphenoquinone, known cyclic ketone compounds, and perylene pigments (perylene derivatives). Among these, from the viewpoint of electrical characteristics, a quinone compound and a perylene pigment (perylene derivative) are preferable, and a quinone compound is more preferable.

Among the quinone compounds, diphenoquinone or dinaphthylquinone is preferable from the viewpoint of electrical characteristics. Among these, dinaphthylquinone is more preferable.

Only one type of electron transport material may be used alone, or two or more types thereof may be used in any combination and in any proportions.

Structures of preferred electron transport materials are exemplified below.

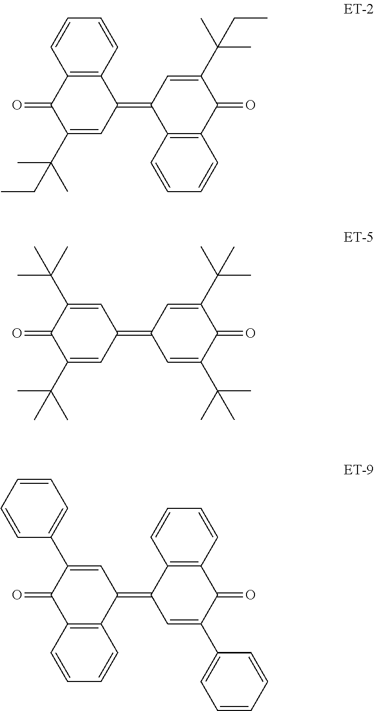 [SMILES: CCC(C)(C)C1=C/C(=C2/C=C(C(C)(C)CC)C(=O)c3ccccc32)c2ccccc2C1=O ; CC(C)(C)C1=CC(=C2C=C(C(C)(C)C)C(=O)C(C(C)(C)C)=C2)C=C(C(C)(C)C)C1=O ; O=C1C(c2ccccc2)=C/C(=C2/C=C(c3ccccc3)C(=O)c3ccccc32)c2ccccc21]

Among the electron transport materials described above, ET-2 and ET-5 are preferable, and ET-2 is more preferable, from the viewpoint of electrical characteristics.

The amount of the electron transport material in the single-layer type photosensitive layer is preferably 15 mass % or more, and more preferably 25 mass % or more, per 100 mass % of the entire present photosensitive layer, from the viewpoint of electron transporting property. The amount is preferably 40 mass % or less, and more preferably 30 mass % or less, from the viewpoint of solubility.

### Binder Resin

Examples of the binder resin used in the present photosensitive layer include vinyl polymers such as polymethyl methacrylate, polystyrene, and polyvinyl chloride or copolymers thereof; vinyl alcohol resins; polyvinyl butyral resins; polyvinyl formal resins; partially modified polyvinyl acetal resins; polyarylate resins; polyamide resins; polyurethane resins; polycarbonate resins; polyester resins; polyester carbonate resins; polyimide resins; phenoxy resins; epoxy resins; silicone resins; and partially crosslinked cured products thereof. The resin may be modified with a silicon reagent or the like. One type of these resins may be used alone, or two or more types thereof may be used in any proportions and in any combination.

The binder resin used in the present photosensitive layer preferably contains one type or two or more types of polymers obtained by interfacial polymerization.

As the binder resin obtained by the interfacial polymerization, a polycarbonate resin and a polyester resin are preferable, and a polycarbonate resin or a polyarylate resin is particularly preferable. In particular, a polymer made from an aromatic diol as a raw material is preferable.

### Additional Material

In addition to the above materials, the present photosensitive layer may contain an additive such as a well-known antioxidant, plasticizer, ultraviolet absorber, electron attracting compound, leveling agent, or visible light shielding agent for improving film formability, flexibility, applicability, stain resistance, gas resistance, light resistance, or the like. The present photosensitive layer may contain any additive such as a sensitizer, a dye, a pigment (excluding the charge generation material, the hole transport material, and the electron transport material described above), or a surfactant, as necessary. Examples of the surfactant include silicone oil and fluorine-based compounds. In the present disclosure, as appropriate, one type of these may be used alone, or two or more types thereof may be used in any proportions and in any combination.

For the purpose of reducing frictional resistance of the surface of the photosensitive layer, the present photosensitive layer may contain a fluorine-based resin, a silicone resin, or the like, or may contain particles made of such a resin or particles of an inorganic compound such as aluminum oxide.

### Layer Thickness

In a case where the present photosensitive layer is a single-layer type photosensitive layer, the thickness of the present photosensitive layer is preferably 20 μm or more, and more preferably 25 μm or more, from the viewpoint of dielectric breakdown resistance. Meanwhile, from the viewpoint of electrical characteristics, the thickness is preferably 50 μm or less, and more preferably 40 μm or less.

### Laminated Type Photosensitive Layer

When the inventive photoreceptor is a laminated type photosensitive layer, the photosensitive layer can have, for example, a structure in which a charge transport layer (CTL) containing a charge transport material is laminated on a charge generation layer (CGL) containing a charge generation material (CGM). In this case, an additional layer other than the charge generation layer (CGL) and the charge transport layer (CTL) can also be provided.

### Charge Generation Layer (CGL)

The charge generation layer (CGL) usually contains a charge generation material (CGM) and a binder resin.

The charge generation material (CGM) and the binder resin are the same as those described above for the single-layer type photosensitive layer.

The charge generation layer may contain an additional component as necessary in addition to the charge generation material and the binder resin. The charge generation layer may contain an additive such as a known antioxidant, plasticizer, ultraviolet absorber, electron attracting compound, leveling agent, visible light shielding agent, or filler, for the purpose of improving, for example, film formability, flexibility, applicability, stain resistance, gas resistance, or light resistance.

In the charge generation layer, when the proportion of the charge generation material is too high, the stability of the coating liquid may be lowered due to aggregation of the charge generation material, whereas when the proportion of the charge generation material is too low, the sensitivity as a photoreceptor may be lowered. Therefore, the blending proportion (mass) of the charge generation material is preferably 10 parts by mass or more, and more preferably 30 parts by mass or more, per 100 parts by mass of the binder resin. Meanwhile, the blending proportion (mass) of the charge generation material is preferably 1000 parts by mass or less, and more preferably 500 parts by mass or less, per 100 parts by mass of the binder resin. From the viewpoint of film strength, the proportion is more preferably 300 parts by mass or less, and particularly preferably 200 parts by mass or less.

The thickness of the charge generation layer is preferably 0.1 μm or more, and more preferably 0.15 μm or more. Meanwhile, the thickness is preferably 10 μm or less, and more preferably 0.6 μm or less.

### Charge Transport Layer (CTL)

The charge transport layer (CTL) usually contains a charge transport material and a binder resin.

The charge transport material and the binder resin are the same as those described above for the single-layer type photosensitive layer.

In the charge transport layer (CTL), regarding the blending proportion of the hole transport material (HTM) relative to the binder resin, the hole transport material (HTM) is preferably blended in a proportion of 20 parts by mass or more, more preferably blended in a proportion of 30 parts by mass or more from the viewpoint of reducing the residual potential, and still more preferably blended in a proportion of 40 parts by mass or more from the viewpoint of stability and charge mobility in repeated use, per 100 parts by mass of the binder resin. Meanwhile, from the viewpoint of thermal stability of the photosensitive layer, the hole transport material (HTM) is preferably blended in a proportion of 200 parts by mass or less, more preferably blended in a proportion of 150 parts by mass or less from the viewpoint of compatibility between the hole transport material (HTM) and the binder resin, and particularly preferably blended in a proportion of 120 parts by mass or less from the viewpoint of glass transition temperature, per 100 parts by mass of the binder resin.

In the charge transport layer (CTL), regarding the blending proportion of the electron transport material (ETM) relative to the binder resin, the electron transport material (ETM) is preferably blended in a proportion of 20 parts by mass or more, more preferably blended in a proportion of 30 parts by mass or more from the viewpoint of reducing the residual potential, and still more preferably blended in a proportion of 40 parts by mass or more from the viewpoint of stability and charge mobility in repeated use, per 100 parts by mass of the binder resin. Meanwhile, from the viewpoint of thermal stability of the photosensitive layer, the electron transport material (ETM) is preferably blended in a proportion of 200 parts by mass or less, more preferably blended in a proportion of 150 parts by mass or less from the viewpoint of compatibility between the electron transport material (ETM) and the binder resin, and particularly preferably blended in a proportion of 120 parts by mass or less from the viewpoint of glass transition temperature, per 100 parts by mass of the binder resin.

The charge transport layer may contain an additional component as necessary in addition to the electron transport material (ETM), the hole transport material (HTM), and the binder resin. The charge transport layer may contain an additive such as a known antioxidant, plasticizer, ultraviolet absorber, electron attracting compound, leveling agent, visible light shielding agent, or filler, for the purpose of improving, for example, film formability, flexibility, applicability, stain resistance, gas resistance, or light resistance.

The thickness of the charge transport layer is not particularly limited. From the viewpoint of electrical characteristics, image stability, and further high resolution, the thickness is preferably 5 μm or more and 50 μm or less, more preferably 10 μm or more and 40 μm or less, and still more preferably 15 μm or more and 35 μm or less.

### Method for Forming Present Photosensitive Layer

In each of the laminated type and the single-layer type, the respective layers described above can be formed as follows.

The layers can be formed by repeating, for each layer sequentially, steps of applying a coating liquid obtained by dissolving or dispersing a material to be contained in a solvent onto the electroconductive support by a known method such as dip coating, spray coating, nozzle coating, bar coating, roll coating, or blade coating, and drying the coating liquid.

However, the method is not limited to such a forming method.

The solvent or dispersion medium used for preparing the coating liquid is not particularly limited. Specific examples of the solvent or dispersion medium include alcohols, ethers, aromatic hydrocarbons, and chlorinated hydrocarbons. One type of these may be used alone, or two or more types thereof may be used in any combination and species.

The amount of the solvent or the dispersion medium to be used is not particularly limited. It is preferable to appropriately adjust the solid component concentration and physical properties such as viscosity of the coating liquid to be in desired ranges in consideration of the purpose of each layer and the properties of the selected solvent or dispersion medium.

The coating film is preferably dried by heating at rest or under air blowing usually in a temperature range of 30° C. or higher and 200° C. or lower from 1 minute to 2 hours after drying to touch at room temperature. The heating temperature may be constant, or the heating may be performed while changing the temperature during drying.

### Electroconductive Support

The electroconductive support of the inventive photoreceptor (hereinafter also referred to as “the present electroconductive support”) is not particularly limited as long as it supports a layer formed thereon and exhibits electroconductivity.

As the present electroconductive support, for example, a metal material such as aluminum, an aluminum alloy, stainless steel, copper, or nickel, a resin material to which electroconductivity is imparted by coexistence of an electroconductive powder of metal, carbon, or tin oxide, or a resin, glass, paper, or the like having an electroconductive material such as aluminum, nickel, or ITO (indium tin oxide alloy) deposited or applied on the surface thereof can be mainly used.

The present electroconductive support may be in the form of a drum, cylinder, sheet, belt, or the like.

The present electroconductive support may be an electroconductive support made of a metal material to which an electroconductive material having an appropriate resistance value is applied for controlling electroconductivity, surface properties, and the like or for covering defects.

When a metal material such as an aluminum alloy is used as the present electroconductive support, an anodized film may be applied to the metal material before use.

The average thickness of the anodized film is preferably 20 μm or less, and more preferably 7 μm or less.

In the case of forming an anodized film on the metal material, it is preferable to perform sealing treatment. The sealing treatment can be performed by a known method.

The surface of the present electroconductive support may be smoothed or may be roughened by using a special machining method or by performing a polishing treatment. The support may be roughened by mixing particles having an appropriate particle size with the material constituting the support.

### Present Undercoat Layer

The inventive photoreceptor may have an undercoat layer (also referred to as “the present undercoat layer”) between the present electroconductive support and the present photosensitive layer for the purpose of improving adhesiveness, blocking property, and the like.

As the present undercoat layer, for example, a resin, a resin in which particles of an organic pigment, a metal oxide, or the like are dispersed, or the like can be used. The undercoat layer may contain a known antioxidant or the like.

Examples of the organic pigment used in the undercoat layer include phthalocyanine pigments, azo pigments, and perylene pigments. Among these, phthalocyanine pigments or azo pigments, specifically, phthalocyanine pigments or azo pigments used as the charge generation material described above can be indicated.

Examples of the metal oxide particles used in the present undercoat layer include particles of a metal oxide containing one type of metal element, such as titanium oxide, aluminum oxide, silicon oxide, zirconium oxide, zinc oxide, or iron oxide, and particles of a metal oxide containing a plurality of metal elements, such as calcium titanate, strontium titanate, and barium titanate. In the undercoat layer, only one type of the particles may be used, or a plurality of types of the particles may be mixed and used in any proportions and in any combination.

Among the metal oxide particles described above, titanium oxide and aluminum oxide are preferable, and titanium oxide is particularly preferable.

The particle size of the metal oxide particles used in the present undercoat layer is not particularly limited. From the viewpoint of the properties of the undercoat layer and the stability of a dispersion for forming the undercoat layer, the average primary particle size is preferably 10 nm or more, and is preferably 100 nm or less, and more preferably 50 nm or less.

The binder resin used in the present undercoat layer can be selected from, for example, polyvinyl acetal-based resins such as polyvinyl butyral resins; and insulating resins such as polyarylate resins, polycarbonate resins, polyester resins, phenoxy resins, acrylic resins, methacrylic resins, polyamide resins, polyurethane resins, epoxy resins, silicone resins, polyvinyl alcohol resins, and styrene-alkyd resins. However, the polymer is not limited to these polymers. These binder resins may be used alone, two or more types thereof may be used in combination, or they may be used in a form cured with a curing agent.

Among these, polyvinyl acetal-based resins, alcohol-soluble copolymerized polyamides, modified polyamides, and the like are preferable because they exhibit good dispersibility and applicability. Among them, alcohol-soluble copolymerized polyamides are particularly preferable.

The mixing ratio of the particles to the binder resin can be optionally selected, but the particles are preferably used in a range of 10 mass % to 500 mass % from the viewpoint of the stability and applicability of the dispersion.

The thickness of the present undercoat layer may be optionally selected. The thickness is preferably 0.1 μm or more, and more preferably 20 μm or less, in view of the characteristics of the electrophotographic photoreceptor and the applicability of the dispersion.

### Additional Layer

The inventive photoreceptor may appropriately have an additional layer as necessary, in addition to the present electroconductive support, the present photosensitive layer, the present protective layer, and the present undercoat layer described above.

### Physical Property of Inventive Photoreceptor

The inventive photoreceptor can have the following physical properties.

### Martens Hardness

In the inventive photoreceptor, from the viewpoint of providing practically sufficient abrasion resistance, the Martens hardness is preferably 175 N/mm² or more, more preferably 200 N/mm² or more, and still more preferably 220 N/mm² or more, although it varies depending on the composition of the components of the protective layer.

In the present disclosure, the Martens hardness of the photoreceptor means a Martens hardness as measured from the surface side of the photoreceptor.

The Martens hardness can be measured by a method described in Examples described below.

### Elastic Deformation Rate

From the viewpoint of providing practically sufficient abrasion resistance, the elastic deformation rate of the inventive photoreceptor is preferably 25% or more, more preferably 30% or more, and still more preferably 40% or more, although it varies depending on the composition of the components of the protective layer.

In the present disclosure, the elastic deformation rate of the photoreceptor means an elastic deformation rate as measured from the surface side of the photoreceptor.

The elastic deformation rate can be measured by a method described in Examples described below.

### Residual Potential

In the inventive photoreceptor, from the viewpoint of providing a practically sufficient residual potential, the residual potential is preferably 250 V or less, more preferably 200 V or less, still more preferably 150 V or less, and yet still more preferably 100 V or less, although it varies depending on the composition of the components of the protective layer.

In the present disclosure, the residual potential of the photoreceptor means a potential after the photoreceptor is charged and irradiated with exposure light.

The residual potential can be measured by a method described in Examples described below.

### Inventive Image Forming Apparatus

An image forming apparatus (hereinafter also referred to as “the inventive image forming apparatus”) can be configured using the inventive photoreceptor.

However, the inventive image forming apparatus described below is an example of an image forming apparatus that can be configured using the present electrophotographic photoreceptor.

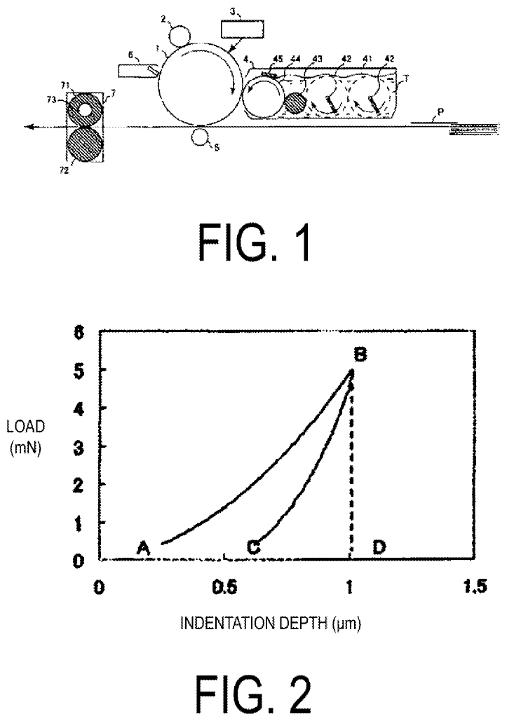

As illustrated in FIG. 1, the inventive image forming apparatus includes an inventive photoreceptor 1, a charging device 2, an exposure device 3, and a developing device 4, and further optionally includes a transfer device 5, a cleaning device 6, and a fixing device 7.

The inventive photoreceptor 1 is not particularly limited as long as it is the above-described inventive photoreceptor. FIG. 1 illustrates, as an example of the inventive photoreceptor 1, a drum-shaped photoreceptor in which the above-described photosensitive layer is formed on the surface of a cylindrical electroconductive support. The charging device 2, the exposure device 3, the developing device 4, the transfer device 5, and the cleaning device 6 are disposed along the outer peripheral surface of the inventive photoreceptor 1.

Examples of the charging device 2 include a non-contact corona charging device such as a corotron or a scorotron, or a contact charging device (direct charging device) that charges the surface of the photoreceptor by bringing a voltage-applied charging member into contact with the surface of the photoreceptor. Examples of the contact charging device include a charging roller and a charging brush. FIG. 1 illustrates a roller-type charging device (charging roller) as an example of the charging device 2.

The type of the exposure device 3 is not particularly limited as long as the exposure device 3 can expose the inventive photoreceptor 1 to light to form an electrostatic latent image on a photosensitive surface of the inventive photoreceptor 1.

Alternatively, the exposure may be performed by a photoreceptor internal exposure method. Any type of light is used for the exposure.

A toner T may be of any type, and may be a powdery toner, or a polymerized toner obtained by suspension polymerization, emulsion polymerization, or the like.

The developing device 4 also has any configuration. The developing device 4 illustrated in FIG. 1 has a configuration in which the toner T is formed into a thin layer by a regulating member (developing blade) 45, is frictionally charged to a predetermined polarity, is conveyed while being carried on a developing roller 44, and is brought into contact with the surface of the photoreceptor 1. However, the developing device 4 is not limited to this configuration.

The type of the transfer device 5 is not particularly limited, and a device using any method such as an electrostatic transfer method such as corona transfer, roller transfer, or belt transfer, a pressure transfer method, or an adhesive transfer method can be used.

The cleaning device 6 is not particularly limited. For example, any cleaning device such as a brush cleaner, a magnetic roller cleaner, or a blade cleaner can be used. When the amount of the toner remaining on the surface of the photoreceptor is small or almost zero, the cleaning device 6 may be omitted.

The fixing device 7 also has any configuration.

The image forming apparatus may have, besides the above-described configuration, for example, a configuration that can perform an electrostatic elimination step.

The image forming apparatus may be configured in a further modified manner, and may be configured to be able to perform, for example, a pre-exposure step, an auxiliary charging step, and the like, may be configured to perform offset printing, or may be configured to be a full-color tandem system using a plurality of types of toners.

### Inventive Cartridge

The inventive photoreceptor 1 may be combined with one or two or more of the charging device 2, the exposure device 3, the developing device 4, the transfer device 5, the cleaning device 6, and the fixing device 7 to form an integrated cartridge (referred to as “the inventive cartridge”).

However, the inventive cartridge described below is an example of an electrophotographic cartridge that can be configured using the present electrophotographic photoreceptor.

The inventive cartridge may have a configuration that is detachably mounted on a main body of an electrophotographic apparatus such as a copying machine or a laser beam printer. In such a case, for example, when the inventive photoreceptor 1 or another member is deteriorated, the electrophotographic photoreceptor cartridge is detached from the main body of the image forming apparatus, and another new electrophotographic photoreceptor cartridge is attached to the main body of the image forming apparatus, whereby the image forming apparatus is easily maintained and managed.

### Description of Terms

In the present disclosure, the meaning of the expression “X to Y” (X and Y are any numerals) includes “X or more and Y or less” and “preferably more than X” or “preferably less than Y” unless otherwise specified.

In addition, when “X or more” or “X≤” (X is any numeral) is described, the meaning thereof includes “preferably more than X” unless otherwise specified, and when “Y or less” or “≤Y” (Y is any numeral) is described, the meaning thereof includes “preferably less than Y” unless otherwise specified.

### EXAMPLES

Hereinafter, embodiments of the present disclosure will be described in more detail with reference to Examples. However, the following Examples are described for illustrating the present disclosure in detail, and the present disclosure is not limited to the Examples described below and can be carried out with any modification without departing from the gist of the present disclosure. In the following Examples and Comparative Examples, the term “part(s)” means “part(s) by mass” unless otherwise specified.

In the present specification, DMF denotes N,N-dimethylformamide, NMP denotes N-methyl-2-pyrrolidone, Et denotes an ethyl group, Ac denotes an acetyl group, and MEHQ denotes 4-methoxyphenol.

### Synthesis of Compound

Methods for synthesizing Compounds 1 to 12 indicated below will be described.

### Synthesis of Compound 1

A synthesis scheme of Compound 1 is described below.

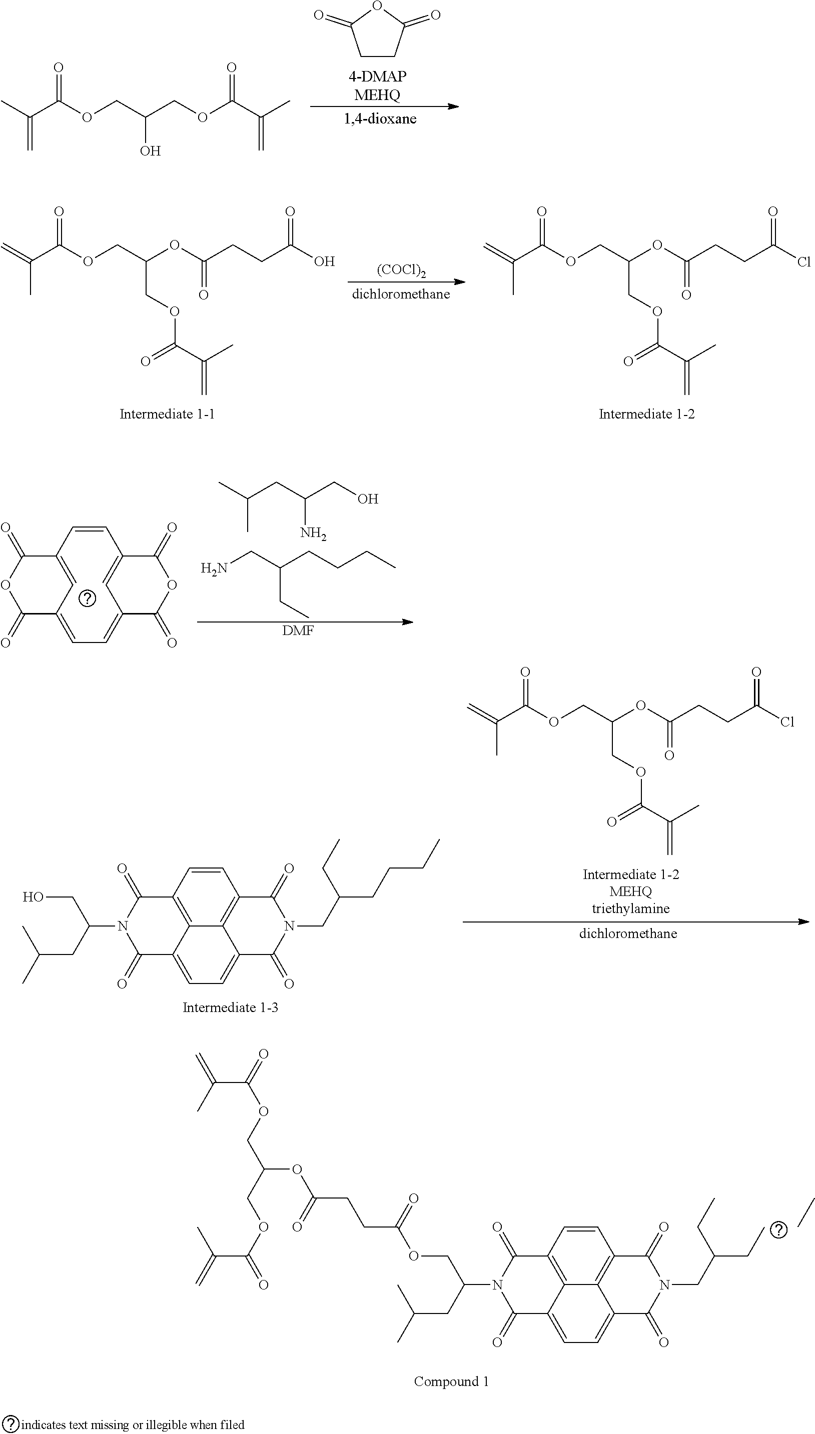

A synthetic procedure for Compound 1 is described below.

### Synthesis of Intermediate 1-1

Under a nitrogen atmosphere, 100 mL of 1,4-dioxane was added to a mixture of succinic anhydride (11.0 g, 109.5 mmol) and 4-DMAP (4-dimethylaminopyridine, 0.26 g, 2.19 mmol) to prepare a solution. To this solution was added dropwise a solution of glycerol dimethacrylate (25 g, 109.5 mmol) and MEHQ (27 mg, 0.22 mmol) in 50 mL of 1,4-dioxane, and the mixture was stirred at 80° C. for 9 hours. The mixture was cooled to room temperature, then poured into 200 mL of water, and subjected to extraction with dichloromethane. The organic layer was washed with water and then dried over magnesium sulfate. The solid was filtered, the solvent of the filtrate was distilled off under reduced pressure, and the residue was dried, to produce Intermediate 1-1 (yield: 30 g, yield percentage: 83 mass %).

### Synthesis of Intermediate 1-2

Under a nitrogen atmosphere, 100 mL of dehydrated dichloromethane and 1 mL of dehydrated dimethylformamide were added to Intermediate 1-1 (21.6 g, 65.8 mmol), and the mixture was cooled with ice. Oxalyl chloride (11.2 mL, 131.6 mmol) was added dropwise, and the mixture was stirred under ice cooling for 2 hours and stirred at room temperature for 12 hours. The solvent was distilled off under reduced pressure, and the residue was then dried to produce Intermediate 1-2 (yield: 21.5 g, yield percentage: 94 mass %).

### Synthesis of Intermediate 1-3

Under a nitrogen atmosphere, 60 mL of N,N-dimethylformamide was added to naphthalene-1,4,5,8-tetracarboxylic dianhydride (7.18 g, 26.8 mmol) to prepare a solution. To this solution was added dropwise a mixed solution of L-(+)-leucinol (4.71 g, 40.2 mmol) and 2-ethylhexylamine (5.19 g, 40.2 mmol) in 40 mL of N,N-dimethylformamide, and the mixed solution was stirred at 120° C. for 8 hours. The mixed solution was cooled to room temperature, and then poured into 200 mL of ice water, and 1 N hydrochloric acid was added to make the reaction solution acidic. The solution was subjected to extraction with dichloromethane, and the organic layer was washed with water and dried over magnesium sulfate, and the resultant solid was filtered. The solvent of the filtrate was distilled off under reduced pressure, and then the residue was dried, to produce Intermediate 1-3 (yield: 10.7 g, yield percentage: 84 mass %).

### Synthesis of Compound 1

Under a nitrogen atmosphere, 150 mL of dehydrated dichloromethane and triethylamine (11.7 mL, 84.4 mmol) were added to Intermediate 1-3 (10.1 g, 21.1 mmol) and 4-methoxyphenol (0.01 g), and the mixture was cooled with ice. Intermediate 1-2 (14.6 g, 42.2 mmol) dissolved in 50 mL of dehydrated dichloromethane was added dropwise, and the mixture was stirred under ice cooling for 1 hour and stirred at room temperature for 12 hours. The reaction solution was poured into 100 mL of water, and subjected to extraction with dichloromethane. The organic layer was washed with water and then dried over magnesium sulfate. The resultant solid was filtered, the solvent of the filtrate was distilled off under reduced pressure, and the residue was subjected to silica gel column chromatography to produce Compound 1 (yield: 5.3 g, yield percentage: 32 mass %).

### Synthesis of Compound 2

A synthesis scheme of Compound 2 is described below.

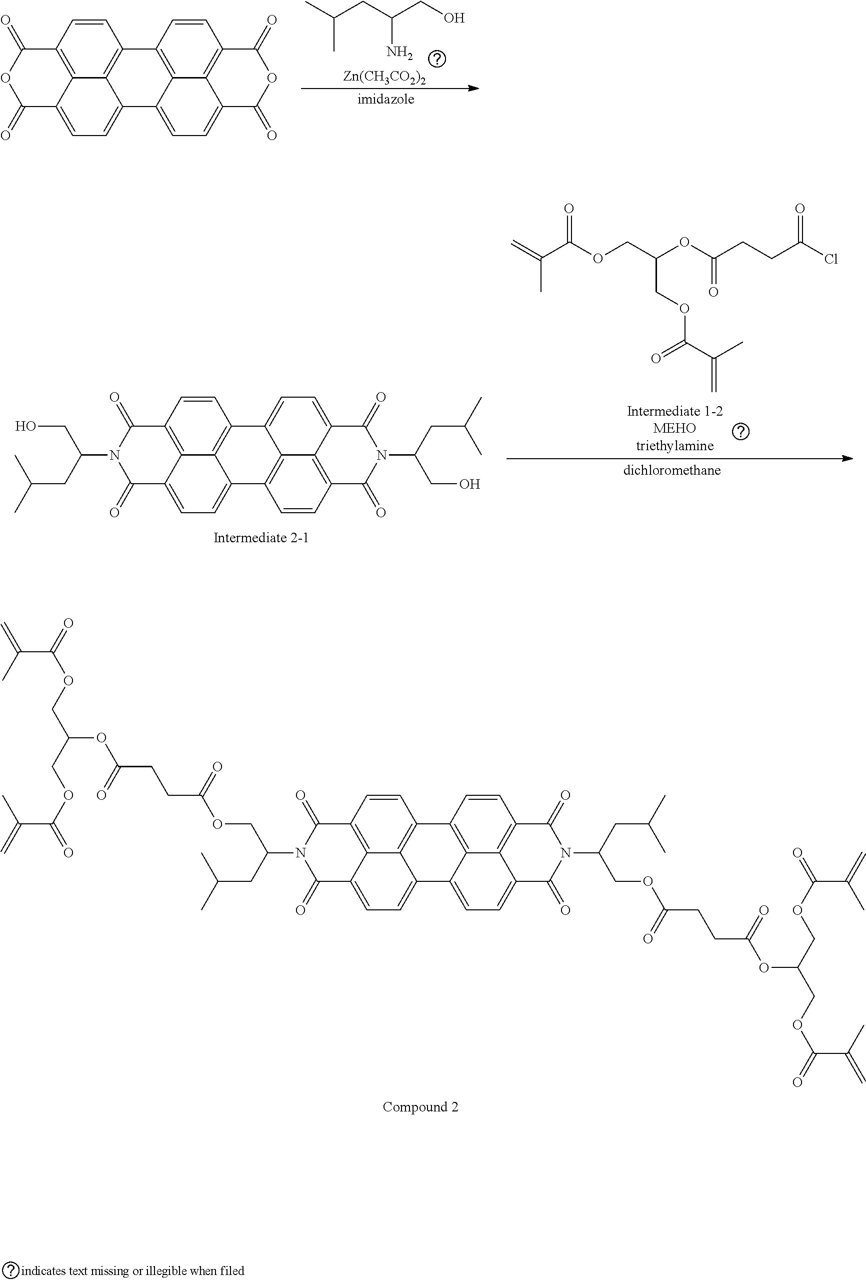

A synthetic procedure for Compound 2 is described below.

### Synthesis of Intermediate 2-1

Under a nitrogen atmosphere, 3,4,9,10-perylenetetracarboxylic dianhydride (11.4 g, 29.0 mmol), zinc acetate (5.32 g, 29.0 mmol), 50 g of imidazole, and L-(+)-leucinol (8.5 g, 72.5 mmol) were mixed, and the mixture was stirred at 160° C. for 7 hours. The mixture was cooled to room temperature, and then dissolved in dichloromethane. This solution was poured into 200 mL of ice water, and 1 N hydrochloric acid was added to make the reaction solution acidic. The reaction solution was subjected to extraction with dichloromethane, and the organic layer was washed with water and then dried over magnesium sulfate. The resultant solid was filtered, the solvent of the filtrate was distilled off under reduced pressure, and the residue was subjected to silica gel column chromatography to produce Intermediate 2-1 (yield: 12.0 g, yield percentage: 70 mass %).

### Synthesis of Compound 2

Under a nitrogen atmosphere, 150 mL of dehydrated dichloromethane and triethylamine (29.5 mL, 213 mmol) were added to Intermediate 2-1 (21.0 g, 35.5 mmol) and 4-methoxyphenol (0.05 g), and the mixture was cooled with ice. Intermediate 1-2 (36.9 g, 107 mmol) dissolved in 50 mL of dehydrated dichloromethane was added dropwise, and the mixture was stirred under ice cooling for 1 hour and stirred at room temperature for 2 hours. The reaction solution was poured into 100 mL of water, and subjected to extraction with dichloromethane. The organic layer was washed with water and then dried over magnesium sulfate. The resultant solid was filtered, the solvent of the filtrate was distilled off under reduced pressure, and the residue was subjected to silica gel column chromatography to produce Compound 2 (yield: 32.5 g, yield percentage: 76 mass %).

### Synthesis of Compound 3

A synthesis scheme of Compound 3 is described below.

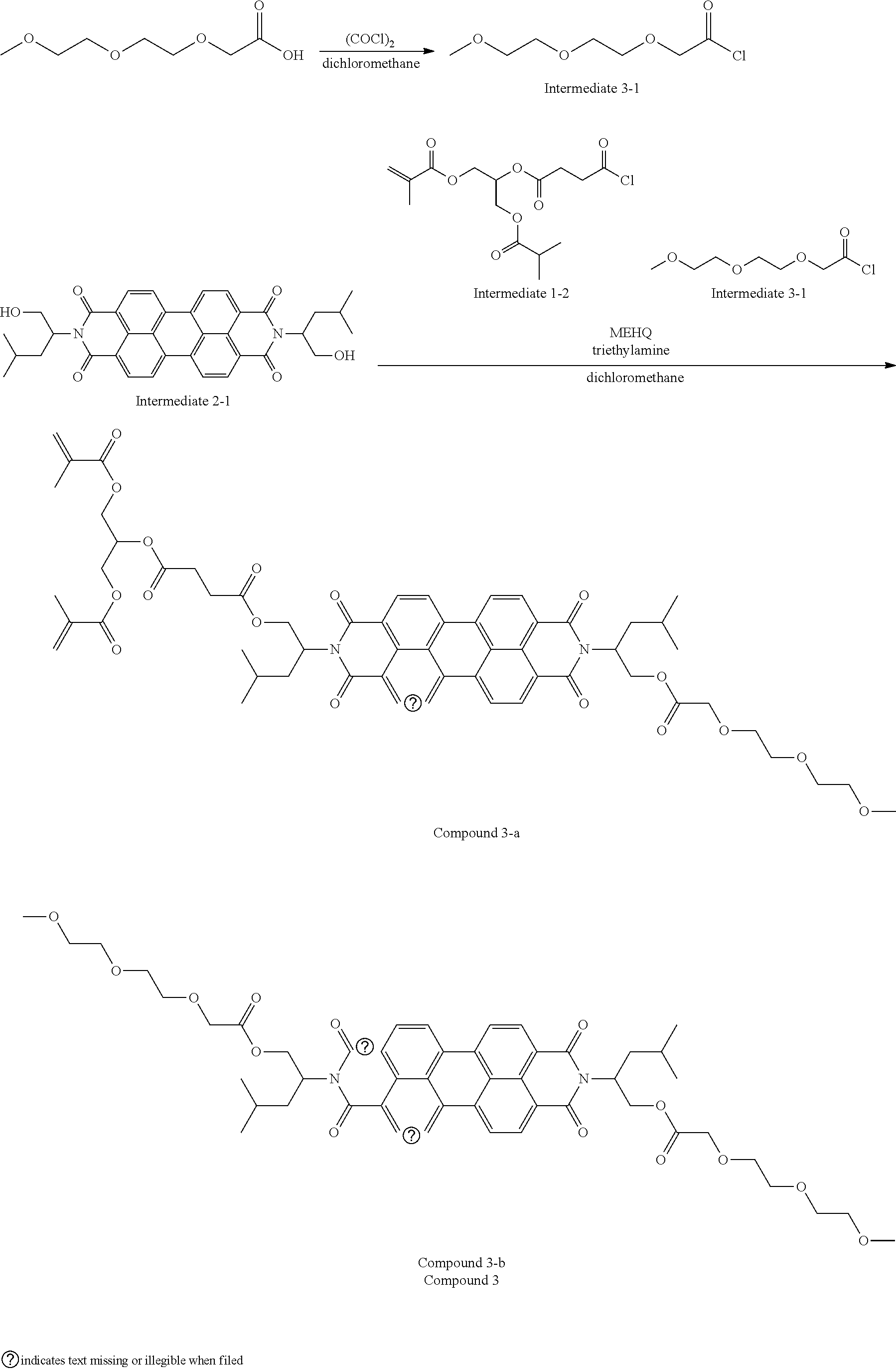

A synthetic procedure for Compound 3 is described below.

### Synthesis of Intermediate 3-1

Under a nitrogen atmosphere, 100 mL of dehydrated dichloromethane was added to [2-(2-methoxyethoxy) ethoxy]acetic acid (6.3 g, 35.3 mmol), and the mixture was cooled with ice. After 0.5 mL of N, N-dimethylformamide was added to this solution, oxalyl chloride (6.1 mL, 70.7 mmol) was added dropwise thereto, and the mixture was stirred for 1 hour under ice cooling and stirred at room temperature for 12 hours. The solvent was distilled off under reduced pressure, and the residue was then dried to produce Intermediate 4-1 (yield: 6.9 g, yield percentage: 99 mass %).

### Synthesis of Compound 3

Under a nitrogen atmosphere, 200 mL of dehydrated dichloromethane and triethylamine (19.5 mL, 141 mmol) were added to Intermediate 2-1 (13.9 g, 23.5 mmol) and 4-methoxyphenol (0.04 g), and the mixture was cooled with ice. Intermediate 3-1 (12.2 g, 35.3 mmol) and Intermediate 1-2 (6.94 g, 35.3 mmol) dissolved in 80 mL of dehydrated dichloromethane were added dropwise, and the mixture was stirred under ice cooling for 1 hour and stirred at room temperature for 12 hours. The solvent of the reaction solution was distilled off under reduced pressure, and the residue was subjected to silica gel column chromatography to produce Compound 3 (yield: 22 g, yield percentage: 88 mass %, molar ratio of Compound 3-a and Compound 3-b (3-a: 3-b)=2:1).

### Synthesis of Compound 4

A synthesis scheme of Compound 4 is described below.

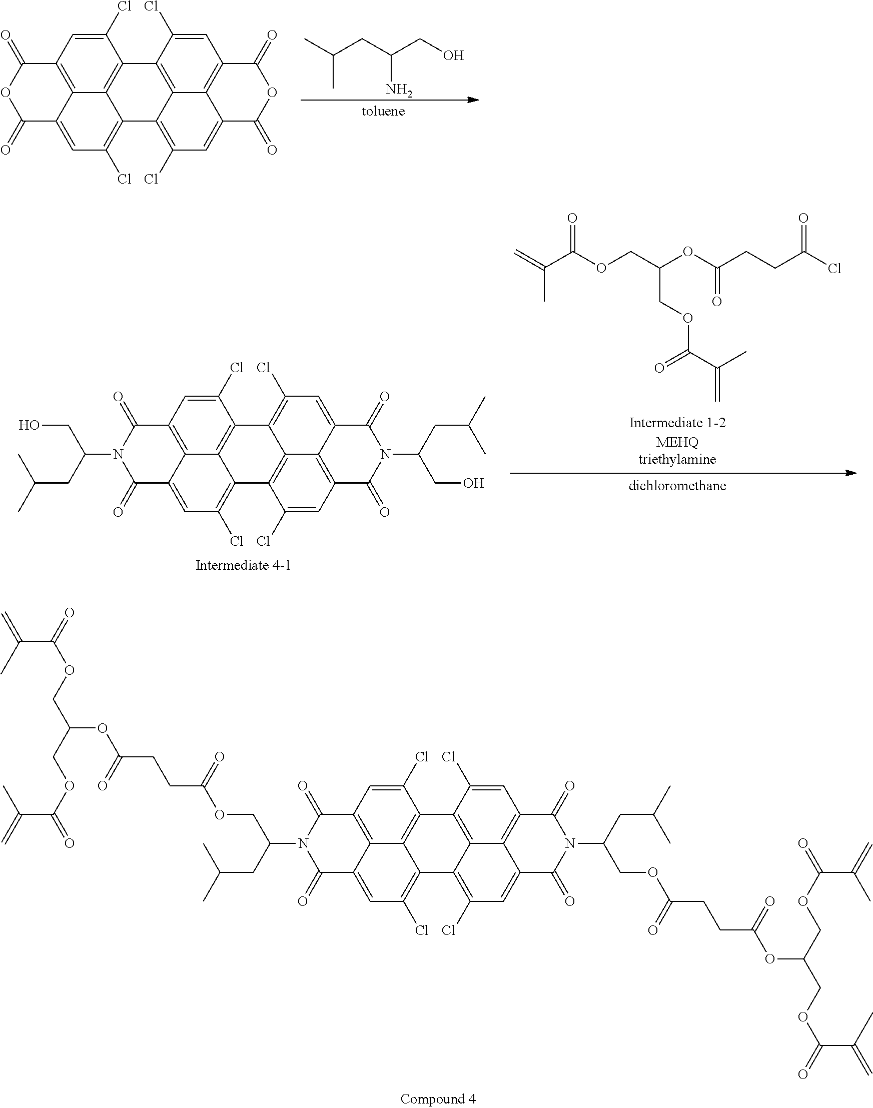

A synthetic procedure for Compound 4 is described below.

### Synthesis of Intermediate 4-1

Under a nitrogen atmosphere, 5,6,12,13-tetrachloroperylo[3,4-cd:9,10-c′d′]dipyran-1,3,8,10-tetrone (13.0 g, 24.5 mmol) and L-(+)-leucinol (7.2 g, 61.3 mmol) were added to 200 mL of toluene, and the mixture was stirred at 110° C. for 9 hours. After cooling to room temperature, this solution was poured into 200 mL of ice water, and 1 N hydrochloric acid was added to make the reaction solution acidic. The reaction solution was subjected to extraction with toluene and tetrahydrofuran, and the organic layer was washed with water and then dried over magnesium sulfate. The resultant solid was filtered, the solvent of the filtrate was distilled off under reduced pressure, and the residue was dried to produce Intermediate 4-1 (yield: 11.8 g, yield percentage: 66 mass %).

### Synthesis of Compound 4

Under a nitrogen atmosphere, 100 mL of dehydrated dichloromethane and triethylamine (6.6 mL, 47.8 mmol) were added to Intermediate 4-1 (5.8 g, 7.96 mmol) and 4-methoxyphenol (0.05 g), and the mixture was cooled with ice. Intermediate 1-2 (8.3 g, 23.9 mmol) dissolved in 70 mL of dehydrated dichloromethane was added dropwise, and the mixture was stirred under ice cooling for 1 hour and stirred at room temperature for 12 hours. The reaction solution was poured into 200 mL of ice water, and subjected to extraction with dichloromethane. The organic layer was washed with water and then dried over magnesium sulfate. The resultant solid was filtered, the solvent of the filtrate was distilled off under reduced pressure, and the residue was subjected to silica gel column chromatography to produce Compound 4 (yield: 5.7 g, yield percentage: 53 mass %).

### Synthesis of Compound 5

A synthesis scheme of Compound 5 is described below.

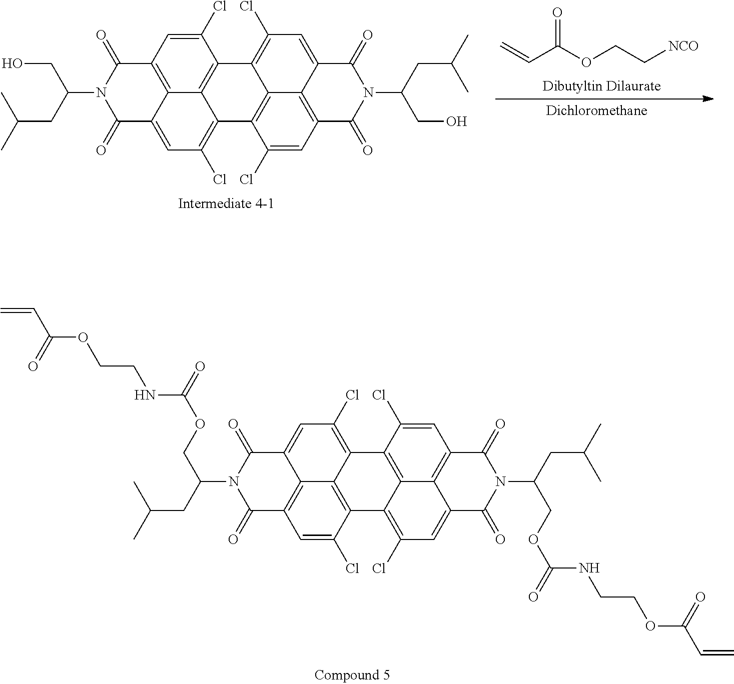

A synthetic procedure for Compound 5 is described below.

### Synthesis of Compound 5

Under a nitrogen atmosphere, 70 mL of dehydrated dichloromethane was added to Intermediate 4-1 (5.1 g, 6.93 mmol), and 2-(acryloyloxy)ethyl isocyanate (2.5 g, 17.3 mmol) was added dropwise thereto. 0.1 mL of dibutyltin dilaurate was added, and the mixture was stirred at room temperature for 12 hours. The reaction solution was poured into 200 ml of water, and subjected to extraction with dichloromethane. The organic layer was washed with water and then dried over magnesium sulfate. The resultant solid was filtered, the solvent of the filtrate was distilled off under reduced pressure, and the residue was subjected to silica gel column chromatography to produce Compound 5 (yield: 2.3 g, yield percentage: 33 mass %).

### Synthesis of Compound 6

A synthesis scheme of Compound 6 is described below.

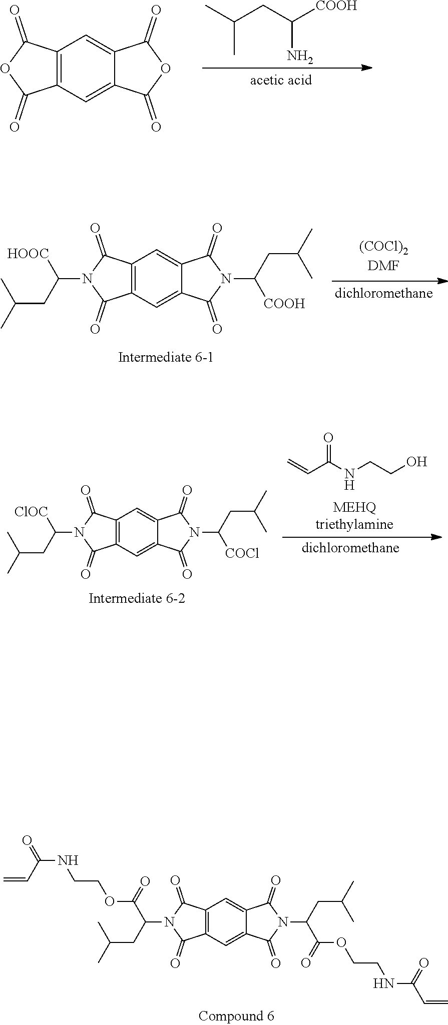

A synthetic procedure for Compound 6 is described below.

### Synthesis of Intermediate 6-1

Under a nitrogen atmosphere, 250 mL of acetic acid was added to a mixture of benzene-1,2,4,5-tetracarboxylic anhydride (19.3 g, 88.4 mmol) and L-leucine (23.2 g, 176.9 mmol), and the mixture was stirred at room temperature for 12 hours and stirred at 130° C. for 12 hours. After cooling to room temperature, the mixture was poured into 400 mL of ice water and the solid was filtered and washed with water. After drying, Intermediate 6-1 (yield: 38.7 g, yield percentage: 98%) was produced.

### Synthesis of Intermediate 6-2

Under a nitrogen atmosphere, 200 mL of dehydrated dichloromethane and 1 mL of dehydrated dimethylformamide were added to Intermediate 6-1 (23.0 g, 51.8 mmol), and the mixture was cooled with ice. Oxalyl chloride (26.6 mL, 310.5 mmol) was added dropwise, and the mixture was stirred under ice cooling for 2 hours and stirred at room temperature for 12 hours. The solvent was distilled off under reduced pressure, and the solid was then filtered and washed with hexane. After drying, Intermediate 6-2 (yield: 23.5 g, yield percentage: 94 mass %) was produced.

### Synthesis of Compound 6

Under a nitrogen atmosphere, 4-methoxyphenol (0.01 g) was added to N-(2-hydroxyethyl) acrylamide (17.9 g, 51.7 mmol). Thereafter, 200 mL of dehydrated dichloromethane and triethylamine (43 mL, 310.2 mmol) were further added, and the mixture was cooled with ice. Intermediate 6-2 (23.5 g, 48.8 mmol) dissolved in 100 mL of dehydrated dichloromethane was added dropwise, and the mixture was stirred under ice cooling for 2 hours and stirred at room temperature for 2 hours. The solvent was distilled off under reduced pressure, and the residue was then subjected to silica gel column chromatography to produced Compound 6 (yield: 14.2 g, yield percentage: 46 mass %).

### Synthesis of Compound 7

A synthesis scheme of Compound 7 is described below.

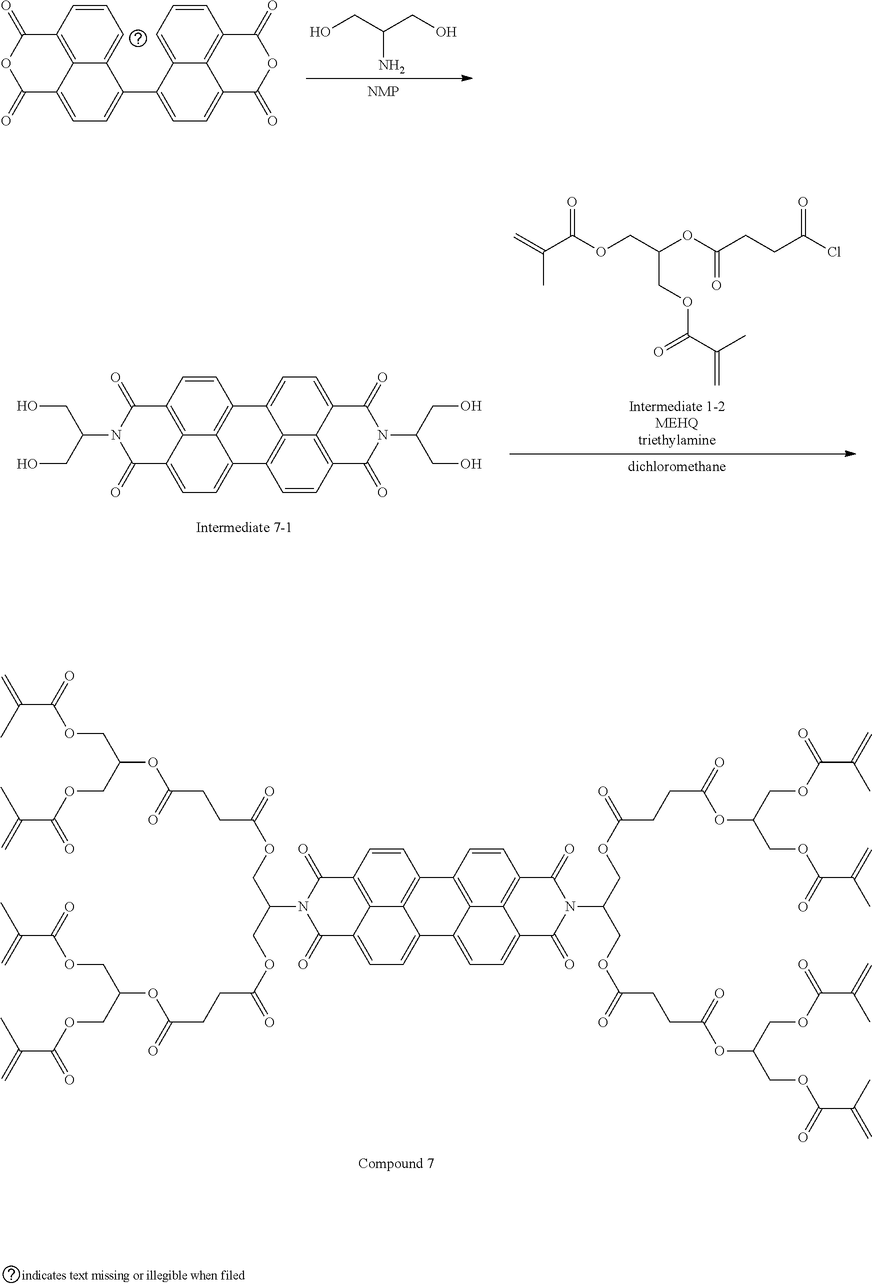 [SMILES: O=C1OC(=O)c2ccc(-c3ccc4c5c(cccc35)C(=O)OC4=O)c3cccc1c23 ; NC(CO)CO ; O=C1c2ccc3c4ccc5c6c(ccc(c7ccc(c2c37)C(=O)N1C(CO)CO)c64)C(=O)N(C(CO)CO)C5=O ; C=C(C)C(=O)OCC(COC(=O)C(=C)C)OC(=O)CCC(=O)Cl ; C=C(C)C(=O)OCC(COC(=O)C(=C)C)OC(=O)CCC(=O)OCC(COC(=O)CCC(=O)OC(COC(=O)C(=C)C)COC(=O)C(=C)C)N1C(=O)c2ccc3c4ccc5c6c(ccc(c7ccc(c2c37)C1=O)c64)C(=O)N(C(COC(=O)CCC(=O)OC(COC(=O)C(=C)C)COC(=O)C(=C)C)COC(=O)CCC(=O)OC(COC(=O)C(=C)C)COC(=O)C(=C)C)C5=O]

A synthetic procedure for Compound 7 is described below.

### Synthesis of Intermediate 7-1

Under a nitrogen atmosphere, 3,4,9,10-perylenetetracarboxylic dianhydride (7.6 g, 19.4 mmol), 2-amino-1,3-propanediol (3.5 g, 38.7 mmol), and 200 mL of NMP were mixed, and the mixture was stirred at 150° C. for 8 hours. After cooling to room temperature, this solution was poured into 400 mL of ice water, and 1 N hydrochloric acid was added to make the reaction solution acidic. The resultant solid was filtered, and the filtered product was washed with water. The filtered product was dried to produce Intermediate 7-1 (yield: 10.0 g, yield percentage: 96 mass %).

### Synthesis of Compound 7

Under a nitrogen atmosphere, 200 mL of dehydrated dichloromethane and triethylamine (30.9 mL, 223 mmol) were added to Intermediate 7-1 (10.0 g, 18.6 mmol) and 4-methoxyphenol (0.05 g), and the mixture was cooled with ice. Intermediate 1-2 (38.6 g, 111 mmol) dissolved in 100 mL of dehydrated dichloromethane was added dropwise, and the mixture was stirred under ice cooling for 1 hour and stirred at room temperature for 12 hours. The reaction solution was poured into 200 mL of water, and subjected to extraction with dichloromethane. The organic layer was washed with water and then dried over magnesium sulfate. The resultant solid was filtered, the solvent of the filtrate was distilled off under reduced pressure, and the residue was subjected to silica gel column chromatography to produce Compound 7 (yield: 6.80 g, yield percentage: 21 mass %).

### Synthesis of Compound 8

A synthesis scheme of Compound 8 is described below.

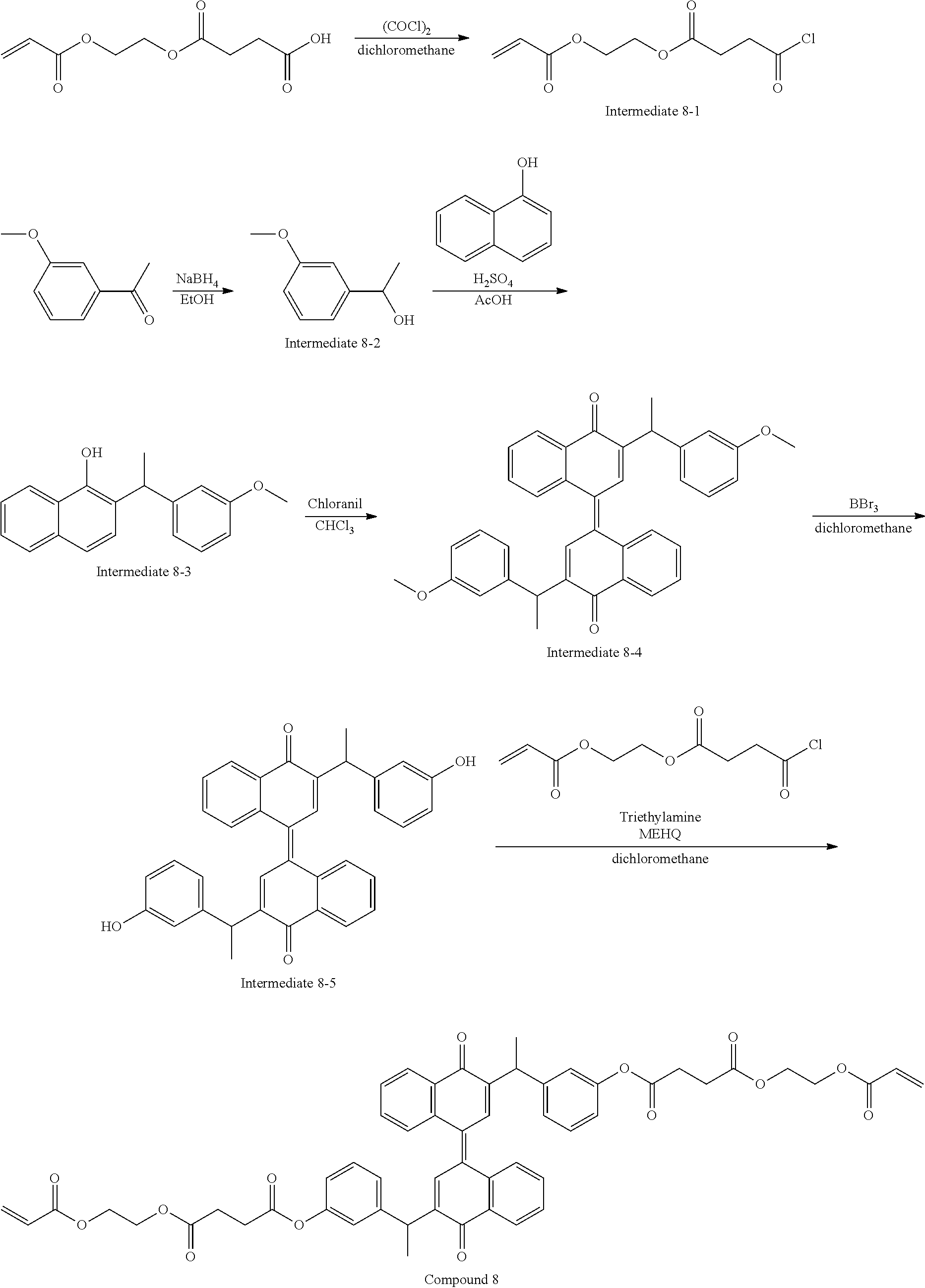

A synthetic procedure for Compound 8 is described below.

### Synthesis of Intermediate 8-1

Under a nitrogen atmosphere, a solution was prepared by adding 100 mL of dichloromethane to mono (2-acryloyloxyethyl) succinate (11.7 g, 54.1 mmol), and the solution was cooled with ice. Oxalyl chloride (6.0 mL, 70.3 mmol) was added dropwise to this solution, and the mixture was stirred under ice cooling for 1 hour and stirred at room temperature for 12 hours. The solvent was distilled off under reduced pressure, and then Intermediate 8-1 (yield: 12 g, yield percentage: 94 mass %) was produced.

### Synthesis of Intermediate 8-2

Under a nitrogen atmosphere, 300 mL of ethanol was added to 3-methoxyacetophenone (16 g, 106.5 mmol), and the mixture was cooled with ice. Sodium borohydride (6.0 g, 159.8 mmol) was added in multiple portions, and the mixture was stirred under ice cooling for 1 hour and stirred at room temperature for 2 hours. The reaction solution was poured into 300 mL of water, and the organic layer was extracted with ethyl acetate and washed with salt water. The organic layer was dried over magnesium sulfate, and the solvent was then distilled off under reduced pressure to produce Intermediate 8-2 (yield: 15.1 g, yield percentage: 94 mass %).

### Synthesis of Intermediate 8-3

Under a nitrogen atmosphere, 300 mL of acetic acid was added to a mixture of 1-naphthol (32.5 g, 225.4 mmol) and Intermediate 8-2 (22.9 g, 150.2 mmol), and 8.0 mL of sulfuric acid was added dropwise thereto. After stirring at room temperature for 40 minutes, the mixture was poured into 300 mL of water, and the organic layer was extracted with dichloromethane and washed with water. The organic layer was dried over magnesium sulfate, the solvent was then distilled off under reduced pressure, and the residue was subjected to silica gel column chromatography to produce Intermediate 8-3 (yield 17 g, yield percentage: 41 mass %).

### Synthesis of Intermediate 8-4

Under a nitrogen atmosphere, 500 mL of chloroform was added to Intermediate 8-3 (17 g, 61.1 mmol), and chloranil (15 g, 61.1 mmol) was added thereto. After stirring at room temperature for 24 hours, the mixture was filtered with dichloromethane. The solvent of the filtrate was distilled off under reduced pressure, and the residue was subjected to silica gel chromatography to produce Intermediate 8-4 (yield: 15 g, yield percentage: 89 mass %).

### Synthesis of Intermediate 8-5

Under a nitrogen atmosphere, 200 mL of dichloromethane was added to Intermediate 8-4 (14 g, 25.3 mmol), and the mixture was cooled to −70° C. 130 mL of a 1 mol/L solution of boron tribromide in dichloromethane was added dropwise, and the mixture was heated to room temperature and stirred for 12 hours. The mixture was cooled to 0° C., and 150 mL of water was added dropwise thereto. After the mixture was heated to room temperature, the organic layer was extracted with dichloromethane and washed with water. The organic layer was dried over magnesium sulfate, the residue was then dissolved in 200 mL of chloroform, chloranil (5.1 g, 20.7 mmol) was added, and the mixture was stirred at room temperature for 2.5 hours. The mixture was filtered with dichloromethane. The solvent of the filtrate was distilled off under reduced pressure, and the residue was subjected to silica gel chromatography to produce Intermediate 8-5 (yield: 9.6 g, yield percentage: 72 mass %).

### Synthesis of Compound 8

Under a nitrogen atmosphere, 100 mL of dichloromethane was added to a mixture of Intermediate 8-5 (7.6 g, 14.5 mmol) and 0.05 g of 4-methoxyphenol to prepare a solution, and the solution was cooled with ice. Triethylamine (8.0 mL, 58.0 mmol) was added to this solution, then Intermediate 8-1 (7.5 g, 31.9 mmol) was added dropwise thereto, and the mixture was stirred for 1 hour under ice cooling and stirred at room temperature for 12 hours. The reaction solution was poured into 200 ml of water, and subjected to extraction with dichloromethane, and the organic layer was washed with water. The organic layer was dried over magnesium sulfate, the solvent was then distilled off under reduced pressure, and the residue was subjected to silica gel chromatography to produce Compound 8 (yield: 4.4 g, yield percentage: 33 mass %).

### Synthesis of Compound 9

A synthesis scheme of Compound 9 is described below.

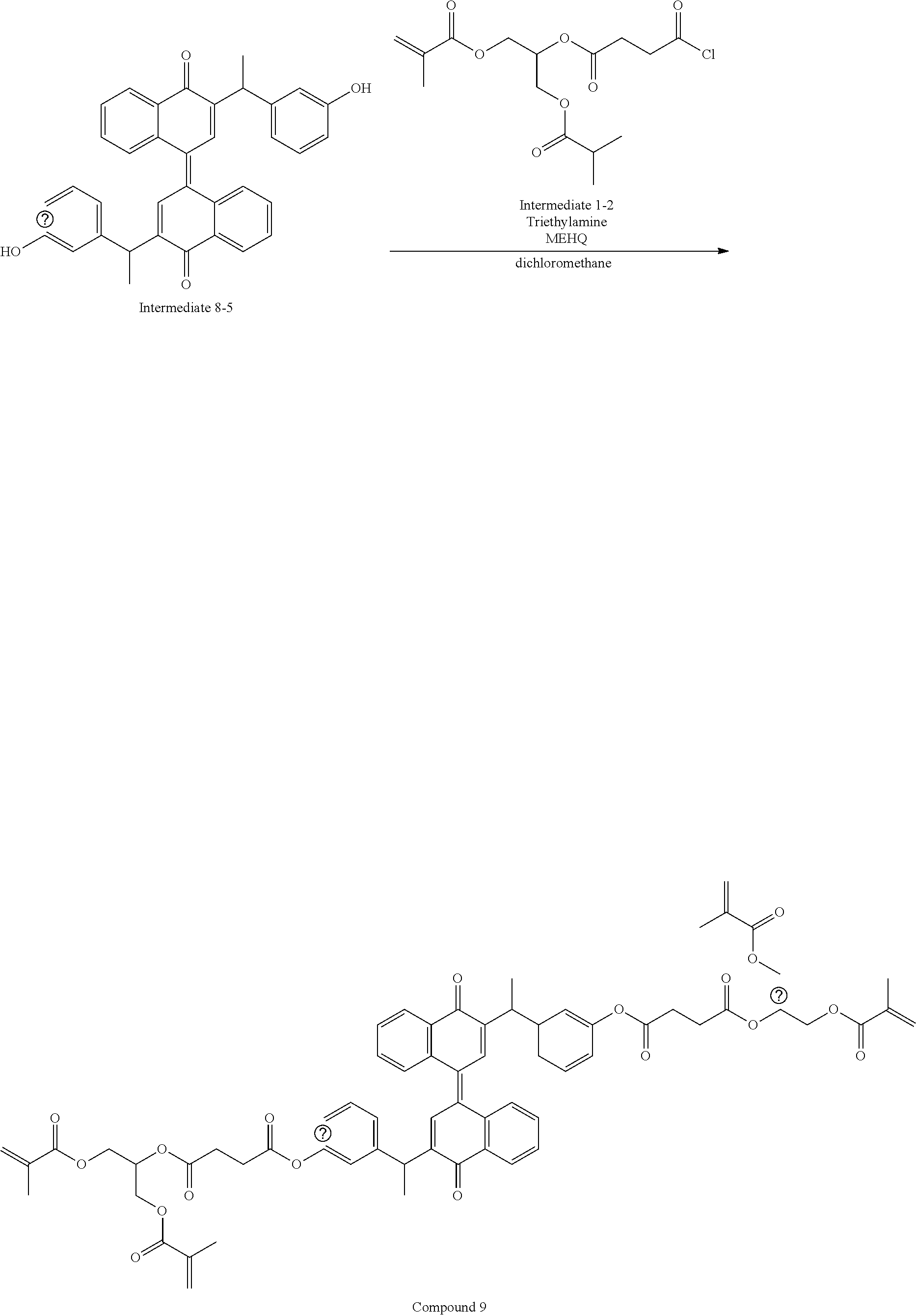

A synthetic procedure for Compound 9 is described below.

### Synthesis of Compound 9

Under a nitrogen atmosphere, 200 mL of dichloromethane was added to a mixture of Intermediate 8-5 (5.5 g, 10.5 mmol) produced by the above-described procedure and 0.05 g of MEHQ to prepare a solution, and the solution was cooled with ice. Triethylamine (7.3 mL, 52.4 mmol) was added to this solution, then Intermediate 1-2 (10.9 g, 31.5 mmol) was added dropwise thereto, and the mixture was stirred for 1 hour under ice cooling and stirred at room temperature for 2 hours. The reaction solution was poured into 100 ml of water, and subjected to extraction with dichloromethane, and the organic layer was washed with water. The organic layer was dried over magnesium sulfate, the solvent was then distilled off under reduced pressure, and the residue was subjected to silica gel chromatography to produce Compound 9 (yield: 4.8 g, yield percentage: 40 mass %).

### Synthesis of Compound 10

A synthesis scheme of Compound 10 is described below.

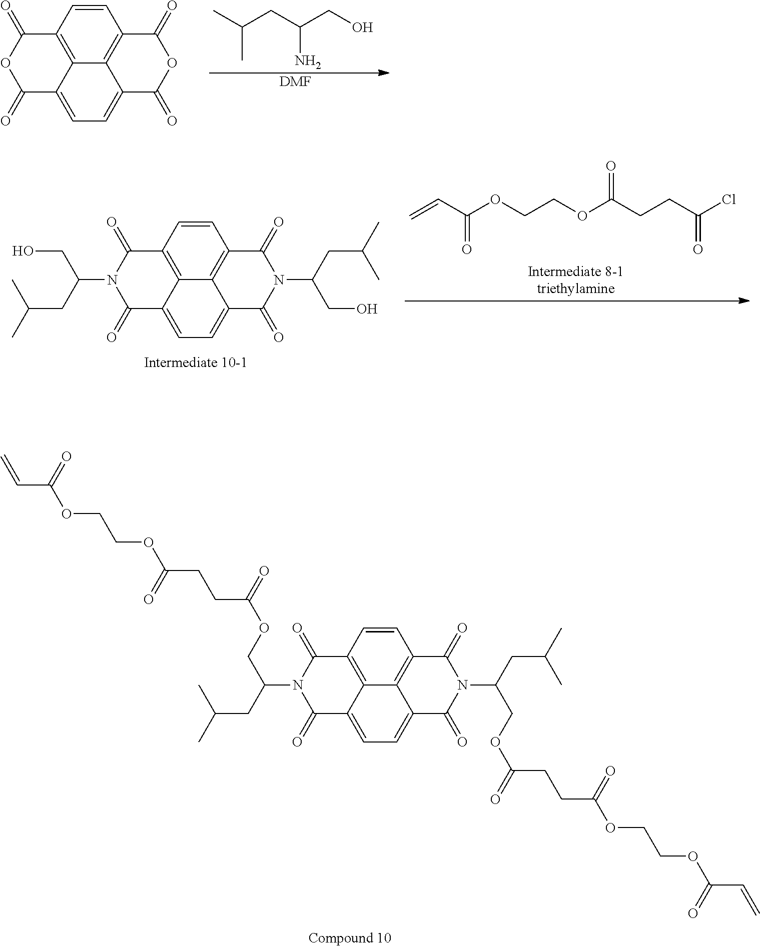

A synthetic procedure for Compound 10 is described below.

### Synthesis of Intermediate 10-1

Under a nitrogen atmosphere, 150 mL of N,N-dimethylformamide was added to naphthalene-1,4,5,8-tetracarboxylic dianhydride (4.5 g, 16.9 mmol) and L-(+)-leucinol (4.4 mL, 33.7 mmol) to prepare a solution, and the solution was stirred at 150° C. for 6 hours. The solution was cooled to room temperature, and then poured into 200 mL of ice water, and 1 N hydrochloric acid was added to make the solution acidic. The solution was subjected to extraction with ethyl acetate, and the organic layer was washed with water and then dried over magnesium sulfate. The resultant solid was filtered. The solvent of the filtrate was distilled off under reduced pressure, the residue was dried, and then Intermediate 10-1 (yield: 7.8 g, yield percentage: 99 mass %) was produced.

### Synthesis of Compound 10

Under a nitrogen atmosphere, 50 mL of dehydrated dichloromethane and triethylamine (5.1 mL, 36.8 mmol) were added to Intermediate 10-1 (4.3 g, 9.21 mmol), and the mixture was cooled with ice. Intermediate 8-1 (4.8 g, 20.3 mmol) dissolved in 50 mL of dehydrated dichloromethane was added dropwise, and the mixture was stirred under ice cooling for 1 hour and stirred at room temperature for 1 hour. The reaction solution was poured into 100 ml of water, and subjected to extraction with dichloromethane. The organic layer was washed with water and then dried over magnesium sulfate. The resultant solid was filtered, the solvent of the filtrate was distilled off under reduced pressure, and the residue was subjected to silica gel column chromatography to produce Compound 10 (yield: 3.5 g, yield percentage: 45 mass %).

### Synthesis of Compound 11

A synthesis scheme of Compound 11 is described below.

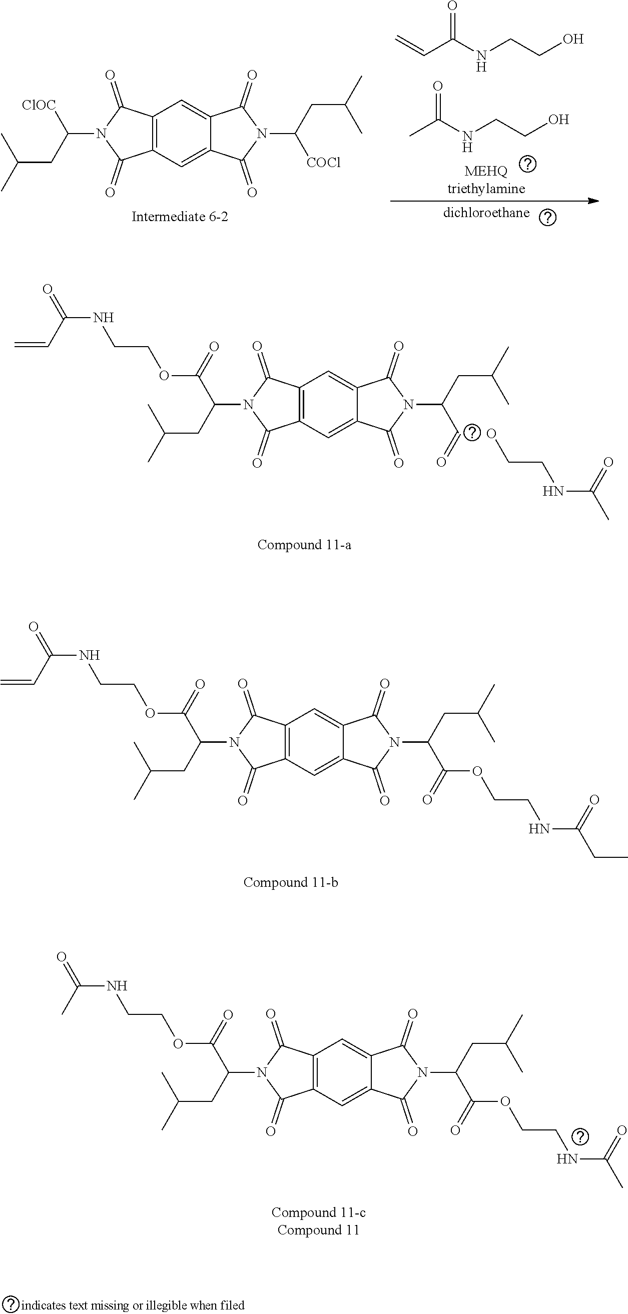

A synthetic procedure for Compound 11 is described below.

### Synthesis of Compound 11

Under a nitrogen atmosphere, 200 mL of dehydrated dichloromethane and triethylamine (29 mL, 208.2 mmol) were added to a mixture of N-(2-hydroxyethyl) acrylamide (5.99 g, 52.0 mmol), 2-acetamidoethanol (5.37 g, 52.0 mmol), and 4-methoxyphenol (0.03 g), and the mixture was cooled with ice. A solution prepared by dissolving Intermediate 6-2 (16.7 g, 34.7 mmol) produced by the above-described procedure in 100 mL of dehydrated dichloromethane was added dropwise, and the mixture was stirred under ice cooling for 2 hours and stirred at room temperature for 2 hours. The solvent was distilled off under reduced pressure, and the residue was then subjected to silica gel column chromatography to produce Compound 11 (yield: 3.4 g, yield percentage: 16 mass %, molar proportions of Compound 11-a, Compound 11-b, and Compound 11-c (11-a:11-b:11-c)=2:1:1).

### Synthesis of Compound 12

Compound 12 was synthesized in accordance with the method described in Non-Patent Literature 1 below.
Non-Patent Literature 1: Organic Letters, 2010, Vol. 12, No. 10, 2382-2385

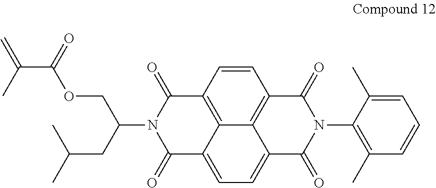 [SMILES: C=C(C)C(=O)OCC(CC(C)C)N1C(=O)c2ccc3c4c(ccc(c24)C1=O)C(=O)N(c1c(C)cccc1C)C3=O]

TABLE 1

| | Formula | Formula | Formula | Formula | | | | | |
|---|---|---|---|---|---|---|---|---|---|
| | (1A) | (1B) | (2) | (3A) | M_{ETM} | M_{X} | M_{X}/M_{ETM} | FA_{X} | A_{ETM} |
| Compound 1 | X | X | ◯ | ◯ | 788.9 | 264.2 | 0.33 | 3.89 | 2.53 |
| Compound 2 | X | X | ◯ | ◯ | 1211.3 | 388.3 | 0.32 | 3.94 | 3.30 |
| Compound 3 | X | X | ◯ | ◯ | 1061.2 | 388.3 | 0.37 | 3.94 | 1.88 |
| Compound 4 | X | X | ◯ | ◯ | 1349.1 | 526.1 | 0.39 | 4.2 | 2.97 |
| Compound 5 | ◯ | X | ◯ | X | 1010.7 | 526.1 | 0.52 | 4.2 | 1.98 |
| Compound 6 | X | X | ◯ | X | 638.7 | 214.1 | 0.34 | 3.69 | 3.13 |
| Compound 7 | X | X | ◯ | ◯ | 1779.7 | 388.3 | 0.22 | 3.94 | 4.50 |
| Compound 8 | X | X | ◯ | ◯ | 920.1 | 282.3 | 0.31 | 3.83 | 2.17 |
| Compound 9 | X | X | ◯ | ◯ | 1145.2 | 282.3 | 0.25 | 3.83 | 3.49 |
| Compound 10 | X | X | ◯ | ◯ | 862.9 | 264.2 | 0.31 | 3.89 | 2.32 |
| Compound 11 | X | X | ◯ | X | 626.7 | 214.1 | 0.34 | 3.69 | 1.60 |
| Compound 12 | X | X | X | X | 590.7 | 388.4 | 0.66 | 3.72 | 1.86 |

In Table 1, “◯” indicates that each of Compounds 1 to 12 has a group represented by each of the above-described formulae, and “X” indicates that each of Compounds 1 to 12 does not have a group represented by each of the above-described formulae.

In addition, “M_{ETM}” represents the molecular weight of a compound represented by Formula (1), “M_{X}” represents the molecular weight of a compound in which all bonding sites of X in Formula (1) are replaced with hydrogen atoms, “EA_{X}” represents the electron affinity (eV) of the compound in which all bonding sites of X in Formula (1) are replaced with hydrogen atoms, and “A_{ETM}” represents the number of polymerizable functional groups contained per molecular weight of 1000 of the compound represented by Formula (1).

The “electron affinity of the compound” is a value determined using software “Spartan’ 18 Parallel Suite” (Wavefunction, Inc.). Hereinafter, a method for calculating the electron affinity of the compound will be described. First, shape optimization was carried out with the density functional theory (DFT) method (functional “B3LYP”, basis function “6-31G*”). Then, based on the optimized shape, the lowest unoccupied molecular orbital (LUMO) levels (E_{LUMO}/eV) were determined using the “Energy at Ground state in Gas with Density Functional B3LYP 6-31G*” method. Total Charge used was “Neutral (0)”, and Unpaired Electrons used were “0”. Subsequently, the electron affinity “EA_{X}” was calculated from the obtained E_{LUMO} using the following equation.

EA_{X} (eV)=−0.8059×E_{LUMO}+1.1451

### Evaluation of Solubility in Organic Solvent

To a mixed solvent of toluene/2-propanol=3/7 (mass ratio) at room temperature (25° C.), each of Compounds 1 to 12 was added to attain a concentration of 6 mass %, and the mixture was stirred with a rotor for 10 minutes without heating or cooling. The dissolution state was then visually observed, and the solubility was evaluated according to the following criteria.

When undissolved residue was observed, the dissolution state was again visually observed after heating for 10 minutes in a water bath at a constant temperature (40° C.) as described below, and the solubility was evaluated. Evaluation “⊚” or “◯” indicated excellent solubility in an organic solvent. The evaluation results are shown in Table 2.
⊚: Completely dissolved at room temperature.
◯: A slight amount of undissolved residue was observed at room temperature, but completely dissolved upon heating under conditions of 40° C. and less than 10 minutes.
Δ: There was undissolved residue at room temperature, which was completely dissolved upon heating at 40° C. for 10 minutes or more.
x: Undissolved residue was observed even after heating at 40° C. for 10 minutes or more.

### Production of Electrophotographic Photoreceptor

### Production of Coating Liquid P1 for Forming Undercoat Layer

20 parts of D-type titanyl phthalocyanine showing a clear peak at a diffraction angle 2θ=27.3°±0.2° in powder X-ray diffraction using CuKα rays and 280 parts of 1,2-dimethoxyethane were mixed, and the mixture was pulverized for 2 hours with a sand grinding mill to perform a pulverization dispersion treatment. To the mixture, 400 parts of a 1,2-dimethoxyethane solution containing 2.5 mass % of polyvinyl butyral (trade name “Denka Butyral” #6000C, available from Denki Kagaku Kogyo Kabushiki Kaisha) and 170 parts of 1,2-dimethoxyethane were further added and mixed to produce a coating liquid P1 for forming an undercoat layer having a solid component concentration of 3.4 mass %.

### Production of Coating Liquid Q1 for Forming Single-Layer Type Photosensitive Layer

2.6 parts of D-type titanyl phthalocyanine showing a clear peak at a diffraction angle 2θ=27.3°±0.2° in powder X-ray diffraction using CuKα rays, 11.3 parts of a perylene pigment having a structure described below, 0.5 parts of a polyvinyl butyral resin, 90 parts of a hole transport material described below (HTM48, molecular weight: 748), 70 parts of an electron transport material described below (ET-2, molecular weight: 424.2), 100 parts of a polycarbonate resin having a biphenyl structure, 0.05 parts of silicone oil (trade name KF-96, available from Shin-Etsu Silicone Co., Ltd.) as a leveling agent, and 793.35 parts of a mixed solvent of tetrahydrofuran (hereinafter appropriately abbreviated as THF) and toluene (hereinafter appropriately abbreviated as TL) (THF: 90 mass %, TL: 10 mass %) were mixed to produce a coating liquid Q1 for forming a single-layer type photosensitive layer having a solid component concentration of 25 mass %.

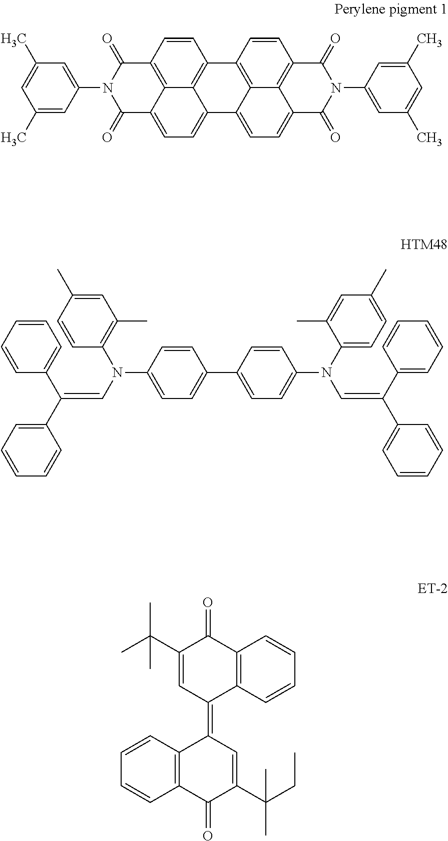 [SMILES: Cc1cc(C)cc(N2C(=O)c3ccc4c5ccc6c7c(ccc(c8ccc(c3c48)C2=O)c75)C(=O)N(c2cc(C)cc(C)c2)C6=O)c1 ; Cc1ccc(N(C=C(c2ccccc2)c2ccccc2)c2ccc(-c3ccc(N(C=C(c4ccccc4)c4ccccc4)c4ccc(C)cc4C)cc3)cc2)c(C)c1 ; CCC(C)(C)C1=C/C(=C2/C=C(C(C)(C)C)C(=O)c3ccccc32)c2ccccc2C1=O]

### Production of Coating Liquids S1 to S12 for Forming Protective Layer

Coating liquids S1 to S12 for forming a protective layer (solid component concentration: about 8.0 mass %) having a solvent composition of toluene/2-propanol=3/7 (mass ratio) were produced using the curable compounds (polymerizable compounds having no electron transport skeleton) shown in Table 2, the electron donating compound shown in Table 2, and the electron transport compounds shown in Table 2 in the amounts shown in Table 2.

The symbols of the curable compounds and the electron donating compound in Table 2 represent the following.
Curable compound: A-DPH (available from Shin-Nakamura Chemical Co., Ltd., dipentaerythritol polyacrylate, product name “NK Ester A-DPH”)
Curable compound: M9050 (available from Toagosei Co., Ltd., polyester acrylate, product name “ARONIX M-9050”)
Electron donating compound: N-DMBI (available from Tokyo Chemical Industry Co., Ltd., N,N-dimethylbenzylamine)

### Examples 1 to 5 and Comparative Examples 1 to 7

In Examples 1 to 5 and Comparative Examples 1 to 7, single-layer type photoreceptors A1 to A12 were produced and evaluated as shown in Table 2.

### Production of Single-Layer Type Photoreceptors A1 to A12

Single-layer type photoreceptors were produced by the following procedure.

The coating liquid P1 for forming an undercoat layer was applied by dip coating to an aluminum cylinder having a machined surface and a diameter of 30 mm and a length of 244 mm, to form an undercoat layer so that the thickness after drying was 0.3 μm. The coating liquid Q1 for forming a single-layer type photosensitive layer was applied by dip coating onto the undercoat layer and dried at 100° C. for 24 minutes to provide a single-layer type photosensitive layer so that the thickness after drying was 32 μm. Each of the coating liquids S1 to S14 for forming a protective layer was applied by ring coating onto the single-layer type photosensitive layer. Immediately after the coating, while the photoreceptor was rotated at 60 rpm under a nitrogen atmosphere, the photoreceptor 2 was irradiated with LED light of 365 nm at an intensity of 0.9 W/cm² for 30 seconds, the photoreceptors 1, 4, and 7 were irradiated with light for 60 seconds, and the photoreceptors 3, 5, 6, and 8 to 12 were irradiated with light for 2 minutes, whereby a protective layer was provided such that the thickness after curing was from 1.5 to 2.0 μm, and photoreceptors A1 to A12 were produced.

### Measurement of Martens Hardness and Elastic Deformation Rate

The Martens hardness and elastic deformation rate of each of the produced photoreceptors A1 to A12 were measured from the surface side of the photoreceptor using a microhardness tester (available from Fischer Instruments K. K.: FISCHERSCOPE HM2000) at a temperature of 25° C. and a relative moisture of 50% under the following measurement conditions.

### Conditions for Measuring Martens Hardness and Elastic Deformation Rate

Indenter: Vickers square pyramid diamond indenter with facing angle of 136°
Maximum indentation load: 0.2 mN
Required loading time: 10 seconds
Required unloading time: 10 seconds

The Martens hardness is determined by the following equation.

Martens hardness (N/mm²)=maximum indentation load/dent area at maximum indentation load

The elastic deformation rate is a value defined by the following equation, and is the ratio of the amount of work performed by a film due to elasticity during unloading to the total amount of work required for indentation.

$$Elastic deformation rate ( \% ) = ( We / Wt ) \times 100$$

In the equation, the total work amount Wt (nJ) represents an area surrounded by A-B-D-A in FIG. 2, and the elastic deformation work amount We (nJ) represents an area surrounded by C-B-D-C. The larger the elastic deformation rate is, the less deformation due to the load remains, and an elastic deformation rate of 100 means that no deformation remains.

In the present disclosure, a Martens hardness (described as “hardness” in Table 2) of 200 N/mm² or more was evaluated as “pass”, and an elastic deformation rate of 30% or more was evaluated as “pass”.

### Measurement of Residual Potential

Each of the produced photoreceptors A1 to A12 was mounted on an electrophotographic property evaluation device (Basis and Application of Electrophotographic Technology—The Sequel, edited by The Society of Electrophotography of Japan, Corona Publishing Co., Ltd., described on pages 404 to 405) produced according to the measuring standards of the Society of Electrophotography of Japan, and the electrical characteristics by the cycle of charging, exposure, potential measurement, and electrostatic elimination were measured as follows.

First, the grid voltage was adjusted, and the photoreceptor was charged so that an initial surface potential (V0) of the photoreceptor was +700 V. Subsequently, the photoreceptor was irradiated with exposure light at 1.3 μJ/cm², and a residual potential (VL) 60 milliseconds after the irradiation was measured. The exposure light used was light from a halogen lamp that had been converted into monochromatic light of 780 nm by an interference filter. The measurement was performed in an environment at a temperature of 25° C. and a relative humidity of 50% (N/N environment).

As the absolute value of the residual potential (V) is smaller, charges are sufficiently transported and the potential is lowered, which can be said to be a good result.

In the present disclosure, a residual potential of 180 V or less was evaluated as “pass”.

TABLE 2

| | | Electron | | Electron | | | | |
|---|---|---|---|---|---|---|---|---|
| | | transport | Curable | donating | | | | |
| | | compound | compound | compound | | Residual | | Elastic |
| | Photo- | Compound No. | (parts by | (parts by | | potential | Hardness | deformation |
| | receptor | (parts by mass) | mass) | mass) | Solubility | (+V) | (N/mm²) | rate (%) |
| Example 1 | A1 | Compound 1 | M9050 | N-DMBI | ◯ | 161 | 202 | 35.6 |
| | | (100) | (50) | (2.5) | | | | |
| Example 2 | A2 | Compound 2 | A-DPH | N-DMBI | Δ | 53 | 231 | 45.3 |
| | | (100) | (50) | (2.5) | | | | |
| Example 3 | A3 | Compound 3 | A-DPH | N-DMBI | ◯ | 103 | 212 | 35.3 |
| | | (100) | (50) | (2.5) | | | | |
| Example 4 | A4 | Compound 4 | A-DPH | N-DMBI | ⊚ | 49 | 223 | 38.7 |
| | | (100) | (100) | (2.5) | | | | |
| Example 5 | A5 | Compound 5 | A-DPH | N-DMBI | ⊚ | 50 | 224 | 39.7 |
| | | (100) | (100) | (2.5) | | | | |
| Comparative | A6 | Compound 6 | M9050 | — | ◯ | 243 | 231 | 37.1 |
| Example 1 | | (100) | (100) | | | | | |
| Comparative | A7 | Compound 7 | A-DPH | N-DMBI | ⊚ | 246 | 283 | 45.9 |
| Example 2 | | (100) | (50) | (2.5) | | | | |
| Comparative | A8 | Compound 8 | M9050 | — | Δ | 209 | 211 | 31.0 |
| Example 3 | | (100) | (50) | | | | | |
| Comparative | A9 | Compound 9 | M9050 | — | ◯ | 316 | 224 | 32.2 |
| Example 4 | | (100) | (100) | | | | | |
| Comparative | A10 | Compound 10 | M9050 | — | Δ | 261 | 205 | 38.0 |
| Example 5 | | (100) | (100) | | | | | |
| Comparative | A11 | Compound 11 | A-DPH | N-DMBI | ⊚ | 172 | 175 | 16.2 |
| Example 6 | | (100) | (50) | (2.5) | | | | |
| Comparative | A12 | Compound 12 | M9050 | | X | Fail to be | Fail to be | Fail to be |
| Example 7 | | (100) | (100) | | | evaluated | evaluated | evaluated |

From Table 2, it was confirmed that Compounds 1 to 5 had excellent solubility in an organic solvent. As is also clear from Table 2, the photoreceptors of Examples 1 to 5 produced using Compounds 1 to 5 were superior to the photoreceptors of Comparative Examples 1 to 7 produced using Compounds 6 to 12 in electrical characteristics such as residual potential properties and mechanical characteristics such as hardness and elastic deformation rate.

All of the compounds of these Examples were Compounds A satisfying Formula (I) and Formula (II-1).

$${M}_{E T M} \geq 700 \qquad ( I )$$

$$0.32 \leq {M}_{X} / {M}_{E T M} \leq 0.60 \qquad ( II - 1 )$$

(In Formula (I) and Formula (II-1), M_{ETM} represents the molecular weight of a compound represented by Formula (1). In Formula (II-1), M_{X} represents the molecular weight of a compound in which all bonding sites of X in Formula (1) are replaced with hydrogen atoms.)

It is considered that when the compound for forming a protective layer has an electron transport structure, charge injection from the photosensitive layer to the protective layer and charge mobility to the outermost surface through the electron transport skeleton are enhanced, and an electrophotographic photoreceptor excellent in electrical characteristics such as residual potential properties can be produced.

When the compound has a polymerizable functional group, the compound is polymerized in a step of forming a protective layer and becomes a polymer, and thus can form a protective layer having excellent mechanical strength.

Further, it is considered that when the compound has a value equal to or lower than the upper limit of Formula (II-1), the proportion of a mother skeleton which is a hydrophobic π-conjugated skeleton is in a preferred range, the solubility in an alcohol-based solvent is high, the applicability of a coating liquid at the time of forming the protective layer is good, and a uniform protective layer without unevenness can be formed. Conceivably, this improves the electron transporting property in the protective layer and improves the electrical characteristics of the photoreceptor. Further, it is considered that when the compound has a value equal to or higher than the lower limit of Formula (II-1) described below, the proportion of the structure contributing to electron transport present in the protective layer is high, and the electron transporting property is high, and thus the electrical characteristics are further improved.

Further, it is considered that when the compound satisfies Formula (I) and Formula (II-1), a side chain moiety contributing to the solubility in an alcohol-based solvent is increased, and the solubility in an alcohol-based solvent becomes more excellent.

All of the compounds of the Examples were also Compounds B satisfying Formula (I), Formula (II-2), and Formula (III).

$${M}_{E T M} \geq 700 \qquad ( I )$$

$${M}_{X} / {M}_{E T M} > 0.31 \qquad ( II - 2 )$$

$${A}_{E T M} \geq 1.8 \qquad ( III )$$

(In Formula (I) and Formula (II-2), M_{ETM} represents the molecular weight of the compound represented by Formula (1). In Formula (II-2), M_{X} represents the molecular weight of a compound in which all bonding sites of X in Formula (1) are replaced with hydrogen atoms. In Formula (III), A_{ETM} represents the number of polymerizable functional groups contained per molecular weight of 1000 of the compound represented by Formula (1).)

It is considered that when the compound for forming a protective layer has an electron transport structure, the use of the compound B for formation of the present protective layer enhances charge injection from the photosensitive layer to the protective layer and charge mobility to the outermost surface through the electron transport skeleton, and an electrophotographic photoreceptor excellent in electrical characteristics such as residual potential properties can be produced.

When the compound B has a polymerizable functional group, the compound is polymerized in a step of forming a protective layer and becomes a polymer, and thus can form a protective layer having excellent mechanical strength.

Further, it is considered that when the compound B satisfies Formula (I) and Formula (II-2), the proportion of a structure that is present in the protective layer and is considered to contribute to the electron transport increases, which is advantageous for the electron transport. Further, it is considered that when Formula (III) is satisfied, the number of polymerizable functional groups present in the protective layer is large, and a dense network structure is easily formed, resulting in further improved hardness and elastic deformation rate.

It is considered that when the compound A, B described above further satisfies Formula (IV) described below, the electron injection from an adjacent layer is good and the electron transporting property of the mother skeleton is excellent, and therefore the electrical characteristics are further improved.

$${EA}_{X} \geq 3.8 \qquad ( IV )$$

(In Formula (IV), EA_{X} represents the electron affinity (eV) of a compound in which all bonding sites of X in Formula (1) are replaced with hydrogen atoms.)

### REFERENCE SIGNS LIST

1: Photoreceptor (electrophotographic photoreceptor)
2: Charging device (charging roller; charging part)
3: Exposure device (exposure part)
4: Developing device (developing part)
5: Transfer device
6: Cleaning device
7: Fixing device
41: Developing tank
42: Agitator
43: Supplying roller
44: Developing roller
45: Regulating member
71: Upper fixing member (pressure roller)
72: Lower fixing member (fixing roller)
73: Heating device
T: Toner
P: Recording paper (sheet, medium)

1. An electrophotographic photoreceptor comprising at least a photosensitive layer and a protective layer sequentially on an electroconductive support, wherein
the protective layer contains a compound represented by Formula (1) described below, and the compound represented by Formula (1) satisfies Formula (I) described below: 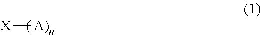
in Formula (1), X represents an n-valent electron transport skeleton;
A is a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, a group represented by Formula (2) described below, or a group represented by Formula (1B) described below;
n represents an integer of 1 or more;
when n is 1, A is a group represented by Formula (2) described below or a group represented by Formula (1B) described below;
when n is 2 or more, a plurality of As may be the same or different, and at least one A is a group represented by Formula (2) described below or a group represented by Formula (1B) described below, 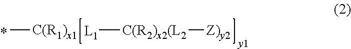
in Formula (2), * represents a bond with X;
R₁ and R₂ each independently represent a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, or a group represented by Formula (1B) described below;
L₁ and L₂ each independently represent a direct bond, a divalent group, a group represented by Formula (1A) described below, or a group represented by Formula (3A) described below; and
Z represents a hydrogen atom, an alkyl group, an alkoxy group, an amide group, or a polymerizable functional group,
provided that x1+y1=3 wherein x1 is an integer from 0 to 2 and y1 is an integer from 1 to 3; x2+y2=3 wherein x2 is an integer from 0 to 2 and y2 is an integer from 1 to 3; when x1 is an integer of 2 or more, R₁s may be the same or different; when y1 is an integer of 2 or more, each of R₂s, x2s, y2s, L₁s, L₂s, and Zs may be the same or different; when x2 is an integer of 2 or more, R₂s may be the same or different; and when y2 is an integer of 2 or more, each of Las and Zs may be the same or different, 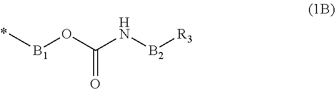
in Formula (1B), * represents a bond with any atom in Formula (1) or (2), and B₁ and B₂ each independently represent a direct bond or a divalent group; and R₃ represents a hydrogen atom, an alkyl group optionally having a substituent, an alkoxy group optionally having a substituent, an aryloxy group optionally having a substituent, a heteroaryloxy group optionally having a substituent, an alkoxycarbonyl group optionally having a substituent, a dialkylamino group optionally having a substituent, a diarylamino group optionally having a substituent, an arylalkylamino group optionally having a substituent, an acyl group optionally having a substituent, a haloalkyl group optionally having a substituent, an alkylthio group optionally having a substituent, an arylthio group optionally having a substituent, a silyl group optionally having a substituent, a siloxy group optionally having a substituent, an aromatic hydrocarbon group optionally having a substituent, an aromatic heterocyclic group optionally having a substituent, or a polymerizable functional group, 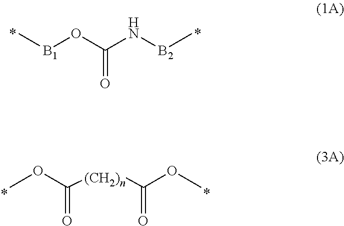
in Formula (1A) and Formula (3A), * represents a bond with any atom in Formula (1) and Formula (2); in Formula (1A), B₁ and B₂ each independently represent a direct bond or a divalent group; and in Formula (3A), n is an integer of 1 or more,
$${M}_{E T M} \geq 700 \qquad ( I )$$
in Formula (I), M_{ETM} represents a molecular weight of the compound represented by Formula (1).

2. The electrophotographic photoreceptor according to claim 1, wherein the compound represented by Formula (1) satisfies Formula (II-1) described below:
$$0.32 \leq {M}_{X} / {M}_{E T M} \leq 0.60 \qquad ( II - 1 )$$
in Formula (II-1), M_{X} represents a molecular weight of a compound in which all bonding sites of X in Formula (1) are replaced with hydrogen atoms.

3. The electrophotographic photoreceptor according to claim 1, wherein the compound represented by Formula (1) satisfies (II-2) and (III) described below:
$${M}_{X} / {M}_{E T M} > 0.31 \qquad ( II - 2 )$$
$${A}_{E T M} \geq 1.8 \qquad ( III )$$
in Formula (II-2), M_{X} represents a molecular weight of a compound in which all bonding sites of X in Formula (1) are replaced with hydrogen atoms; and in Formula (III), A_{ETM} represents the number of polymerizable functional groups contained per molecular weight of 1000 of the compound represented by Formula (1).

4. The electrophotographic photoreceptor according to claim 1, wherein the compound represented by Formula (1) further satisfies Formula (IV) described below:
$${EA}_{X} \geq 3.8 \qquad ( IV )$$
in Formula (IV), EA_{X} represents an electron affinity (eV) of the compound in which all bonding sites of X in Formula (1) are replaced with hydrogen atoms.

5. The electrophotographic photoreceptor according to claim 1, wherein, in Formula (1), X is represented by Formulae (A-1) to (A-27) described below: 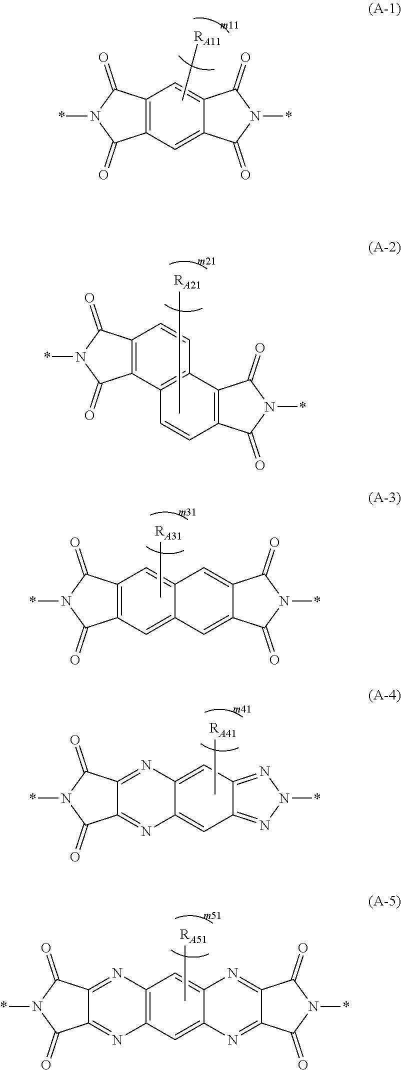 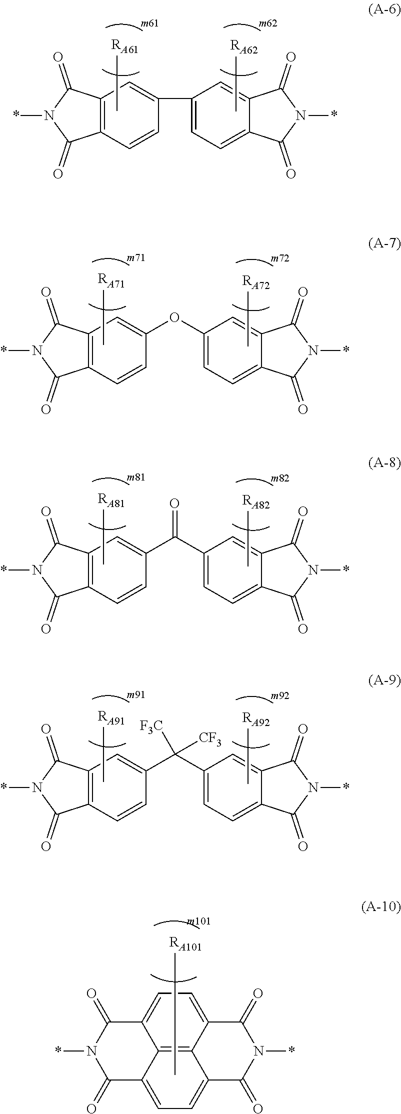 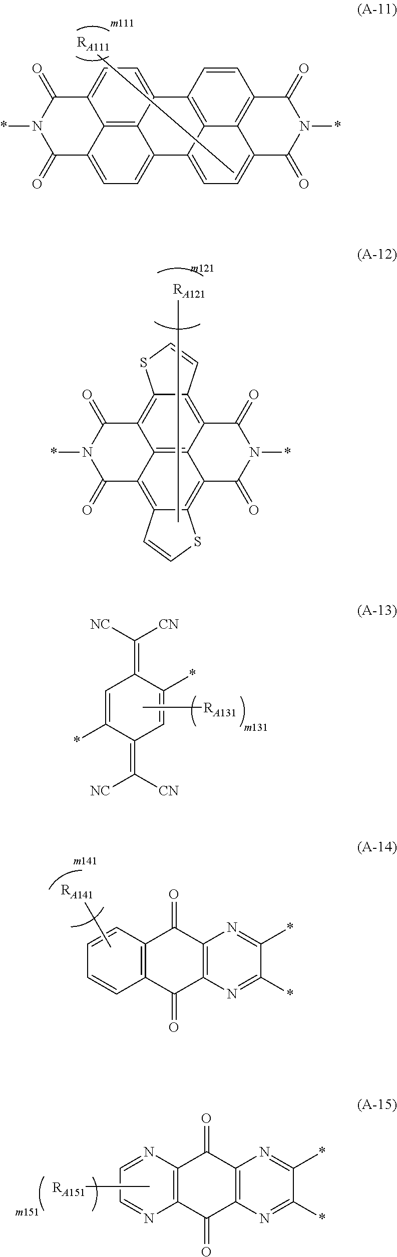 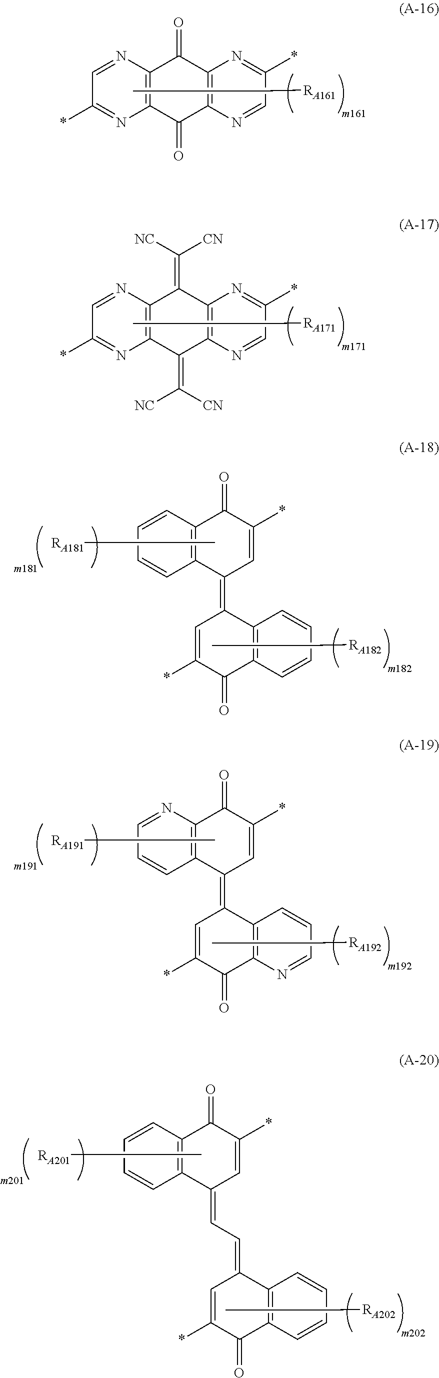 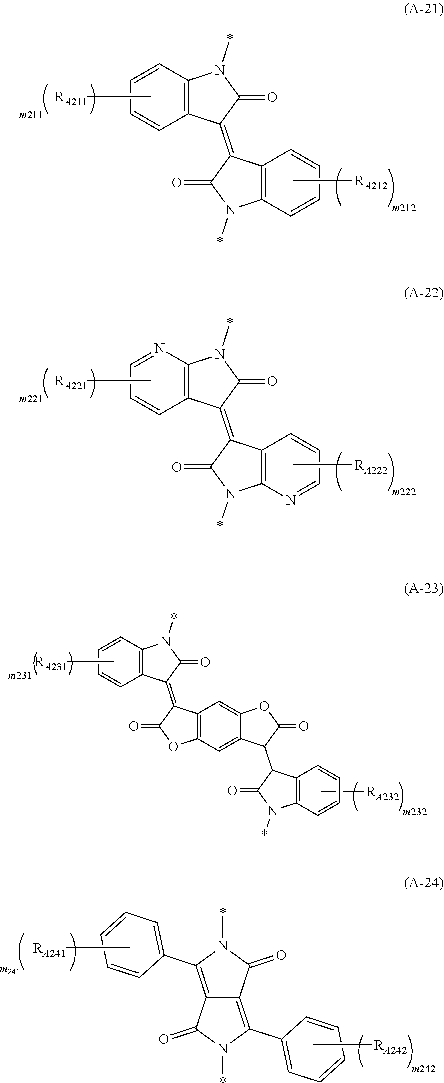 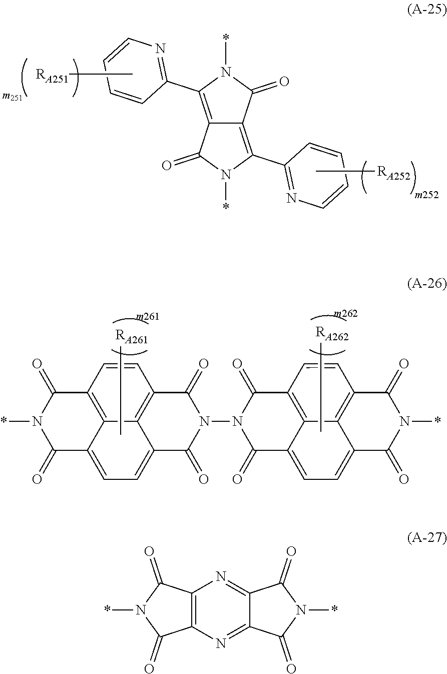
in Formulae (A-1) to (A-27), * represents a bond with A, and R_{A11}, R_{A21}, R_{A31}, R_{A41}, R_{A51}, R_{A61}, R_{A62}, R_{A71}, R_{A72}, R_{A81}, R_{A82}, R_{A91}, R_{A92}, R_{A101}, R_{A111}, R_{A121}, R_{A131}, R_{A141}, R_{A151}, R_{A161}, R_{A171}, R_{A181}, R_{A182}, R_{A191}, R_{A192}, R_{A201}, R_{A202}, R_{A211}, R_{A212}, R_{A221}, R_{A222}, R_{A231}, R_{A232}, R_{A241}, R_{A242}, R_{A251}, R_{A252}, R_{A261}, and R_{A262} each independently represent a hydrogen atom, an alkyl group optionally having a substituent, an aralkyl group optionally having a substituent, an aromatic group optionally having a substituent, an alkoxy group optionally having a substituent, an aryloxy group optionally having a substituent, an acyl group optionally having a substituent, an ester group optionally having a substituent, a cyano group, a nitro group, a sulfone group optionally having a substituent, a hydroxy group, an aldehyde group optionally having a substituent, or a halogen atom; m11, m21, m31, m41, m51, m61, m62, m71, m72, m81, m82, m91, m92, m101, m111, m121, m131, m141, m151, m161, m171, m181, m182, m191, m192, m201, m202, m211, m212, m221, m222, m231, m232, m241, m242, m251, m252, m261, and m262 each independently represent an integer of 0 or more; and when m11, m21, m31, m41, m51, m61, m62, m71, m72, m81, m82, m91, m92, m101, m111, m121, m131, m141, m151, m161, m171, m181, m182, m191, m192, m201, m202, m211, m212, m221, m222, m231, m232, m241, m242, m251, m252, m261, and m262 are each 2 or more, each of R_{A11}s to R_{A262}s may be different.

6. The electrophotographic photoreceptor according to claim 1, wherein, in Formula (1), at least one of As is represented by Formula (2).

7. The electrophotographic photoreceptor according to claim 1, wherein, in Formula (2), at least one of L₁ and L₂ is the group represented by Formula (1A) or the group represented by Formula (3A).

8. The electrophotographic photoreceptor according to claim 1, wherein the compound represented by Formula (1) has at least one polymerizable functional group in one molecule.

9. The electrophotographic photoreceptor according to claim 8, wherein the polymerizable functional group is selected from Formulae (M1) to (M7) described below: 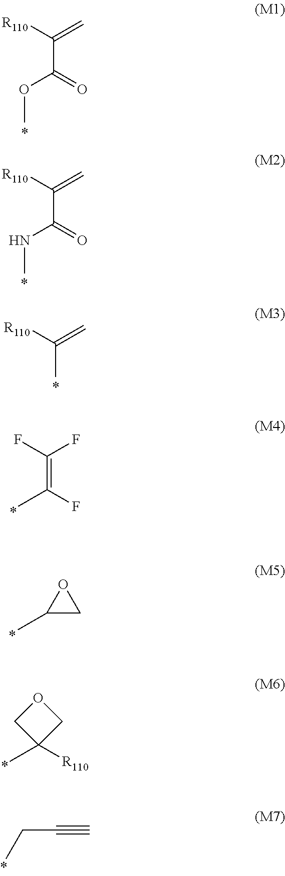
in Formulae (M1) to (M7), R₁₁₀ represents a hydrogen atom or an alkyl group optionally having a substituent, and * represents a bonding position.

10. The electrophotographic photoreceptor according to claim 1, wherein, in Formula (2), R₁ is an alkyl group optionally having a substituent.

11. The electrophotographic photoreceptor according to claim 1, wherein the protective layer further contains a polymer of a polymerizable compound having no electron transport skeleton.

12. The electrophotographic photoreceptor according to claim 1, wherein the protective layer further contains an electron donating compound.

13. An electrophotographic photoreceptor cartridge comprising the electrophotographic photoreceptor described in claim 1.

14. An image forming apparatus comprising the electrophotographic photoreceptor described in claim 1.
